(19) United States
(12) Patent Application Publication
(10) Pub. No.: US 2016/0338480 A1
(43) Pub. Date: Nov. 24, 2016

(54) HANDHELD DEVICES AND RELATED METHODS

(71) Applicant: Christopher C. Sappenfield, San Diego, CA (US)

(72) Inventor: Christopher C. Sappenfield, San Diego, CA (US)

(73) Assignee: Christopher C. Sappenfield, San Diego, CA (US)

(21) Appl. No.: 15/218,354

(22) Filed: Jul. 25, 2016

Related U.S. Application Data
(63) Continuation-in-part of application No. 15/194,761, filed on Jun. 28, 2016.
Application No. 15/194,761 is a continuation-in-part of application No. 14/327,519, filed on Jul. 9, 2014, now Pat. No. 9,382,973.
Application No. 14/327,519 is a continuation of application No. 14/187,302, filed on Feb. 23, 2014, now Pat. No. 8,956,258.
Application No. 14/187,302 is a continuation of application No. 13/451,468, filed on Apr. 19, 2012, now Pat. No. 8,684,883.
Application No. 13/451,468 is a continuation-in-part of application No. 13/423,413, filed on Mar. 19, 2012, now Pat. No. 8,672,799.
Application No. 13/423,413 is a continuation-in-part of application No. 13/219,683, filed on Aug. 28, 2011, now Pat. No. 8,715,133.
Application No. 13/219,683 is a continuation-in-part of application No. 13/184,332, filed on Jul. 15, 2011, now Pat. No. 8,668,618.
Application No. 13/184,332 is a continuation-in-part of application No. 12/577,326, filed on Oct. 12, 2009, now Pat. No. 8,152,679.
Application No. 12/577,326 is a continuation of application No. PCT/US09/60386, filed on Oct. 12, 2009.
(60) Provisional application No. 62/186,229, filed on Jun. 29, 2015.
(60) Provisional application No. 61/365,290, filed on Jul. 16, 2010.
(60) Provisional application No. 61/376,725, filed on Aug. 25, 2010.
(60) Provisional application No. 61/104,748, filed on Oct. 12, 2008.
(60) Provisional application No. 62/197,092, filed on Jul. 26, 2015.

(51) Int. Cl. A46B 7/04; A61C 17/34; A46B 15/00; A46B 5/00; F16H 1/20; A46B 9/04

(52) U.S. Cl. CPC A46B 7/04; F16H 1/20; A46B 9/04; A46B 15/0071; A46B 5/0095; A61C 17/3436

(57) ABSTRACT

Devices comprising, or configured to comprise, interchangeable rotational components or portions thereof are provided.

### CROSS-REFERENCE TO RELATED APPLICATIONS

This application is a continuation-in-part of, and claims the benefit of priority from, U.S. Non-Provisional patent application Ser. No. 15/194,761, filed Jun. 28, 2016, which claims the benefit of priority from U.S. Provisional Patent Application No. 62/186,229, filed Jun. 29, 2015 and is a continuation-in-part of, and claims the benefit of priority from, U.S. Non-Provisional patent application Ser. No. 14/327,519, filed Jul. 9, 2014 (now U.S. Pat. No. 9,382,973, issued Jul. 5, 2016), which is a continuation of, and claims the benefit of priority from, U.S. Non-Provisional patent application Ser. No. 14/187,302, filed Feb. 23, 2014 (now U.S. Pat. No. 8,956,258, issued Feb. 17, 2015), which is a continuation of, and claims the benefit of priority from, U.S. Non-Provisional patent application Ser. No. 13/451,468, filed Apr. 19, 2012 (now U.S. Pat. No. 8,684,883, issued Apr. 1, 2014), which is a continuation-in-part of, and claims the benefit of priority from, U.S. Non-Provisional patent application Ser. No. 13/423,413, filed Mar. 19, 2012 (now U.S. Pat. No. 8,672,799, issued Mar. 18, 2014), which is a continuation-in-part of, and claims the benefit of priority from U.S. Non-Provisional patent application Ser. No. 13/219,683, filed Aug. 28, 2011 (now U.S. Pat. No. 8,715,133, issued May 6, 2014), which is a continuation-in-part of, and claims the benefit of priority from U.S. Non-Provisional patent application Ser. No. 13/184,332, filed Jul. 15, 2011 (now U.S. Pat. No. 8,668,618, issued Mar. 11, 2014), which claims the benefit of priority from U.S. Provisional Patent Application Nos. 61/365,290, filed Jul. 16, 2010 and 61/376,725, filed Aug. 25, 2010, which are each incorporated by reference in their entirety. U.S. Non-Provisional patent application Ser. No. 13/184,332, filed Jul. 15, 2011 (now U.S. Pat. No. 8,668,618, issued Mar. 11, 2014) is also continuation-in-part of, and claims the benefit of priority from, U.S. Non-Provisional patent application Ser. No. 12/577,326, filed Oct. 12, 2009 (now U.S. Pat. No. 8,152,679, issued Apr. 10, 2012), which claims the benefit of priority from U.S. Provisional Patent Application No. 61/104,748, filed on Oct. 12, 2008 and is a continuation of and claims the benefit of priority from International Patent Application No. PCT/US09/60386, filed on Oct. 12, 2009, which are each incorporated by reference in their entirety. This application also claims the benefit of priority from U.S. Provisional Patent Application No. 62/197,092, filed Jul. 26, 2015, which is incorporated by reference in its entirety.

### FIELD OF THE INVENTION

The invention relates generally to mechanical, electrical, or electromechanical devices, and provides rotational components, methods, and related devices and other applications that are useful for a wide variety of purposes.

### BACKGROUND OF THE INVENTION

Electromechanical devices are ubiquitous. Some of these devices include rotating components and are used in many different applications.

### SUMMARY OF THE INVENTION

In one aspect, the invention provides a handheld device (e.g., tooth brushing devices, etc.) that includes a head portion comprising at least one housing that comprises top and bottom areas, wherein the top area comprises at least one top opening and the bottom area comprises at least one bottom opening, wherein the housing comprises at least one rotational component receiving area that communicates with the top and bottom openings. The handheld device also includes at least a first rotational component body structure portion disposed at least partially within the rotational component receiving area, which first rotational component body structure portion comprises a top surface, a bottom surface, and at least one orifice disposed at least partially through the first rotational component body structure portion, which orifice is configured to reversibly receive at least one section of at least a second rotational component body structure portion that comprises, or is configured to comprise, at least one implement through the bottom opening such that a segment of the second rotational component body structure portion is reversibly received in and/or through the top opening, and wherein the first rotational component body structure portion comprises at least one gear component disposed on at least one segment of the first rotational component body structure portion between the top and bottom surfaces of the first rotational component body structure portion. The handheld device also includes at least one drive mechanism component or portion thereof that operably engages the gear component of the first rotational component body structure portion and effects rotation of at least the first rotational component body structure portion and the second rotational component body structure portion at least partially around at least one rotational axis when the orifice reversibly receives the second rotational component body structure portion through the bottom opening. In addition, the handheld device also includes a handle portion operably connected or connectable to the head portion.

In some embodiments, the handle portion is reversibly connectable to the head portion. In certain embodiments, the handheld device includes more than one top opening, more than one bottom opening, more than one rotational component receiving area, and/or more than one first rotational component body structure portions, wherein neighboring pairs of first rotational component body structure portions are configured to rotate in opposite directions relative to one another. In some embodiments, the first rotational component body structure portion, the second rotational component body structure portion, and/or parts thereof comprise at least one resilient coupling that resiliently couples the portions and/or the parts thereof to one another. In certain embodiments, the first and/or second rotational component body structure portion comprises at least one alignment component or portion thereof that is configured to reversibly align the first and second rotational component body structure portions relative to one another. In some embodiments, the handheld device includes more than one second rotational component body structure portion. In some of these embodiments, at least one of the second rotational component body structure portions lacks one or more implements. In some of these embodiments, one or more of the second rotational component body structure portions comprise, or are configured to comprise, the implement. In some of these embodiments, at least a portion of the implement comprises at least one cross-sectional shape selected from the group consisting of: a circle, an oval, a square, a rectangle, a trapezoid, an irregular n-sided polygon, and a regular n-sided polygon.

In some embodiments, the drive mechanism component or a portion thereof comprises at least one chain of meshed gear components that is configured to effect rotation of at least the first rotational component body structure portion and the second rotational component body structure portion when the orifice reversibly receives the second rotational component body structure portion through the bottom opening. In certain embodiments, the drive mechanism component or a portion thereof comprises at least one shaft component that is configured to effect rotation of at least the first rotational component body structure portion and the second rotational component body structure portion when the orifice reversibly receives the second rotational component body structure portion through the bottom opening.

In some embodiments, the handheld device includes at least one retaining mechanism or portion thereof (e.g., a cover component or the like) that is configured to reversibly retain the first and/or second rotational component body structure portion disposed in the rotational component receiving area. In some of these embodiments, the retaining mechanism or portion thereof comprises at least one attachment component or portion thereof that is configured to reversibly attach the retaining mechanism or portion thereof to the head and/or handle portion.

In some embodiments, the handheld device includes the second rotational component body structure portion. In some of these embodiments, the second rotational component body structure portion comprises the implement.

In another aspect, the invention provides a handheld device that includes a head portion comprising at least one housing that comprises top and bottom areas, wherein the top area comprises at least one top opening and the bottom area comprises at least one bottom opening, wherein the housing comprises at least one rotational component receiving area that communicates with the top and bottom openings, which rotational component receiving area is configured to reversibly receive at least a portion of at least one interchangeable rotational component through the bottom opening such that a segment of the interchangeable rotational component that comprises, or is configured to comprise, at least one implement is reversibly received in and/or through the top opening, which interchangeable rotational component comprises at least one gear component. The handheld device also includes at least one drive mechanism component or portion thereof that operably engages the gear component of the interchangeable rotational component and effects rotation of at least the interchangeable rotational component when the rotational component receiving area reversibly receives at least the portion of the interchangeable rotational component through the bottom opening. In addition, the handheld device also includes a handle portion operably connected or connectable to the head portion.

In some embodiments, the handle portion is reversibly connectable to the head portion. In some embodiments, the handheld device includes more than one top opening, more than one bottom opening, more than one rotational component receiving area, and/or more than one interchangeable rotational components, wherein neighboring pairs of the interchangeable rotational components are configured to rotate in opposite directions relative to one another. In some embodiments, the handheld device includes more than one interchangeable rotational component. In some of these embodiments, at least one of the interchangeable rotational components lacks one or more implements. In some of these embodiments, one or more of the interchangeable rotational components comprise, or are configured to comprise, the implement. In some of these embodiments, at least a portion of the implement comprises at least one cross-sectional shape selected from the group consisting of: a circle, an oval, a square, a rectangle, a trapezoid, an irregular n-sided polygon, and a regular n-sided polygon.

In some embodiments, segments of the interchangeable rotational component comprise at least one resilient coupling that resiliently couples the segments to one another. In some embodiments, the interchangeable rotational component comprises at least one alignment component or portion thereof that is configured to reversibly align the interchangeable rotational component and the housing relative to one another.

In some embodiments, the drive mechanism component or a portion thereof comprises at least one chain of meshed gear components that is configured to effect rotation of at least the interchangeable rotational component when the rotational component receiving area reversibly receives at least the portion of the interchangeable rotational component through the bottom opening. In some embodiments, the drive mechanism component or a portion thereof comprises at least one shaft component that is configured to effect rotation of at least the interchangeable rotational component when the rotational component receiving area reversibly receives at least the portion of the interchangeable rotational component through the bottom opening.

In some embodiments, the handheld device includes at least one retaining mechanism or portion thereof (e.g., a cover component or the like) that is configured to reversibly retain the interchangeable rotational component disposed in the rotational component receiving area. In some of these embodiments, the retaining mechanism or portion thereof comprises at least one attachment component or portion thereof that is configured to reversibly attach the retaining mechanism or portion thereof to the head and/or handle portion.

In some embodiments, the handheld device includes the interchangeable rotational component. In some of these embodiments, the interchangeable rotational component comprises the implement.

In another aspect, the invention provides a handheld device that includes a head portion comprising at least one housing that comprises top and bottom areas, wherein the top area comprises at least two top openings and the bottom area comprises at least two bottom openings, wherein the housing comprises at least two rotational component receiving areas that communicate with one or more of the top and bottom openings, wherein each of the rotational component receiving areas comprises at least a first rotational component body structure portion disposed at least partially within at least one of the rotational component receiving areas, which first rotational component body structure portion comprises a top surface, a bottom surface, and at least one orifice disposed at least partially through the first rotational component body structure portion, which orifice is configured to reversibly receive at least one section of at least a second rotational component body structure portion that comprises, or is configured to comprise, at least one implement through the top opening such that a segment of the second rotational component body structure portion is reversibly received in and/or through the top opening, wherein the first rotational component body structure portion comprises at least one gear component disposed on at least one segment of the first rotational component body structure portion between the top and bottom surfaces of the first rotational component body structure portion, and wherein the gear component of one of the first rotational component body structure portions operably engages the gear component of at least one other first rotational component body structure portion. The handheld device also includes at least one drive mechanism component or portion thereof that operably engages at least one of the gear components of the first rotational component body structure portions such that neighboring pairs of first rotational component body structure portions rotate in opposite directions relative to one another. In addition, the handheld device also includes a handle portion operably connected or connectable to the head portion. In some embodiments, the handle portion is reversibly connectable to the head portion.

In some embodiments, the handheld device includes more than two top openings, more than two bottom openings, more than two rotational component receiving areas, and/or more than two first rotational component body structure portions, wherein neighboring pairs of first rotational component body structure portions are configured to rotate in opposite directions relative to one another. In some embodiments, the handheld device includes more than two second rotational component body structure portions. In some of these embodiments, at least one of the second rotational component body structure portions lacks one or more implements. In some of these embodiments, one or more of the second rotational component body structure portions comprise, or are configured to comprise, the implement. In some of these embodiments, at least a portion of the implement comprises at least one cross-sectional shape selected from the group consisting of: a circle, an oval, a square, a rectangle, a trapezoid, an irregular n-sided polygon, and a regular n-sided polygon.

In some embodiments, one or more of the first rotational component body structure portions, the second rotational component body structure portions, and/or parts thereof comprise at least one resilient coupling that resiliently couples the portions and/or the parts thereof to one another. In some embodiments, one or more of the first and/or second rotational component body structure portions comprise at least one alignment component or portion thereof that is configured to reversibly align the first and second rotational component body structure portions relative to one another.

In some embodiments, the drive mechanism component or a portion thereof comprises at least one chain of meshed gear components that is configured to effect rotation of at least one of the first rotational component body structure portions. In some embodiments, the drive mechanism component or a portion thereof comprises at least one shaft component that is configured to effect rotation of at least one of the first rotational component body structure portions.

In some embodiments, the handheld device includes at least one retaining mechanism or portion thereof (e.g., a cover component or the like) that is configured to reversibly retain one or more of the first and/or second rotational component body structure portions disposed in the rotational component receiving areas. In some of these embodiments, the retaining mechanism or portion thereof comprises at least one attachment component or portion thereof that is configured to reversibly attach the retaining mechanism or portion thereof to the head and/or handle portion.

In some embodiments, the handheld device includes one or more of the second rotational component body structure portions. In some of these embodiments, the second rotational component body structure portions comprise the implements. In some of these embodiments, the implements of one of the second rotational component body structure portions are different from the implements of another of the second rotational component body structure portions.

In another aspect, the invention provides a handheld device that includes a head portion comprising at least one housing that comprises top and bottom areas, wherein the top area comprises at least one top opening, wherein the housing comprises at least one rotational component receiving area that communicates with the top opening, which rotational component receiving area is configured to reversibly receive at least a portion of at least one interchangeable rotational component through the top opening such that a segment of the interchangeable rotational component that comprises, or is configured to comprise, at least one implement is reversibly received in and/or through the top opening, which interchangeable rotational component comprises at least one gear component. The handheld device also includes at least one drive mechanism component or portion thereof that operably engages the gear component of the interchangeable rotational component and effects rotation of at least the interchangeable rotational component when the rotational component receiving area reversibly receives at least the portion of the interchangeable rotational component through the top opening. In addition, the handheld device also includes a handle portion operably connected or connectable to the head portion. In some embodiments, the handle portion is reversibly connectable to the head portion.

In some embodiments, the handheld device includes more than one top opening, one or more bottom openings, more than one rotational component receiving area, and/or more than one interchangeable rotational component, wherein neighboring pairs of the interchangeable rotational components are configured to rotate in opposite directions relative to one another.

In some embodiments, the handheld device includes more than one interchangeable rotational component. In some of these embodiments, at least one of the interchangeable rotational components lacks one or more implements. In some of these embodiments, one or more of the interchangeable rotational components comprise, or are configured to comprise, the implement. In some of these embodiments, at least a portion of the implement comprises at least one cross-sectional shape selected from the group consisting of: a circle, an oval, a square, a rectangle, a trapezoid, an irregular n-sided polygon, and a regular n-sided polygon.

In some embodiments, segments of the interchangeable rotational component comprise at least one resilient coupling that resiliently couples the segments to one another. In some embodiments, the interchangeable rotational component comprises at least one alignment component or portion thereof that is configured to reversibly align the interchangeable rotational component and the housing relative to one another.

In some embodiments, the drive mechanism component or a portion thereof comprises at least one chain of meshed gear components that is configured to effect rotation of at least the interchangeable rotational component when the rotational component receiving area reversibly receives at least the portion of the interchangeable rotational component through the top opening. In some embodiments, the drive mechanism component or a portion thereof comprises at least one shaft component that is configured to effect rotation of at least the interchangeable rotational component when the rotational component receiving area reversibly receives at least the portion of the interchangeable rotational component through the top opening.

In some embodiments, the handheld device includes at least one retaining mechanism or portion thereof (e.g., a cover component or the like) that is configured to reversibly retain the interchangeable rotational component disposed in the rotational component receiving area. In some embodiments, the retaining mechanism or portion thereof comprises at least one attachment component or portion thereof that is configured to reversibly attach the retaining mechanism or portion thereof to the head and/or handle portion.

In some embodiments, the handheld device includes the interchangeable rotational component. In some of these embodiments, the interchangeable rotational component comprises the implement.

In another aspect, the invention provides a handheld device that includes a head portion comprising at least one housing that comprises top and bottom areas, wherein the top area comprises at least one top opening and the bottom area comprises at least one bottom opening, wherein the housing comprises at least one rotational component receiving area that communicates with the top and bottom openings, which rotational component receiving area is configured to reversibly receive at least one interchangeable rotational component or portion thereof through the bottom opening such that a segment of the interchangeable rotational component or portion thereof is reversibly disposed in and/or through the top opening. The handheld device also includes at least one drive mechanism component or portion thereof that is configured to operably engage and effect rotation of at least the interchangeable rotational component or portion thereof at least partially around at least one rotational axis when the rotational component or portion thereof is received in the rotational component receiving area. In addition, the handheld device also includes a handle portion operably connected or connectable to the head portion.

In another aspect, the invention provides a tooth brushing device that includes a head portion comprising at least one housing that comprises top and bottom areas, wherein the top area comprises at least one top opening and the bottom area comprises at least one bottom opening, wherein the housing comprises at least one rotational component receiving area that communicates with the top and bottom openings, which rotational component receiving area is configured to reversibly receive one or more interchangeable rotational components or portions thereof through the bottom opening and wherein the top opening is configured to reversibly receive a segment of the interchangeable rotational components or portions thereof. The tooth brushing device also includes at least one drive mechanism component or portion thereof that is configured to operably engage and effect rotation of at least the interchangeable rotational components or portions thereof at least partially around at least one rotational axis when the interchangeable rotational components or portions thereof are disposed in the rotational component receiving area. In addition, the tooth brushing device also includes a handle portion operably connected or connectable to the head portion.

In another aspect, the invention provides a tooth brushing device that includes a head portion comprising at least one housing that comprises top and bottom areas, wherein the top area comprises at least one top opening and the bottom area comprises at least one bottom opening, wherein the housing comprises at least one rotational component receiving area that communicates with the top and bottom openings, which rotational component receiving area is configured to reversibly receive one or more interchangeable rotational components or portions thereof through the bottom opening and wherein the top opening is configured to reversibly receive a segment of the interchangeable rotational components or portions thereof. The tooth brushing device also includes at least one drive mechanism component or portion thereof that is configured to operably engage and effect rotation of at least the interchangeable rotational components or portions thereof at least partially around at least one rotational axis when the interchangeable rotational components or portions thereof are disposed in the rotational component receiving area. In addition, the tooth brushing device also includes a handle portion operably connected or connectable to the head portion.

In another aspect, the invention provides a handheld device that includes a head portion comprising at least one housing that comprises top and bottom areas, wherein the top area comprises at least one top opening and the bottom area comprises at least one bottom opening, wherein the housing comprises at least one rotational component receiving area that communicates with the top and bottom openings, which rotational component receiving area is configured to reversibly receive one or more interchangeable rotational components or portions thereof through the bottom opening and wherein the top opening is configured to reversibly receive a segment of the interchangeable rotational components or portions thereof. The handheld device also includes at least one interchangeable rotational component or portion thereof disposed in the rotational component receiving area, wherein the interchangeable rotational component comprises at least one gear component and wherein at least the segment of the interchangeable rotational component or portion thereof is disposed in and/or through the top opening. The handheld device also includes at least one drive mechanism component or portion thereof comprising at least one gear component that operably engages the gear component of the interchangeable rotational component or portion thereof, which drive mechanism component or portion thereof is configured to effect rotation of at least the interchangeable rotational component or portion thereof at least partially around at least one rotational axis. In addition, the handheld device also includes a handle portion operably connected to the head portion. In some embodiments, the handle portion is reversibly connectable to the head portion. In some embodiments, the segment of the interchangeable rotational component or portion thereof comprises at least one implement.

In some embodiments, the handheld device includes at least one retaining mechanism or portion thereof (e.g., a cover component or the like) that is configured to retain the interchangeable rotational component or portion thereof disposed in the rotational component receiving area at least when the interchangeable rotational component or portion thereof rotates at least partially around the rotational axis. In some of these embodiments, the retaining mechanism or portion thereof comprises at least one attachment component or portion thereof that is configured to reversibly attach the retaining mechanism or portion thereof to the head and/or handle portion.

In another aspect, the invention provides a handheld device that includes a head portion comprising at least one housing that comprises top and bottom areas, wherein the top area comprises at least one top opening and the bottom area comprises at least one bottom opening, wherein the housing comprises at least one rotational component receiving area that communicates with the top and bottom openings, which rotational component receiving area is configured to reversibly receive one or more interchangeable rotational components or portions thereof through the bottom opening and wherein the top opening is configured to reversibly receive a segment of the interchangeable rotational components or portions thereof. The handheld device also includes at least one interchangeable rotational component or portion thereof disposed in the rotational component receiving area, wherein the interchangeable rotational component or portion thereof comprises at least a first portion and is configured to comprise at least a second portion, wherein the first portion comprises at least one gear component, and wherein the second portion comprises at least a first segment that is configured to be disposed in and/or through the top opening. The handheld device also includes at least one drive mechanism component or portion thereof comprising at least one gear component that operably engages the gear component of the first portion of the interchangeable rotational component or portion thereof, which drive mechanism component or portion thereof is configured to effect rotation of at least the first portion of the interchangeable rotational component or portion thereof at least partially around at least one rotational axis. In additions, the handheld device also includes a handle portion operably connected to the head portion.

In some embodiments, the first and/or second portion comprises at least one attachment component or portion thereof that is configured to reversibly attach the first and second portions to one another. In some embodiments, the first and/or second portion comprises at least one alignment component or portion thereof that is configured to reversibly align the first and second portions relative to one another. In some embodiments, the first segment of the second portion comprises at least one implement. In some embodiments, the handle portion is reversibly connectable to the head portion.

In some embodiments, the handheld device includes at least one retaining mechanism or portion thereof (e.g., a cover component or the like) that is configured to retain the interchangeable rotational component or portion thereof disposed in the rotational component receiving area at least when the interchangeable rotational component or portion thereof rotates at least partially around the rotational axis. In some embodiments, the retaining mechanism or portion thereof comprises at least one attachment component or portion thereof that is configured to reversibly attach the retaining mechanism or portion thereof to the head and/or handle portion.

In another aspect, the invention provides a handheld device that includes a head portion comprising at least one housing that comprises top and bottom areas, wherein the top area comprises at least one top opening and the bottom area comprises at least one bottom opening, wherein the housing comprises at least one rotational component receiving area that communicates with the top and bottom openings, which rotational component receiving area is configured to reversibly receive one or more interchangeable rotational components or portions thereof at least through the top opening and wherein the bottom opening is configured to reversibly receive at least a segment of the interchangeable rotational components or portions thereof. The handheld device also includes at least one interchangeable rotational component or portion thereof disposed in the rotational component receiving area, wherein the interchangeable rotational component or portion thereof comprises at least a first portion comprising at least a first portion opening that is configured to reversibly receive at least a part of at least a second portion of the interchangeable rotational component or portion thereof, wherein the first portion comprises at least one gear component, and wherein the second portion comprises at least a first segment that is configured to be disposed in and/or through the top opening and at least a second segment that is configured to be disposed in and/or through the bottom opening. The handheld device also includes at least one drive mechanism component or portion thereof comprising at least one gear component that operably engages the gear component of the first portion of the interchangeable rotational component or portion thereof, which drive mechanism component or portion thereof is configured to effect rotation of at least the first portion of the interchangeable rotational component or portion thereof at least partially around at least one rotational axis. In addition, the handheld device also includes a handle portion operably connected to the head portion. In some embodiments, the first portion opening is disposed through the first portion of the interchangeable rotational component or portion thereof.

In some embodiments, the handheld device includes at least one retaining mechanism or portion thereof (e.g., a cover component or the like) that is configured to retain the interchangeable rotational component or portion thereof disposed in the rotational component receiving area at least when the interchangeable rotational component or portion thereof rotates at least partially around the rotational axis. In some of these embodiments, the retaining mechanism or portion thereof comprises at least one attachment component or portion thereof that is configured to reversibly attach the retaining mechanism or portion thereof to the head and/or handle portion. In some of these embodiments, the retaining mechanism or portion thereof comprises at least one recess component and wherein the second portion of the interchangeable rotational component or portion thereof comprises at least one tapered projection component, wherein the recess component and the tapered projection are configured to interlock with one another to reversibly retain the retaining mechanism and the second portion positioned relative to one another when the interchangeable rotational component or portion thereof rotates at least partially around the rotational axis. In some of these embodiments, the tapered projection component comprises at least one tenon and the recess component comprises at least one mortise (e.g., dovetail joint components, etc.). In some of these embodiments, the second segment of the second portion comprises the tapered projection component. In some embodiments, wherein the retaining mechanism or portion thereof comprises at least one recess component and wherein the second portion of the interchangeable rotational component or portion thereof comprises at least one projection component, wherein the recess component and the projection are configured to interlock with one another to reversibly retain the retaining mechanism and the second portion positioned relative to one another when the interchangeable rotational component or portion thereof rotates at least partially around the rotational axis. In some of these embodiments, at least portions of the recess component and the projection component that are configured to interlock with one another comprise at least one cross-sectional shape selected from the group consisting of: a circle, an oval, a square, a rectangle, a trapezoid, an irregular n-sided polygon, and a regular n-sided polygon.

In some embodiments, the first and/or second portion comprises at least one attachment component or portion thereof that is configured to reversibly attach the first and second portions to one another. In some embodiments, the first and/or second portion comprises at least one alignment component or portion thereof that is configured to reversibly align the first and second portions relative to one another. In some embodiments, the first segment of the second portion comprises at least one implement. In some embodiments, the handle portion is reversibly connectable to the head portion.

In another aspect, the invention provides a handheld device that includes a head portion comprising at least one housing that comprises top and bottom areas, wherein the top area comprises at least two top openings and the bottom area comprises at least two bottom openings, wherein the housing comprises at least two rotational component receiving areas that communicate with one or more of the top and bottom openings, which rotational component receiving areas are each configured to reversibly receive one or more interchangeable rotational components or portions thereof through the top and/or bottom opening, and wherein at least a first interchangeable rotational component is configured to rotate at least partially around a first rotational axis and wherein at least a second interchangeable rotational component is configured to rotate at least partially around a second rotational axis when the interchangeable rotational components are disposed in the rotational component receiving areas. The handheld device also includes at least one drive mechanism component or portion thereof that is configured to operably engage one or more of the interchangeable rotational components or portions thereof to effect rotation of at least a portion of the first interchangeable rotational component at least partially around the first rotational axis in a first direction and at least a portion of the second interchangeable rotational component at least partially around the second rotational axis in a second direction when the interchangeable rotational components are disposed in the rotational component receiving areas. In addition, the handheld device also includes a handle portion operably connected or connectable to the head portion.

In another aspect, the invention provides a device that includes at least one housing that comprises top and bottom areas, wherein the top area comprises at least one top opening and the bottom area comprises at least one bottom opening, wherein the housing comprises at least one rotational component receiving area that communicates with the top and bottom openings, which rotational component receiving area is configured to reversibly receive one or more interchangeable rotational components or portions thereof at least through the bottom opening and wherein the top opening is configured to reversibly receive at least a segment of the interchangeable rotational components or portions thereof. The device also includes at least one drive mechanism component or portion thereof that is configured to operably engage and effect rotation of at least the interchangeable rotational components or portions thereof at least partially around at least one rotational axis when the rotational components or portions thereof are disposed in the rotational component receiving area.

In another aspect, the invention provides interchangeable rotational component that includes at least one body structure portion that comprises a top surface and a bottom surface, wherein the top surface comprises, or is configured to comprise, at least one implement. The interchangeable rotational component also includes at least one gear component disposed on at least one segment of the body structure portion between the top and bottom surfaces, which gear component is configured to operably engage at least one gear component of another rotational component and/or a gear component of a drive mechanism component or portion thereof of a device. At least a segment of the body structure portion and/or the gear component of the interchangeable rotational component is configured to be reversibly received in at least one rotational component receiving area disposed in a housing of the device through a top and/or a bottom opening in the housing such that the drive mechanism component or portion thereof effects rotation of the interchangeable rotational component when the segment is received in the rotational component receiving area and the gear component of the interchangeable rotational component operably engages the gear component of another rotational component and/or the gear component of the drive mechanism component or portion thereof.

In some embodiments, the gear component of the interchangeable rotational component is disposed substantially around the portion of the body structure. In some embodiments, the body structure portion and/or the gear component of the interchangeable rotational component comprises at least one alignment component or portion thereof that is configured to reversibly align the interchangeable rotational component and at least the device housing relative to one another when the segment is received in the rotational component receiving area.

In some embodiments, the interchangeable rotational component includes the implement. In some of these embodiments, at least a portion of the implement comprises at least one cross-sectional shape selected from the group consisting of: a circle, an oval, a square, a rectangle, a trapezoid, an irregular n-sided polygon, and a regular n-sided polygon. In some of these embodiments, the implement comprises at least one flossing component. In some of these embodiments, the implement comprises at least one bristle component. In some of these embodiments, the implement comprises at least one polishing component. In some embodiments, the implement comprises at least one cap component.

In another aspect, the invention provides interchangeable rotational component that includes at least a first rotational component body structure portion that comprises a top surface, a bottom surface, and at least one orifice disposed at least partially through the first rotational component body structure portion, which orifice is configured to reversibly receive at least one segment of at least one second rotational component body structure portion. The interchangeable rotational component also includes at least a second rotational component body structure portion that comprises a top surface and a bottom surface, wherein the top surface comprises, or is configured to comprise, at least one implement. In addition, the interchangeable rotational component also includes at least one gear component disposed on at least one segment of the first rotational component body structure portion between the top and bottom surfaces of the first rotational component body structure portion, which gear component is configured to operably engage at least one gear component of another rotational component and/or a gear component of a drive mechanism component or portion thereof of a device. At least a segment of the interchangeable rotational component is configured to be reversibly received in at least one rotational component receiving area disposed in a housing of the device through a top and/or a bottom opening in the housing such that the drive mechanism component or portion thereof effects rotation of the interchangeable rotational component when the segment of the interchangeable rotational component is received in the rotational component receiving area and the gear component of the interchangeable rotational component operably engages the gear component of another rotational component and/or the gear component of the drive mechanism component or portion thereof.

In some embodiments, the first and/or second rotational component body structure portion comprises at least one attachment component or portion thereof that is configured to reversibly attach the first and second rotational component body structure portions to one another. In some embodiments, the first and/or second rotational component body structure portion comprises at least one alignment component or portion thereof that is configured to reversibly align the first and second rotational component body structure portions relative to one another. In some embodiments, the gear component of the first rotational component body structure portion is disposed substantially around the first rotational component body structure portion.

In some embodiments, the interchangeable rotational component includes at least one tapered projection component configured to interlock with at least one recess component of at least one retaining mechanism (e.g., a cover component or the like) of the device to reversibly retain the interchangeable rotational component or portion thereof and the retaining mechanism positioned relative to one another when the interchangeable rotational component or portion thereof is received in the rotational component receiving area and rotates at least partially around a rotational axis. In some embodiments, the interchangeable rotational component includes at least one projection component configured to interlock with at least one recess component of at least one retaining mechanism of the device to reversibly retain the interchangeable rotational component or portion thereof and the retaining mechanism positioned relative to one another when the interchangeable rotational component or portion thereof is received in the rotational component receiving area and rotates at least partially around a rotational axis. In some of these embodiments, at least portions of the recess component and the projection component that are configured to interlock with one another comprise at least one cross-sectional shape selected from the group consisting of: a circle, an oval, a square, a rectangle, a trapezoid, an irregular n-sided polygon, and a regular n-sided polygon.

In some embodiments, the interchangeable rotational component includes the implement. In some of these embodiments, at least a portion of the implement comprises at least one cross-sectional shape selected from the group consisting of: a circle, an oval, a square, a rectangle, a trapezoid, an irregular n-sided polygon, and a regular n-sided polygon. In some of these embodiments, the implement comprises at least one flossing component. In some of these embodiments, the implement comprises at least one bristle component. In some of these embodiments, the implement comprises at least one polishing component. In some embodiments, the implement comprises at least one cap component.

In another aspect, the invention provides a method of positioning a rotational component in a device. The method includes placing at least part of at least one rotational component through at least one top opening of a housing of the device into at least one rotational component receiving area that communicates with the top opening such that at least one gear component of the rotational component operably engages at least one drive mechanism component or portion thereof of the device. The method also includes placing a retaining mechanism (e.g., a cover component or the like) at least proximal to the top opening such that at least a portion of the rotational component comprising at least one implement extends at least partially through at least one orifice of the retaining mechanism to retain the rotational component in the rotational component receiving area, thereby positioning the rotational component in the device.

In another aspect, the invention provides a method of interchanging rotational components of a device. The method includes moving at least one retaining mechanism of the device such that at least two openings of a housing of the device are exposed. The method also includes removing at least first and second rotational components or portions thereof through the openings, wherein at least one of the first and second rotational components or portions thereof comprises one or more implements. The method also includes placing at least segments of at least third and fourth rotational components or portions thereof through the openings of the housing, wherein at least one of the third and fourth rotational components or portions thereof comprises one or more implements. The method also includes moving the retaining mechanism of the device such that the openings of the housing of the device are at least partially covered to retain the third and fourth rotational components or portions thereof are retained in the housing of the device, thereby interchanging the rotational components of the device.

In another aspect, the invention provides a handheld device that includes a head portion comprising at least one housing that comprises top, bottom, and side areas, wherein the top area comprises at least one top opening and the side area comprises at least one side opening, wherein the housing comprises at least one rotational component receiving area that communicates with the top and side openings, which rotational component receiving area is configured to reversibly receive at least one interchangeable rotational component or portion thereof at least through the side opening such that a segment of the interchangeable rotational component or portion thereof is reversibly disposed in and/or through the top opening. The handheld device also includes at least one drive mechanism component or portion thereof that is configured to operably engage and effect rotation of at least the interchangeable rotational component or portion thereof at least partially around at least one rotational axis when the rotational component or portion thereof is received in the rotational component receiving area. In addition, the handheld device also includes a handle portion operably connected or connectable to the head portion. In some embodiments, the handheld device includes at least one retaining mechanism or portion thereof that is configured to reversibly retain the interchangeable rotational component or portion thereof disposed in the rotational component receiving area. In some of these embodiments, the retaining mechanism or portion thereof comprises at least one movable segment that is configured to move such that the interchangeable rotational component or portion thereof is reversibly receivable at least through the side opening. In some embodiments, the handheld device includes at least one coupling component that movably couples the movable segment at least to the housing. In some of these embodiments, the coupling component comprises at least one hinge component or the like.

In another aspect, the invention provides an interchangeable rotational component that includes at least one body structure portion that comprises a top surface and a bottom surface, wherein the top surface comprises, or is configured to comprise, at least one implement, which body structure portion comprises, or is configured to comprise, at least one gear component, which gear component is configured to operably engage at least one gear component of another rotational component and/or a gear component of a drive mechanism component or portion thereof of a device, wherein at least a segment of the body structure portion and/or the gear component of the interchangeable rotational component is configured to be reversibly received in at least one rotational component receiving area disposed in a housing of the device such that the drive mechanism component or portion thereof effects rotation of the interchangeable rotational component when the segment is received in the rotational component receiving area and the gear component of the interchangeable rotational component operably engages the gear component of another rotational component and/or the gear component of the drive mechanism component or portion thereof.

In one aspect, the invention provides a toothbrush head component that includes a housing comprising a head portion and a neck portion that are operably connected to one another, wherein the head portion comprises a top area that comprises at least first and second top openings, and wherein the head portion comprises at least first and second rotational component receiving areas that communicate with one or more of the top openings. The toothbrush head component also includes a first rotational component that is configured to rotate around a first rotational axis, which first rotational component comprises a first body structure component that is at least partially disposed in the first rotational component receiving area, which first body structure component comprises at least first and second gear components, and at least one orifice disposed at least partially through the first body structure component, which orifice is configured to reversibly receive at least one section of at least a first interchangeable rotational component through the first top opening such that a segment of the first interchangeable rotational component is reversibly received in and/or through the first top opening. The toothbrush head component also includes a second rotational component that is configured to rotate around a second rotational axis, wherein the first and second rotational axes are substantially parallel to one another, which second rotational component comprises a second body structure component that is at least partially disposed in the second rotational component receiving area, which second body structure component comprises at least a first gear component and at least one orifice disposed at least partially through the second body structure component, which orifice is configured to reversibly receive at least one section of at least a second interchangeable rotational component through the second top opening such that a segment of the second interchangeable rotational component is reversibly received in and/or through the second top opening, wherein the first and/or second interchangeable rotational component comprises, or is configured to comprise, at least one implement, and wherein the first gear component of the second body structure component operably engages the first gear component of the first body structure component. In addition, the toothbrush head component also includes a drive mechanism component or portion thereof at least partially disposed in the neck portion of the housing, which drive mechanism component or portion thereof comprises at least one shaft component that is configured to rotate around a third rotational axis, which shaft component comprises at least one shaft gear component that operably engages the second gear component of the first body structure component such that when the shaft component continuously rotates in one direction around the third rotational axis, the first rotational component continuously rotates in a first direction around the first rotational axis and the second rotational component continuously rotates in a second direction around the second rotational axis, wherein the first and second directions are substantially opposite one another.

In some embodiments, the third rotational axis is substantially perpendicular to, and intersects with, the first and second rotational axes. In some embodiments, at least one retaining mechanism or portion thereof that is configured to reversibly retain at least one of the interchangeable rotational components when the orifice reversibly receives the section of the interchangeable rotational component. In some embodiments, the toothbrush head component includes a handle portion operably connected or connectable to the head portion. In some embodiments, the toothbrush head component includes the first and/or second interchangeable rotational component. In some embodiments, at least a portion of the implement comprises at least one cross-sectional shape selected from the group consisting of: a circle, an oval, a square, a rectangle, a trapezoid, an irregular n-sided polygon, and a regular n-sided polygon. In some embodiments, the implement is selected from the group consisting of: a flossing component, a bristle component, a polishing component, and a cap component. In some embodiments, an interchangeable rotational component is configured to be reversibly received by one or more of the orifices of the toothbrush head component. In some embodiments, a tooth brushing device includes the toothbrush head component. In some embodiments, the head portion comprises a bottom area that comprises at least first and second bottom openings and wherein one or more of the first and second rotational component receiving areas communicate with one or more of the bottom openings.

In another aspect, the invention provides a toothbrush rotational component that includes a body structure component that comprises at least first and second gear components, and at least one orifice disposed at least partially through the body structure component, wherein the first gear component of the body structure component is configured to operably engage at least one gear component of another toothbrush rotational component and wherein the second gear component of the body structure component is configured to operably engage at least one shaft gear component of a toothbrush head component. The toothbrush rotational component also includes an interchangeable rotational component that comprises, or is configured to comprise, at least one implement, wherein at least one section of the interchangeable rotational component is reversibly received in the orifice of the body structure component.

In some embodiments, at least one retaining mechanism or portion thereof that is configured to reversibly retain the section of the interchangeable rotational component in the orifice of the body structure component. In some embodiments, at least a portion of the implement comprises at least one cross-sectional shape selected from the group consisting of: a circle, an oval, a square, a rectangle, a trapezoid, an irregular n-sided polygon, and a regular n-sided polygon. In some embodiments, the implement is selected from the group consisting of: a flossing component, a bristle component, a polishing component, and a cap component.

In another aspect, the invention provides an interchangeable rotational component that includes a base component comprising top and bottom surfaces, wherein at least one implement extends from the top surface, and at least one shaft component that extends from the bottom surface of the base component, which shaft component is configured to be received, and reversibly retained, at least partially in an orifice of a body structure component of a toothbrush rotational component.

In some embodiments, at least a portion of the implement comprises at least one cross-sectional shape selected from the group consisting of: a circle, an oval, a square, a rectangle, a trapezoid, an irregular n-sided polygon, and a regular n-sided polygon. In some embodiments, the implement is selected from the group consisting of: a flossing component, a bristle component, a polishing component, and a cap component. In some embodiments, the interchangeable rotational component includes at least a portion of a retaining mechanism that reversibly retains the interchangeable rotational component positioned relative to the body structure component of the toothbrush rotational component when the shaft component is at least partially disposed in the orifice of the body structure component of the toothbrush rotational component. In some embodiments, the shaft component comprises the portion of the retaining mechanism, which portion of the retaining mechanism is configured to engage another portion of the retaining mechanism that is disposed on a one or more surfaces that define the orifice of the body structure component. In some of these embodiments, the retaining mechanism comprises one or more resilient coupling components.

In another aspect, the invention provides a handheld device that includes a head portion comprising at least one housing that comprises a top area, wherein the top area comprises at least one top opening, wherein the housing comprises at least one rotational component receiving area that communicates with the top opening. The handheld device also includes at least a first rotational component body structure portion disposed at least partially within the rotational component receiving area, which first rotational component body structure portion comprises at least one orifice disposed at least partially through the first rotational component body structure portion, which orifice is configured to reversibly receive at least one section of at least a second rotational component body structure portion through the top opening such that a segment of the second rotational component body structure portion is reversibly received in and/or through the top opening, and wherein the first rotational component body structure portion comprises at least one gear component. The handheld device also includes at least one drive mechanism component or portion thereof that operably engages the gear component of the first rotational component body structure portion and effects rotation of at least the first rotational component body structure portion and the second rotational component body structure portion at least partially around at least one rotational axis when the orifice reversibly receives the second rotational component body structure portion through the bottom opening. In addition, the handheld device also includes a handle portion operably connected or connectable to the head portion.

In some embodiments, the handle portion is reversibly connectable to the head portion. In some embodiments, the handheld device includes more than one top opening. In some embodiments, the handheld device includes more than one bottom opening. In some embodiments, the handheld device includes more than one rotational component receiving area. In some embodiments, the handheld device includes more than one first rotational component body structure portion, wherein neighboring pairs of first rotational component body structure portions are configured to rotate in opposite directions relative to one another. In some embodiments, the handheld device includes more than one second rotational component body structure portion. In some embodiments, the handheld device includes at least one retaining mechanism or portion thereof that is configured to reversibly retain the first and/or second rotational component body structure portion disposed in the rotational component receiving area.

In some embodiments, the first rotational component body structure portion, the second rotational component body structure portion, and/or parts thereof comprise at least one resilient coupling that resiliently couples the portions and/or the parts thereof to one another. In some embodiments, the first and/or second rotational component body structure portion comprises at least one alignment component or portion thereof that is configured to reversibly align the first and second rotational component body structure portions relative to one another. In some embodiments, the drive mechanism component or a portion thereof comprises at least one chain of meshed gear components that is configured to effect rotation of at least the first rotational component body structure portion and the second rotational component body structure portion when the orifice reversibly receives the second rotational component body structure portion through the top opening. In some embodiments, the drive mechanism component or a portion thereof comprises at least one shaft component that is configured to effect rotation of at least the first rotational component body structure portion and the second rotational component body structure portion when the orifice reversibly receives the second rotational component body structure portion through the top opening. In some embodiments, the shaft component comprises at least one shaft gear component that meshes with the gear component of the first rotational component body structure portion. In some embodiments, at least one of the second rotational component body structure portions lacks one or more implements. In some embodiments, one or more of the second rotational component body structure portions comprise, or are configured to comprise, at least one implement. In some embodiments, at least a portion of the implement comprises at least one cross-sectional shape selected from the group consisting of: a circle, an oval, a square, a rectangle, a trapezoid, an irregular n-sided polygon, and a regular n-sided polygon. In some embodiments, the retaining mechanism or portion thereof comprises at least one attachment component or portion thereof that is configured to reversibly attach the retaining mechanism or portion thereof to the head and/or handle portion. In some of these embodiments, the housing comprises a bottom area that comprises at least one bottom opening that communicates with the orifice and the top opening.

In some embodiments, the handle portion includes the second rotational component body structure portion. In some of these embodiments, the second rotational component body structure portion comprises at least one implement. In some of these embodiments, the second rotational component body structure portion is configured to comprise at least one implement.

In some embodiments, the first rotational component body structure portion and/or the head portion comprises at least one alignment structure or portion thereof (e.g., a bearing surface structure, etc.) that is configured to align the first rotational component body structure portion and the head portion relative to one another at least when the first rotational component body structure portion rotates at least partially around the rotational axis. In some of these embodiments, the alignment structure or portion thereof comprises at least one protrusion component and at least one protrusion component receiving area that is configured to receive the protrusion component. In some of these embodiments, the first rotational component body structure portion comprises the protrusion component and wherein the housing and/or at least one housing component structure at least partially disposed in the housing comprises the protrusion component receiving area. In some of these embodiments, the first rotational component body structure portion comprises the protrusion component receiving area and wherein the housing or a housing component structure at least partially disposed in the housing comprises the protrusion component. In some of these embodiments, the first rotational component body structure portion comprises a top surface and a bottom surface, wherein the gear component is disposed on at least one segment of the first rotational component body structure portion between the top and bottom surfaces, wherein a top protrusion component extends from the top surface, and wherein a bottom protrusion component extends from the bottom surface. In some of these embodiments, the housing and/or the at least one housing component structure comprises a top protrusion component receiving area that is configured to receive the top protrusion component and a bottom protrusion component receiving area that is configured to receive the bottom protrusion component. In some of these embodiments, the first rotational component body structure portion comprises the protrusion component and wherein the protrusion component comprises at least a portion of the orifice. In some of these embodiments, the orifice is disposed through the first rotational component body structure portion. In some of these embodiments, at least a portion of the orifice of the first rotational component body structure portion comprises at least one cross-sectional shape selected from the group consisting of: a circle, an oval, a square, a rectangle, a trapezoid, a hexagon, an irregular n-sided polygon, and a regular n-sided polygon. In some of these embodiments, at least a portion of the orifice comprises at least one cross-sectional shape selected from the group consisting of: a circle, an oval, a square, a rectangle, a trapezoid, a hexagon, an irregular n-sided polygon, and a regular n-sided polygon. In some of these embodiments, at least a portion of the section of the second rotational component body structure portion comprises at least one cross-sectional shape selected from the group consisting of: a circle, an oval, a square, a rectangle, a trapezoid, a hexagon, an irregular n-sided polygon, and a regular n-sided polygon.

In another aspect, the invention provides a handheld device that includes a head portion comprising at least one housing that comprises a top area, wherein the top area comprises at least two top openings, wherein the housing comprises at least one rotational component receiving area that communicates with the top openings. The handheld device also includes at least a two rotational components disposed at least partially within the rotational component receiving areas, wherein at least a first rotational component is configured to rotate at least partially around a first rotational axis, wherein at least a second rotational component is configured to rotate at least partially around a second rotational axis, wherein the first and second rotational components each comprise at least a first gear component, wherein the first gear components of the first and second rotational components operably engage one another, wherein at least one of the rotational components comprises at least a second gear component, and wherein at least one of the rotational components comprises at least one implement. The handheld device also includes at least one drive mechanism component or portion thereof comprising at least one shaft component that comprises at least one shaft gear component that operably engages the second gear component, which drive mechanism component or portion thereof effects rotation of the first rotational component at least partially around the first rotational axis and the second rotational component at least partially around the second rotational axis such that when the first rotational component rotates in a first direction, the second rotational component rotates in a second direction, which first and second directions are substantially opposite one another. In addition, the handheld device also includes a handle portion operably connected or connectable to the head portion.

In another aspect, the invention provides a handheld device head portion that includes a head portion configured to reversibly operably connect to a handle portion of at least one handheld device, which head portion comprises at least one housing that comprises a top area comprising at least two top openings that communicate with at least one rotational component receiving area that is at least partially disposed within the housing. The handheld device head portion also includes at least a two rotational components disposed at least partially within the rotational component receiving areas, wherein at least a first rotational component is configured to rotate at least partially around a first rotational axis, wherein at least a second rotational component is configured to rotate at least partially around a second rotational axis, wherein the first and second rotational components each comprise at least a first gear component, wherein the first gear components of the first and second rotational components operably engage one another, wherein at least one of the rotational components comprises at least a second gear component, and wherein at least one of the rotational components comprises at least one implement. In addition, the handheld device head portion also includes at least one shaft component or portion thereof that comprises at least one shaft gear component that operably engages the second gear component, which shaft component or portion thereof is configured to effect rotation of the first rotational component at least partially around the first rotational axis and the second rotational component at least partially around the second rotational axis such that when the first rotational component rotates in a first direction, the second rotational component rotates in a second direction, which first and second directions are substantially opposite one another.

### BRIEF DESCRIPTION OF THE DRAWINGS

The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown.

FIGS. 1A-J schematically illustrate tooth brushing devices or components thereof from various views according to certain embodiments of the invention. FIGS. 1A-C schematically show a rotational component from bottom, top, and side views, respectively. FIGS. 1D and E schematically show rotational components and drive mechanism components or portions thereof from bottom and top views according to one embodiment of the invention. FIG. 1F schematically illustrates the rotational components and drive mechanism components or portions thereof from FIG. 1E operably connected to motor and power source components from a side view. FIG. 1G schematically depict rotational components operably connected to drive mechanism components from a side view according to one embodiment of the invention. FIG. 1H schematically shows a tooth brushing device that includes the rotational components and drive mechanism components from FIG. 1F from a partially transparent side view according to one embodiment of the invention. FIGS. 1 I and J schematically show the tooth brushing device of FIG. 1H from side and top views, respectively.

FIGS. 2A-G schematically illustrate various rotational components from side views according to exemplary embodiments of the invention.

FIG. 3 schematically shows a head portion of a tooth brushing device from partially transparent top view according to one embodiment of the invention.

FIGS. 4A-C schematically illustrate a rotational component, or portions thereof, that include at least one resilient coupling from side views according to one exemplary embodiment of the invention. FIGS. 4 A and B are shown from partial sectional side views.

FIGS. 5A-C schematically illustrate a rotational component, or portions thereof, that include at least one resilient coupling from side views according to one exemplary embodiment of the invention. FIGS. 5 A and B are shown from partial sectional side views.

FIGS. 6A-C schematically illustrate a rotational component, or portions thereof, that include at least one resilient coupling from side views according to one exemplary embodiment of the invention. FIGS. 6 A and B are shown from partial sectional side views.

FIGS. 7A-C schematically illustrate a rotational component, or portions thereof, that include at least one resilient coupling from side views according to one exemplary embodiment of the invention.

FIGS. 8A-C schematically illustrate a rotational component, or portions thereof, that include at least one resilient coupling from side views according to one exemplary embodiment of the invention.

FIG. 9 schematically illustrates rotational components having resilient couplings and drive mechanism components or portions thereof operably connected to motor and power source components from a side view according to one embodiment of the invention.

FIG. 10 schematically illustrates rotational components having resilient couplings and drive mechanism components or portions thereof operably connected to motor and power source components from a side view according to one embodiment of the invention.

FIG. 11 schematically shows a handheld device that includes rotational components having resilient couplings from a side view according to one embodiment of the invention.

FIGS. 12A-H schematically illustrate a handheld device or portions thereof from various views according to one embodiment of the invention. FIG. 12A schematically depicts a bottom cutaway broken view of a head portion of the handheld device. FIG. 12B schematically shows a rotational component from a top view. FIG. 12C schematically shows an exploded side broken view of the head portion of the handheld device with interchangeable rotational components and a retaining mechanism. FIG. 12D schematically illustrates a side cutaway broken view of the head portion of the handheld device with interchangeable rotational components in rotational component receiving areas and a retaining mechanism. FIG. 12E schematically shows the handheld device from a cutaway side view. FIG. 12F schematically shows a side broken view of the head portion of the handheld device with interchangeable rotational components and a retaining mechanism. FIG. 12G schematically shows a top broken view of the head portion of the handheld device with interchangeable rotational components and a retaining mechanism. FIG. 12H schematically shows the handheld device from a side view.

FIGS. 13A-F schematically illustrate a handheld device or portions thereof from various views according to one embodiment of the invention. FIG. 13A schematically depicts a top cutaway broken view of a head portion of the handheld device. FIG. 13B schematically depicts a top view of a retaining mechanism of the handheld device. FIG. 13C schematically shows an exploded side cutaway broken view of a head portion of the handheld device. FIG. 13D schematically shows a side view of a head portion of the handheld device. FIG. 13E schematically shows the handheld device from a side view. FIG. 13E schematically shows an interchangeable rotational component that is configured to comprise an implement (e.g., the implement is optionally interchangeable).

FIGS. 14A-G schematically illustrate an interchangeable rotational component or portions thereof from various views according to an exemplary embodiment of the invention. FIG. 14A schematically depicts a second rotational component body structure portion from a top view. FIG. 14B schematically depicts the second rotational component body structure portion from FIG. 14A from a side view. FIG. 14C schematically depicts the second rotational component body structure portion from FIG. 14A from a bottom view. FIG. 14D schematically depicts a first rotational component body structure portion from a top view. FIG. 14E schematically depicts a rotational component that includes first and second rotational component body structure portions from a side view. FIG. 14F schematically depicts the rotational component from FIG. 14E from a top view. FIG. 14G schematically depicts the rotational component from FIG. 14E from a bottom view.

FIGS. 15A-U schematically illustrate a handheld device or portions thereof from various views according to an exemplary embodiment of the invention. FIG. 15A schematically depicts a bottom cutaway broken view of a head portion of the handheld device. FIG. 15B schematically depicts a top cutaway broken view of a head portion of the handheld device with second rotational component body structure portions of interchangeable rotational components positioned in rotational component receiving areas. FIG. 15C schematically depicts a head portion of the handheld device without second rotational component body structure portions of interchangeable rotational components positioned in rotational component receiving areas from a broken bottom view. FIG. 15D schematically depicts a side cutaway broken view of a head portion of the handheld device with a retaining mechanism and without second rotational component body structure portions of interchangeable rotational components positioned in rotational component receiving areas. FIG. 15E schematically depicts a head portion of the handheld device with second rotational component body structure portions of interchangeable rotational components positioned in rotational component receiving areas from a broken top view. FIG. 15F schematically depicts a head portion of the handheld device prior to positioning a retaining mechanism from a broken bottom view. FIG. 15G schematically depicts a retaining mechanism of the handheld device from a top view. FIG. 15H schematically depicts a head portion of the handheld device with a retaining mechanism from a broken bottom view. FIG. 15I schematically depicts a head portion of the handheld device with a retaining mechanism from a broken side view. FIG. 15J schematically depicts an exploded side cutaway broken view of a head portion of the handheld device with a retaining mechanism and second rotational component body structure portions of interchangeable rotational components prior to assembly. FIG. 15K schematically depicts a side cutaway broken view of a head portion of the handheld device with a retaining mechanism and second rotational component body structure portions of interchangeable rotational components following assembly. FIG. 15L schematically depicts an exploded side broken view of a head portion of the handheld device with a retaining mechanism and second rotational component body structure portions of interchangeable rotational components prior to assembly. FIG. 15M schematically depicts an exploded side broken view of a head portion of the handheld device with a retaining mechanism and a second rotational component body structure portion of an interchangeable rotational component positioned in a rotational component receiving area of the handheld device. FIG. 15N schematically depicts an exploded side broken view of a head portion of the handheld device with second rotational component body structure portions of interchangeable rotational components positioned in rotational component receiving areas of the handheld device prior to positioning a retaining mechanism. FIG. 15O schematically depicts a side broken view of a head portion of the handheld device with a retaining mechanism and second rotational component body structure portions of interchangeable rotational components positioned following assembly. FIG. 15P schematically depicts an exploded front cutaway broken view of a head portion of the handheld device with a retaining mechanism and a second rotational component body structure portion of an interchangeable rotational component prior to assembly. FIG. 15Q schematically depicts an exploded front cutaway broken view of a head portion of the handheld device with a second rotational component body structure portion of an interchangeable rotational component positioned in a rotational component receiving area of the handheld device prior to positioning a retaining mechanism. FIG. 15R schematically depicts a front cutaway broken view of a head portion of the handheld device with a retaining mechanism and second rotational component body structure portion of an interchangeable rotational component following assembly. FIG. 15S schematically depicts an exploded front broken view of a head portion of the handheld device with a second rotational component body structure portion of an interchangeable rotational component positioned in a rotational component receiving area of the handheld device prior to positioning a retaining mechanism. FIG. 15T schematically depicts a front broken view of a head portion of the handheld device with a retaining mechanism and second rotational component body structure portion of an interchangeable rotational component following assembly. FIG. 15U schematically shows the handheld device from a side view. FIG. 15V schematically shows a handheld device that includes only one rotational component receiving area and interchangeable rotational component from a side view according to one exemplary embodiment.

FIGS. 16A-G schematically illustrate various second rotational component body structure portions from side views according to exemplary embodiments of the invention.

FIGS. 17A-G schematically illustrate an interchangeable rotational component or portions thereof from various views according to an exemplary embodiment of the invention. FIG. 17A schematically depicts a second rotational component body structure portion from a top view. FIG. 17B schematically depicts the second rotational component body structure portion from FIG. 17A from a side view. FIG. 17C schematically depicts the second rotational component body structure portion from FIG. 17A from a bottom view. FIG. 17D schematically depicts a first rotational component body structure portion from a bottom view. FIG. 17E schematically depicts a rotational component that includes first and second rotational component body structure portions from a side view. FIG. 17F schematically depicts the rotational component from FIG. 17E from a top view. FIG. 17G schematically depicts the rotational component from FIG. 17E from a bottom view.

FIGS. 18A-U schematically illustrate a handheld device or portions thereof from various views according to an exemplary embodiment of the invention. FIG. 18A schematically depicts a top cutaway broken view of a head portion of the handheld device. FIG. 18B schematically depicts a top cutaway broken view of a head portion of the handheld device with second rotational component body structure portions of interchangeable rotational components positioned in rotational component receiving areas. FIG. 18C schematically depicts a head portion of the handheld device without second rotational component body structure portions of interchangeable rotational components positioned in rotational component receiving areas from a top cutaway broken view. FIG. 18D schematically depicts a head portion of the handheld device without second rotational component body structure portions of interchangeable rotational components positioned in rotational component receiving areas from a bottom cutaway broken view. FIG. 18E schematically depicts a bottom cutaway broken view of a head portion of the handheld device with second rotational component body structure portions of interchangeable rotational components positioned in rotational component receiving areas. FIG. 18F schematically depicts a side cutaway broken view of a head portion of the handheld device with a retaining mechanism and without second rotational component body structure portions of interchangeable rotational components positioned in rotational component receiving areas. FIG. 18G schematically depicts a head portion of the handheld device with second rotational component body structure portions of interchangeable rotational components positioned in rotational component receiving areas from a broken top view. FIG. 18H schematically depicts a side broken view of a head portion of the handheld device with a retaining mechanism and without second rotational component body structure portions of interchangeable rotational components positioned in rotational component receiving areas. FIG. 18I schematically depicts a head portion of the handheld device without second rotational component body structure portions of interchangeable rotational components positioned in rotational component receiving areas from a broken top view. FIG. 18J schematically depicts an exploded side cutaway broken view of a head portion of the handheld device with a retaining mechanism and second rotational component body structure portions of interchangeable rotational components prior to assembly. FIG. 18K schematically depicts an exploded side cutaway broken view of a head portion of the handheld device with second rotational component body structure portions of interchangeable rotational components positioned in rotational component receiving areas of the handheld device prior to positioning a retaining mechanism. FIG. 18L schematically depicts a side cutaway broken view of a head portion of the handheld device with a retaining mechanism and second rotational component body structure portions of interchangeable rotational components following assembly. FIG. 18M schematically depicts an exploded side broken view of a head portion of the handheld device with a retaining mechanism and second rotational component body structure portions of interchangeable rotational components prior to assembly. FIG. 18N schematically depicts an exploded side broken view of a head portion of the handheld device with second rotational component body structure portions of interchangeable rotational components positioned in rotational component receiving areas of the handheld device prior to positioning a retaining mechanism. FIG. 18O schematically depicts a side broken view of a head portion of the handheld device with a retaining mechanism and second rotational component body structure portions of interchangeable rotational components following assembly. FIG. 18P schematically depicts a head portion of the handheld device without second rotational component body structure portions of interchangeable rotational components positioned in rotational component receiving areas from a bottom broken view. FIG. 18Q schematically depicts a retaining mechanism of the handheld device from a bottom view. FIG. 18R schematically depicts a retaining mechanism of the handheld device from a top view. FIG. 18S schematically depicts an exploded bottom broken view of a head portion of the handheld device with a retaining mechanism and second rotational component body structure portions of interchangeable rotational components prior to assembly. FIG. 18T schematically depicts an exploded bottom broken view of a head portion of the handheld device with second rotational component body structure portions of interchangeable rotational components positioned in rotational component receiving areas of the handheld device prior to positioning a retaining mechanism. FIG. 18U schematically depicts a bottom broken view of a head portion of the handheld device with a retaining mechanism and second rotational component body structure portions of interchangeable rotational components following assembly. FIG. 18V schematically depicts a front cutaway broken view of a head portion of the handheld device with a retaining mechanism and without second rotational component body structure portions of interchangeable rotational components positioned in rotational component receiving areas. FIG. 18W schematically depicts a front cutaway broken view of a head portion of the handheld device with a retaining mechanism and second rotational component body structure portions of interchangeable rotational components following assembly. FIG. 18X schematically depicts a front broken view of a head portion of the handheld device with a retaining mechanism and without second rotational component body structure portions of interchangeable rotational components positioned in rotational component receiving areas. FIG. 18Y schematically depicts an exploded front broken view of a head portion of the handheld device with a retaining mechanism and second rotational component body structure portions of interchangeable rotational components prior to assembly. FIG. 18Z schematically depicts an exploded front broken view of a head portion of the handheld device with second rotational component body structure portions of interchangeable rotational components positioned in rotational component receiving areas of the handheld device prior to positioning a retaining mechanism. FIG. 18AA schematically depicts a front broken view of a head portion of the handheld device with a retaining mechanism and second rotational component body structure portions of interchangeable rotational components following assembly. FIG. 18BB schematically shows the handheld device from a side view. FIG. 18CC schematically shows a handheld device that includes only one rotational component receiving area and interchangeable rotational component from a side view according to one exemplary embodiment.

FIGS. 19A-G schematically illustrate various second rotational component body structure portions from side views according to exemplary embodiments of the invention.

FIGS. 20A-D schematically illustrate a handheld device or portions thereof from various views according to an exemplary embodiment of the invention. FIG. 20A schematically depicts a top partial cutaway broken view of a head portion of the handheld device. FIG. 20B schematically depicts a top partial cutaway broken view of the head portion of the handheld device with movable segments positioned such that interchangeable rotational components are reversibly receivable at least through a side opening of the head portion. FIG. 20C schematically shows a side view of a head portion of the handheld device. FIG. 20D schematically shows the handheld device from a side view.

FIG. 21A schematically shows rotational components and a shaft gear component positioned relative to one another from a side view according to one exemplary embodiment of the invention. FIG. 21B schematically shows the rotational components and shaft gear component from FIG. 21A from a bottom view.

FIG. 22 schematically shows an interchangeable rotational component from a side view according to one exemplary embodiment of the invention.

FIGS. 23A-F schematically illustrates a segment of a head portion of a toothbrush or portions thereof from various views according to an exemplary embodiment of the invention. FIG. 23A schematically shows the segment of the head portion of the toothbrush from a side sectional view. FIG. 23B schematically shows an interchangeable rotational component from a perspective view. FIG. 23C schematically depicts a rotational component from the segment of the head portion of the toothbrush from FIG. 23A from a perspective view. FIG. 23D schematically depicts the rotational component from FIG. 23C from a bottom view. FIG. 23E schematically depicts a shaft gear component from the segment of the head portion of the toothbrush from FIG. 23A from a perspective view. FIG. 23F schematically depicts the segment of the head portion of the toothbrush from FIG. 23A from a perspective view.

FIG. 24 schematically shows an interchangeable rotational component from a side view according to one exemplary embodiment of the invention.

FIGS. 25A-D schematically depict a segment of a head portion of a toothbrush from various views according to an exemplary embodiment of the invention. FIG. 25A schematically shows the segment of the head portion of the toothbrush from a side sectional view. FIG. 25B schematically shows the segment of the head portion of the toothbrush from FIG. 25A from a bottom sectional view. FIG. 25C schematically shows the segment of the head portion of the toothbrush from FIG. 25A from a bottom sectional view. FIG. 25D schematically shows the segment of the head portion of the toothbrush from FIG. 25A from a bottom view.

FIGS. 26A-D schematically depict a segment of a head portion of a toothbrush from various views according to an exemplary embodiment of the invention. FIG. 26A schematically shows the segment of the head portion of the toothbrush from a side sectional view. FIG. 26B schematically shows the segment of the head portion of the toothbrush from FIG. 26A from a bottom view. FIG. 26C schematically shows the segment of the head portion of the toothbrush from FIG. 26A from a bottom sectional view. FIG. 26D schematically shows the segment of the head portion of the toothbrush from FIG. 26A from a bottom sectional view.

FIGS. 27A-D schematically depict a segment of a head portion of a toothbrush from various views according to an exemplary embodiment of the invention. FIG. 27A schematically shows the segment of the head portion of the toothbrush from a side sectional view. FIG. 27B schematically shows the segment of the head portion of the toothbrush from FIG. 27A from a bottom view. FIG. 27C schematically shows the segment of the head portion of the toothbrush from FIG. 27A from a bottom sectional view. FIG. 27D schematically shows the segment of the head portion of the toothbrush from FIG. 27A from a bottom sectional view.

FIGS. 28 A and B schematically depict a segment of a head portion of a toothbrush from various views according to an exemplary embodiment of the invention. FIG. 28A schematically shows the segment of the head portion of the toothbrush with a retaining mechanism in a closed position from a side sectional view. FIG. 28B schematically shows the segment of the head portion of the toothbrush from FIG. 28A with the retaining mechanism in an open position from a side sectional view.

FIG. 29 schematically shows a segment of a head portion of a toothbrush from a side sectional view according to an exemplary embodiment of the invention.

FIGS. 30A-R schematically depict a segment of a head portion of a toothbrush or portions thereof from various views according to an exemplary embodiment of the invention. FIG. 30A schematically shows a rotational component from a top view. FIG. 30B schematically shows the rotational component from FIG. 30A from a side view. FIG. 30C schematically shows an interchangeable rotational component from a bottom view. FIG. 30D schematically shows the interchangeable rotational component from FIG. 30C from a side view. FIG. 30E schematically shows an interchangeable rotational component prior to being positioned on a rotational component from a side view. FIG. 30F schematically shows the interchangeable rotational component from FIG. 30C from a top view. FIG. 30G schematically shows an interchangeable rotational component positioned on a rotational component from a side view. FIG. 30H schematically shows the interchangeable rotational component positioned on the rotational component from FIG. 30G from a side sectional view. FIG. 30I schematically shows rotational components positioned relative to one another from a top view. FIG. 30J schematically shows rotational components positioned relative to one another in a housing from a top sectional view. FIG. 30K schematically shows interchangeable rotational components prior to being positioned on rotational components from a side view. FIG. 30L schematically shows interchangeable rotational components prior to being positioned on rotational components disposed in a housing from a side sectional view. FIG. 30M schematically shows a segment of a head portion of a toothbrush from a top view. FIG. 30N schematically shows the segment of the head portion of the toothbrush from FIG. 30M with an interchangeable rotational component positioned on a rotational component from a top view. FIG. 30O schematically shows the segment of the head portion of the toothbrush from FIG. 30M with two interchangeable rotational components positioned on rotational components from a top view. FIG. 30P schematically shows the segment of the head portion of the toothbrush from FIG. 30M prior to positioning interchangeable rotational components on rotational components from a side view. FIG. 30Q schematically shows the segment of the head portion of the toothbrush from FIG. 30M with an interchangeable rotational component positioned on a rotational component from a side view. FIG. 30R schematically shows the segment of the head portion of the toothbrush from FIG. 30M with two interchangeable rotational components positioned on rotational components from a top view.

FIGS. 31 A and B schematically show an interchangeable rotational component and a rotational component from various views according to an exemplary embodiment of the invention. FIG. 31A schematically shows an interchangeable rotational component prior to being positioned relative to a rotational component from a partially sectional side view. FIG. 31B schematically shows the interchangeable rotational component positioned relative to the rotational component from FIG. 31A from a partially sectional side view.

FIGS. 32A-E schematically show an interchangeable rotational component and a rotational component from various views according to an exemplary embodiment of the invention. FIG. 32A schematically shows an interchangeable rotational component prior to being positioned relative to a rotational component from a partially sectional side view. FIG. 32B schematically shows the interchangeable rotational component being positioned relative to the rotational component from FIG. 32A from a partially sectional side view. FIG. 32C schematically shows the interchangeable rotational component positioned relative to the rotational component from FIG. 32A from a partially sectional side view. FIG. 32D schematically shows the interchangeable rotational component being removed from the rotational component from FIG. 32A from a partially sectional side view. FIG. 32E schematically shows the interchangeable rotational component removed from the rotational component from FIG. 32A from a partially sectional side view.

### DETAILED DESCRIPTION

Before describing the invention in detail, it is to be understood that this invention is not limited to particular methods, rotational components, rotary units, rotary mechanisms, or devices, which can vary. As used in this specification and the appended claims, the singular forms “a,” “an,” and “the” also include plural referents unless the context clearly provides otherwise. It is also to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which this invention pertains. In describing and claiming the invention, the following terminology, and grammatical variants thereof, will be used in accordance with the definitions set forth below.

The term “counter-rotate” or “contra-rotate” refers to objects that rotate in opposite directions relative to one another. In some embodiments, for example, rotary mechanisms include rotational components that are configured to rotate in opposite directions.

The term “communicate” refers to the direct or indirect transfer or transmission, and/or capability of directly or indirectly transferring or transmitting, something at least from one thing to another thing. In some embodiments, for example, devices include housings having openings through which at least portions of rotational components can be transferred to positions those portions within housing receiving areas or cavities.

The invention relates to devices that are configured to include rotational components that are readily interchangeable with one another and related methods that are suitable for use in numerous applications. In some embodiments, for example, devices include multiple rotary units are assembled in rotary mechanisms such that neighboring pairs of rotational components counter-rotate or contra-rotate relative to one another during operation of the rotary mechanisms. Rotational components generally include one or more implements that are structured to perform or effect one or more types of work as the rotational components rotate relative to one another in a given rotary mechanism. In certain embodiments, for example, implements are configured for use in various dental applications. The representative embodiments described herein are intended to illustrate, but not to limit, the invention. Essentially any combination of components or portions thereof described herein are optionally utilized or adapted for use together in certain embodiments.

In some embodiments, a given rotary mechanism and device includes only one rotational component. In certain other embodiments, the invention provides rotary or rotational mechanisms that include more than one rotational component or rotary unit (e.g., 2, 3, 4, 5, 6, 7, 8, 9, 10, 11, 12, 13, 14, 15, or more rotational components or rotary units). Rotary mechanisms also typically include at least one counter-rotational mechanism operably coupled to one or more of the rotational components. The counter-rotational mechanism is generally configured to effect substantially simultaneous counter-rotation of the rotational components relative to one another when movement of at least a portion of the counter-rotational mechanism is effected. Rotary mechanisms also typically include drive mechanisms operably coupled to the counter-rotational mechanism and/or rotational components. Drive mechanisms are typically configured to effect movement of at least the portion of the counter-rotational mechanisms such that the rotational components substantially simultaneously counter-rotate relative to one another. In some embodiments, for example, multiple rotary units are included as components (e.g., rotational components and counter-rotational mechanisms, etc.) of rotary mechanisms.

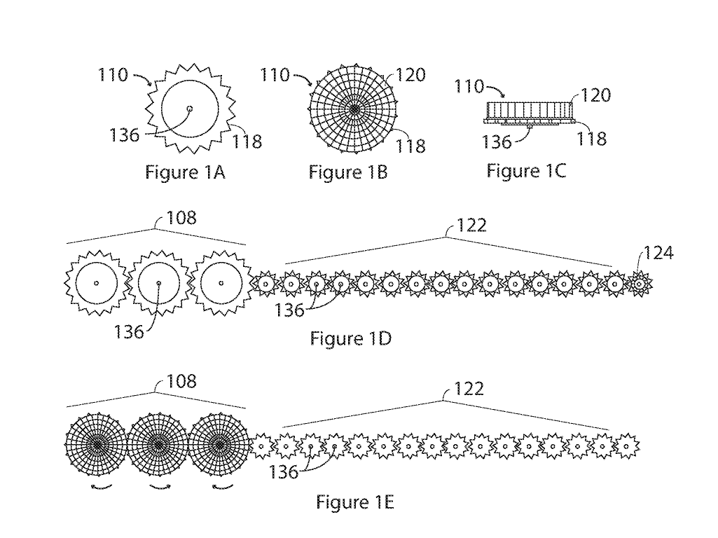

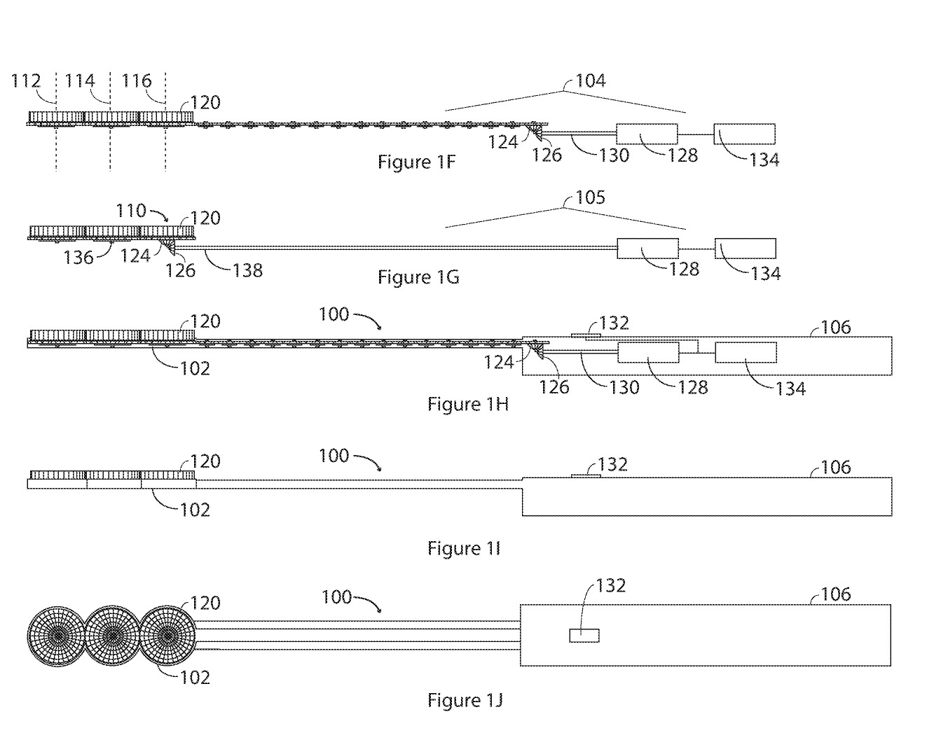

FIGS. 1A-J schematically illustrate handheld devices (e.g., tooth brushing devices) or components thereof from various views according to certain embodiments of the invention. As shown, handheld device 100 includes head portion 102, drive mechanism component 104, and handle portion 106. In the embodiment shown, head portion 102 and handle portion 106 are fabricated integral with one another (i.e., non-detachable from one another). In other embodiments, head and handle portions (and drive mechanism components or portions thereof) are detachable from one another. Head portion 102 includes rotary mechanism 108, which includes three rotational components 110 in this exemplary embodiment. Rotational components 110 are configured to rotate at least partially around rotational axis 112, 114, or 116. Rotational components 110 include gear components 118 that are configured to mesh with one or more gear components of neighboring rotational components and/or drive mechanism components. In the embodiment shown, each rotational component 110 includes implements 120 disposed on a surface that is configured to rotate substantially perpendicular to a rotational axis (e.g., rotational axis 112, 114, or 116) of the rotational component 110. Other exemplary rotational components are described further herein. In some embodiments, rotational components 110 are selectively interchangeable with other rotational components (e.g., having the same or different implement configurations).

Drive mechanism component 104 includes a chain of meshed gear components 122 that mesh with gear component 118 of one rotational component 110 and extend from head portion 102 to handle portion 106. As shown, one gear component 122 includes gear 124 that meshes with gear 126. Gear 126 is operably connected to motor component 128 via shaft component 130. Motor component 128 is also operably connected to switch component 132 (e.g., an on/off switch, etc.) and power source component 134 (e.g., a rechargeable battery, etc.). During operation, motor component 128 effects rotation of shaft component 130, gears 124 and 126, and gear components 122 such that neighboring pairs of rotational components 110 rotate at least partially around rotational axis 112, 114, or 116 in directions (see, directional arrows shown, for example, in FIG. 1E) that are substantially opposite one another. Rotary mechanism 108 and drive mechanism component 104 are at least partially disposed within a housing. Rotational components 110 and gear components 122 include alignment components 136 (shown as pegs in this embodiment) that align rotational components 110 and gear components 122 relative to the housing (e.g., via corresponding seatings (not within view)).

Other drive mechanism components are also optionally used with rotational components 110. As shown in FIG. 1G, for example, drive mechanism component 105 includes shaft component 138 instead of chain of meshed gear components 122. As shown, one rotational component 110 includes gear 124 that meshes with gear 126. Gear 126 is operably connected to motor component 128 via shaft component 138. Motor component 128 is also operably connected to power source component 134 (e.g., a rechargeable battery, etc.). During operation, motor component 128 effects rotation of shaft component 138, gears 124 and 126, and gear components 118 such that neighboring pairs of rotational components 110 rotate at least partially around rotational axis 112, 114, or 116 in directions that are substantially opposite one another.

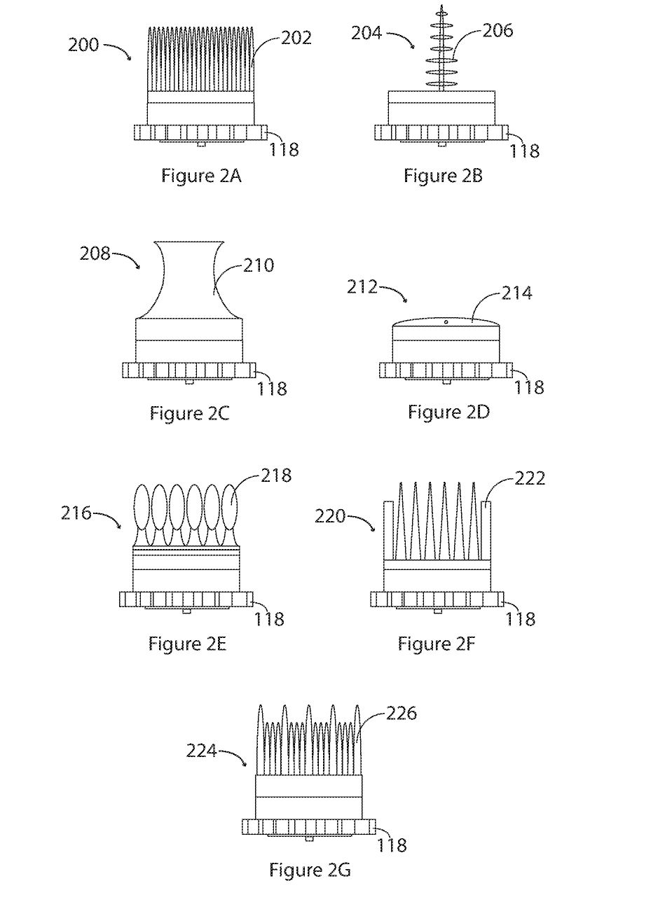

To further illustrate, FIG. 2A-G schematically illustrate side views of various rotational components that are optionally used in handheld device 100 (e.g., interchanged in essentially any combination for one or more of rotational components 110) or in other embodiments. As shown, FIG. 2A schematically depicts rotational component 200, which includes bristle components 202 (e.g., nylon bristles, silicone bristles, etc.). FIG. 2B schematically depicts rotational component 204, which includes flossing component 206. FIG. 2C schematically depicts rotational component 208, which includes polishing component 210 (e.g., a prophy cup, etc.). FIG. 2D schematically depicts rotational component 212, which includes cap component 214 (e.g., a blank cap or the like). Cap component 214 lacks cleaning features, such as bristles or the like in this exemplary embodiment. In certain embodiments, cap components, such as cap component 214 are used in a given device (e.g., handheld device 100 or the like) when a user selects not to use every available rotational component position for a given application. For example, a user may interchange the three rotational components 110 of handheld device 100 with one flossing component 206 or one polishing component 210 and two cap components 214 as desired. FIG. 2E schematically depicts rotational component 216, which includes bristle components 218. FIG. 2F schematically depicts rotational component 220, which includes bristle components 222. FIG. 2G schematically depicts rotational component 224, which includes bristle components 226.

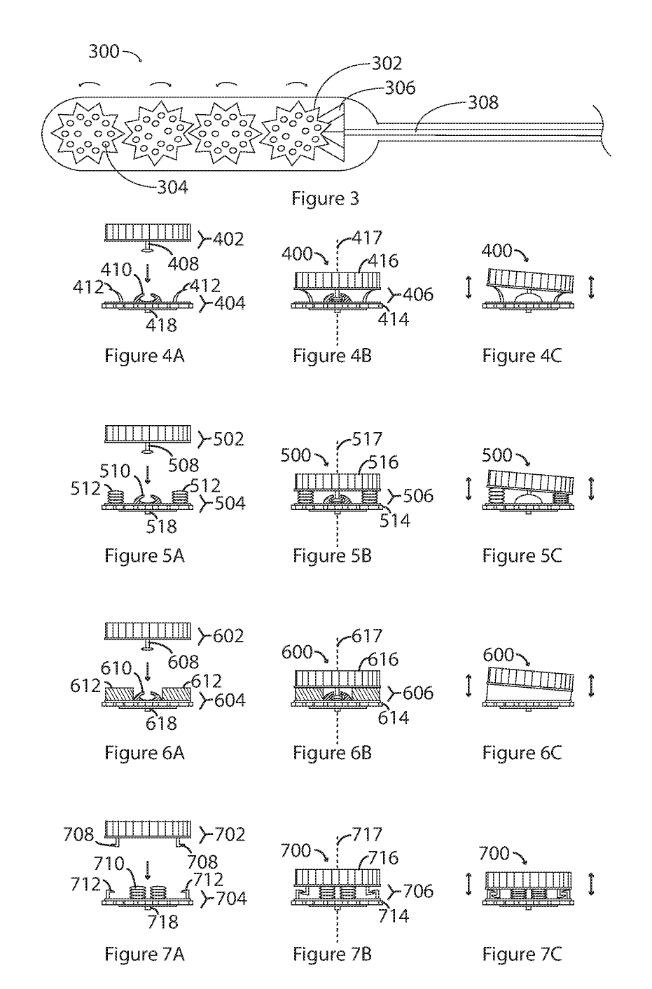

FIG. 3 schematically shows a head portion of a tooth brushing device from partially transparent top view according to one embodiment of the invention. As shown, head portion 300 includes rotational components 302 that include gear components that mesh with one another. Rotational components 302 also have surfaces that are configured to rotate substantially perpendicular to rotational axes of rotational components 302. These surfaces include implements 304. One rotational component 302 also meshes with gear component 306. Gear component 306 is operably connected to shaft component 308, which is typically operably connected to a motor or the like (e.g., disposed in a handle portion of the tooth brushing device (not within view)) that is configured to effect rotation of shaft component 308 and gear component 306 (e.g., in one or both directions, in an oscillating mode, etc.). As gear component 306 rotates, it effects the counter-rotation of rotational components 302.

In some exemplary embodiments, rotational components or portions thereof include resilient couplings, which generate resiliency in those rotational components or portions thereof (e.g., independent rotational component resiliency in applications that use multiple rotational components that include resilient couplings) in a given device. For example, FIGS. 4A-C schematically illustrate a rotational component, or portions thereof, that include at least one resilient coupling from side views according to one exemplary embodiment of the invention. FIGS. 4 A and B are shown from partial sectional side views. As shown, rotational component 400 includes first portion 402 and second portion 404. Rotational component 400 also includes resilient coupling 406, which resiliently couples first portion 402 and second portion 404 to one another. Resilient coupling 406 includes a positioning mechanism (post 408 and post retainer 410) that positions the first and second portions relative to one another within a range of motion (see, e.g., directional arrows in FIG. 4C). Resilient coupling 406 also includes flexible prongs 412, which resiliently position first portion 402 relative to second portion 404. Rotational component 400 also includes gear component 414 that is configured to mesh with one or more gear components of neighboring rotational components and/or drive mechanism components. In the embodiment shown, rotational component 400 includes implements 416 (shown as bristles) disposed on a surface that is configured to rotate substantially perpendicular to rotational axis 417 of rotational component 400. Exemplary implements and rotary mechanisms that are optionally adapted for use with rotational components are described herein. Rotational component 400 also includes alignment component 418 (shown as a peg in this embodiment) that align rotational component 400 relative, e.g., to a housing or other component.

FIGS. 5A-C schematically illustrate a rotational component, or portions thereof, that include at least one resilient coupling from side views according to one exemplary embodiment of the invention. FIGS. 5 A and B are shown from partial sectional side views. As shown, rotational component 500 includes first portion 502 and second portion 504. Rotational component 500 also includes resilient coupling 506, which resiliently couples first portion 502 and second portion 504 to one another. Resilient coupling 506 includes a positioning mechanism (post 508 and post retainer 510) that positions the first and second portions relative to one another within a range of motion (see, e.g., directional arrows in FIG. 5C). Resilient coupling 506 also includes spring mechanisms 512, which resiliently position first portion 502 relative to second portion 504. Rotational component 500 also includes gear component 514 that is configured to mesh with one or more gear components of neighboring rotational components and/or drive mechanism components. In the embodiment shown, rotational component 500 includes implements 516 (shown as bristles) disposed on a surface that is configured to rotate substantially perpendicular to rotational axis 517 of rotational component 500. Exemplary implements and rotary mechanisms that are optionally adapted for use with rotational components are described herein. Rotational component 500 also includes alignment component 518 (shown as a peg in this embodiment) that align rotational component 500 relative, e.g., to a housing or other component.

FIGS. 6A-C schematically illustrate a rotational component, or portions thereof, that include at least one resilient coupling from side views according to one exemplary embodiment of the invention. FIGS. 6 A and B are shown from partial sectional side views. As shown, rotational component 600 includes first portion 602 and second portion 604. Rotational component 600 also includes resilient coupling 606, which resiliently couples first portion 602 and second portion 604 to one another. Resilient coupling 606 includes a positioning mechanism (post 608 and post retainer 610) that positions the first and second portions relative to one another within a range of motion (see, e.g., directional arrows in FIG. 6C). Resilient coupling 606 also includes flexible or elastomeric material 612, which resiliently positions first portion 602 relative to second portion 604. Rotational component 600 also includes gear component 614 that is configured to mesh with one or more gear components of neighboring rotational components and/or drive mechanism components. In the embodiment shown, rotational component 600 includes implements 616 (shown as bristles) disposed on a surface that is configured to rotate substantially perpendicular to rotational axis 617 of rotational component 600. Exemplary implements and rotary mechanisms that are optionally adapted for use with rotational components are described herein. Rotational component 600 also includes alignment component 618 (shown as a peg in this embodiment) that align rotational component 600 relative, e.g., to a housing or other component.

FIGS. 7A-C schematically illustrate a rotational component, or portions thereof, that include at least one resilient coupling from side views according to one exemplary embodiment of the invention. As shown, rotational component 700 includes first portion 702 and second portion 704. Rotational component 700 also includes resilient coupling 706, which resiliently couples first portion 702 and second portion 704 to one another. Resilient coupling 706 includes a positioning mechanism (shown as interlocking retainer components 708 and 712) that positions the first and second portions relative to one another within a range of motion (see, e.g., directional arrows in FIG. 7C). Resilient coupling 706 also includes spring mechanisms 710, which resiliently position first portion 702 relative to second portion 704. Rotational component 700 also includes gear component 714 that is configured to mesh with one or more gear components of neighboring rotational components and/or drive mechanism components. In the embodiment shown, rotational component 700 includes implements 716 (shown as bristles) disposed on a surface that is configured to rotate substantially perpendicular to rotational axis 717 of rotational component 700. Exemplary implements and rotary mechanisms that are optionally adapted for use with rotational components are described herein. Rotational component 700 also includes alignment component 718 (shown as a peg in this embodiment) that align rotational component 700 relative, e.g., to a housing or other component.

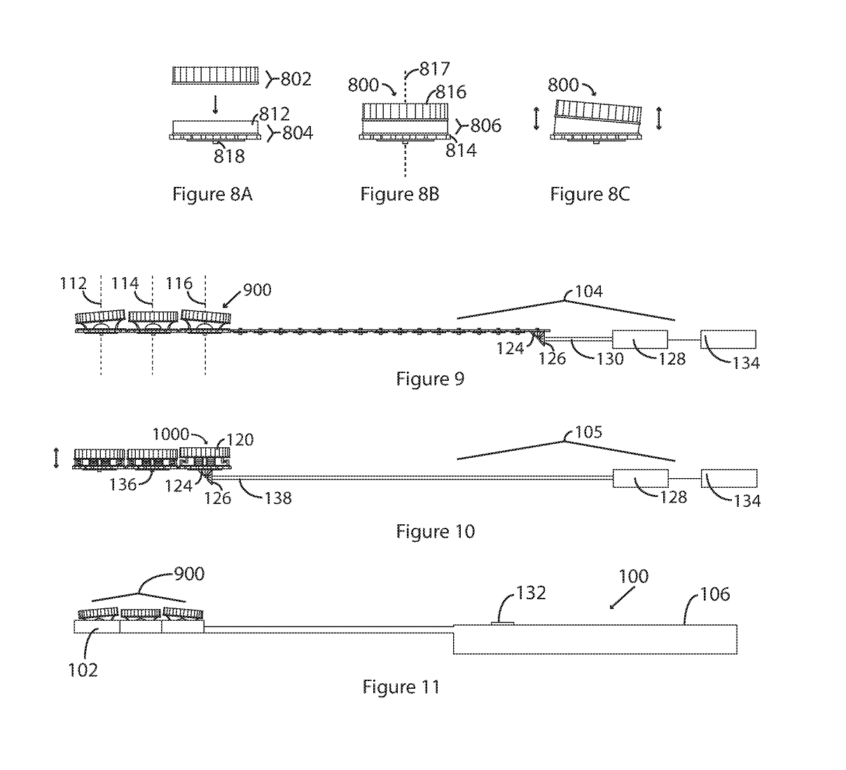

FIGS. 8A-C schematically illustrate a rotational component, or portions thereof, that include at least one resilient coupling from side views according to one exemplary embodiment of the invention. As shown, rotational component 800 includes first portion 802 and second portion 804. Rotational component 800 also includes resilient coupling 806, which resiliently couples first portion 802 and second portion 804 to one another. Resilient coupling 806 includes material container component 812 (e.g., a flexible bladder or the like that is at least partially filled with a fluidic (e.g., a gas, a liquid, etc.) and/or semi-fluidic (e.g., a gel, etc.) material) that resiliently positions the first and second portions relative to one another (see, e.g., directional arrows in FIG. 8C). Rotational component 800 also includes gear component 814 that is configured to mesh with one or more gear components of neighboring rotational components and/or drive mechanism components. In the embodiment shown, rotational component 800 includes implements 816 (shown as bristles) disposed on a surface that is configured to rotate substantially perpendicular to rotational axis 817 of rotational component 800. Exemplary implements and rotary mechanisms that are optionally adapted for use with rotational components are described herein. Rotational component 800 also includes alignment component 818 (shown as a peg in this embodiment) that align rotational component 800 relative, e.g., to a housing or other component.

FIG. 9 schematically illustrates rotational components 900 having resilient couplings and drive mechanism components or portions thereof operably connected to motor and power source components from a side view according to one embodiment of the invention. FIG. 10 schematically illustrates rotational components 1000 having resilient couplings and drive mechanism components or portions thereof operably connected to motor and power source components from a side view according to one embodiment of the invention. FIG. 11 schematically shows a handheld device that includes rotational components 900 having resilient couplings from a side view according to one embodiment of the invention.

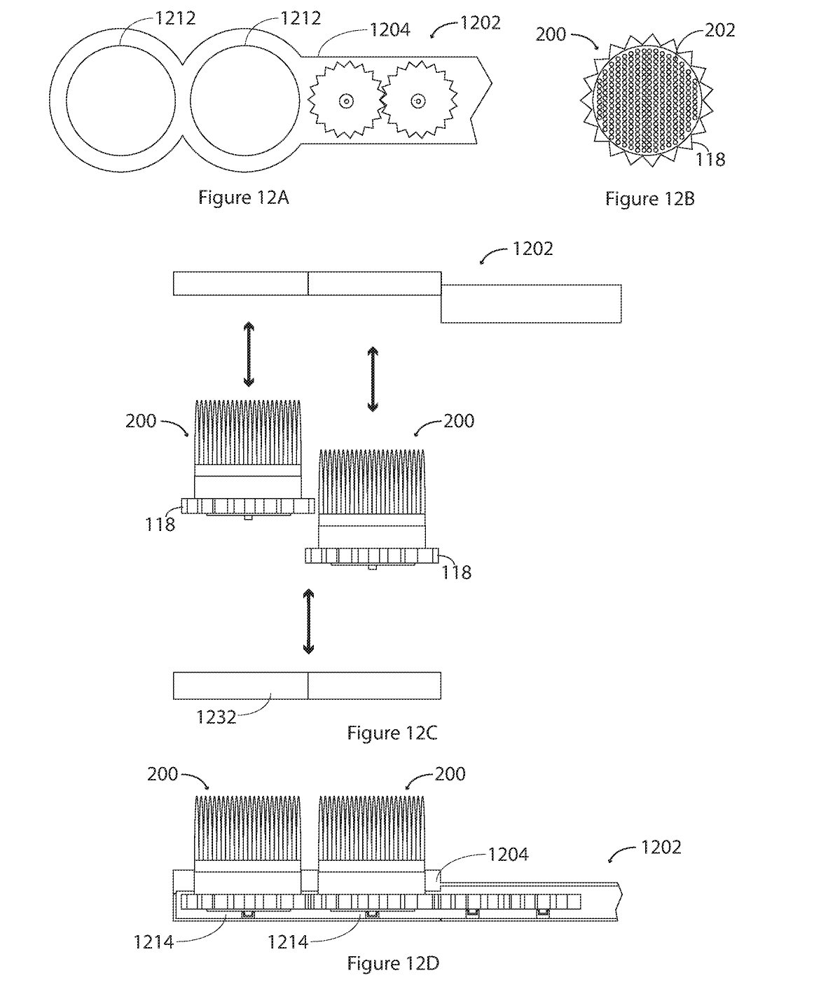

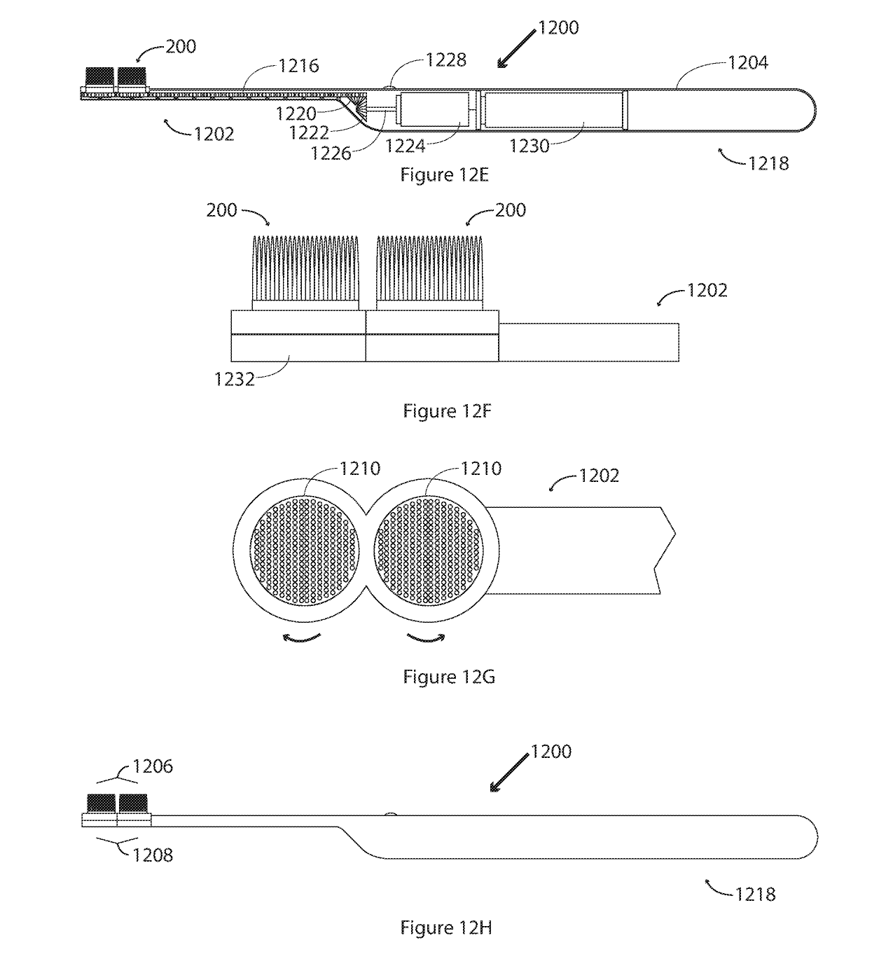

FIG. 12A-H schematically illustrate a handheld device from various views according to one embodiment of the invention. As shown, handheld device 1200 includes head portion 1202 that includes housing 1204, which includes top area 1206 and bottom area 1208. Top area 1206 includes top openings 1210 and bottom area includes bottom openings 1212. Handheld device 1200 also includes rotational component receiving areas 1214 that communicates with top openings 1210 and bottom openings 1212. Rotational component receiving areas 1214 are each configured to reversibly receive a portion of interchangeable rotational components 200 through bottom openings 1212 such that a segment of interchangeable rotational components 200 that comprises implements 202 is reversibly received in and/or through top openings 1210. Other examples of interchangeable rotational components that are optionally used with handheld device 1200 are described herein, such as in FIGS. 2B-2F, 4A-C, 5A-C, 6A-C, and 7A-C. As also shown, interchangeable rotational components 200 include gear components 118, which operably engage (e.g., mesh) one another such that the neighboring pair of interchangeable rotational components depicted counter-rotate (see, e.g., the directional arrow shown in FIG. 12G) relative to one another during operation of handheld device 1200. In this exemplary embodiment, handheld device 1200 is configured to house two interchangeable rotational components at a given time. The handheld devices of the invention are optionally configured to include only one interchangeable rotational component at a given time or more than two interchangeable rotational components at a given time (e.g., 3, 4, 5, 6, 7, 8, 9, 10, or more interchangeable rotational components).

Handheld device 1200 also includes a drive mechanism component that directly operably engages a gear component 118 of one interchangeable rotational component 200 in this exemplary embodiment. The drive mechanism component of handheld device 1200 is configured similar to drive mechanism component 104 described herein. Other drive mechanism component configurations are optionally used. For example, drive mechanism component 105 described herein is optionally adapted for use with handheld device 1200. As shown, the drive mechanism component of handheld device 1200 includes a chain of meshed gear components 1216 that mesh with gear component 118 of one interchangeable rotational component 200 and extend from head portion 1202 to handle portion 1218. As shown, one gear component of chain of meshed gear components 1216 includes gear 1220 that meshes with gear 1222. Gear 1222 is operably connected to motor component 1224 via shaft component 1226. Motor component 1224 is also operably connected to switch component 1228 (e.g., an on/off switch, etc.) and power source component 1230 (e.g., a rechargeable battery, etc.). During operation, motor component 1224 effects rotation of shaft component 1226, gears 1222 and 1220, chain of meshed gear components 1216, and gear components 118 such that the depicted neighboring pair of interchangeable rotational components 200 rotate in directions (see, directional arrows shown, for example, in FIG. 12G) that are substantially opposite one another. In the exemplary embodiment shown, head portion 1202 (other than interchangeable rotational components 200 and retaining mechanism 1232) is fabricated integral with handle portion 1218. In other embodiments, head portions and handle portions are detachable from or reversibly connectable to one another.

As shown, handheld device 1200 also includes retaining mechanism 1232 (e.g., a cover component) that is configured to reversibly retain interchangeable rotational components 200 disposed in rotational component receiving areas 1214. Although not within view, retaining mechanism 1232 includes attachment components (e.g., molded projections and corresponding receiving areas and a latch mechanism) that are configured to reversibly attach retaining mechanism 1232 to head portion 1202. Essentially any attachment component is adapted for use in attaching retaining mechanisms and head and/or handle portions to one another, such as hinges and latch components, tongue and groove-type sliding mechanisms, clamping mechanisms, and clipping mechanism, among many others.

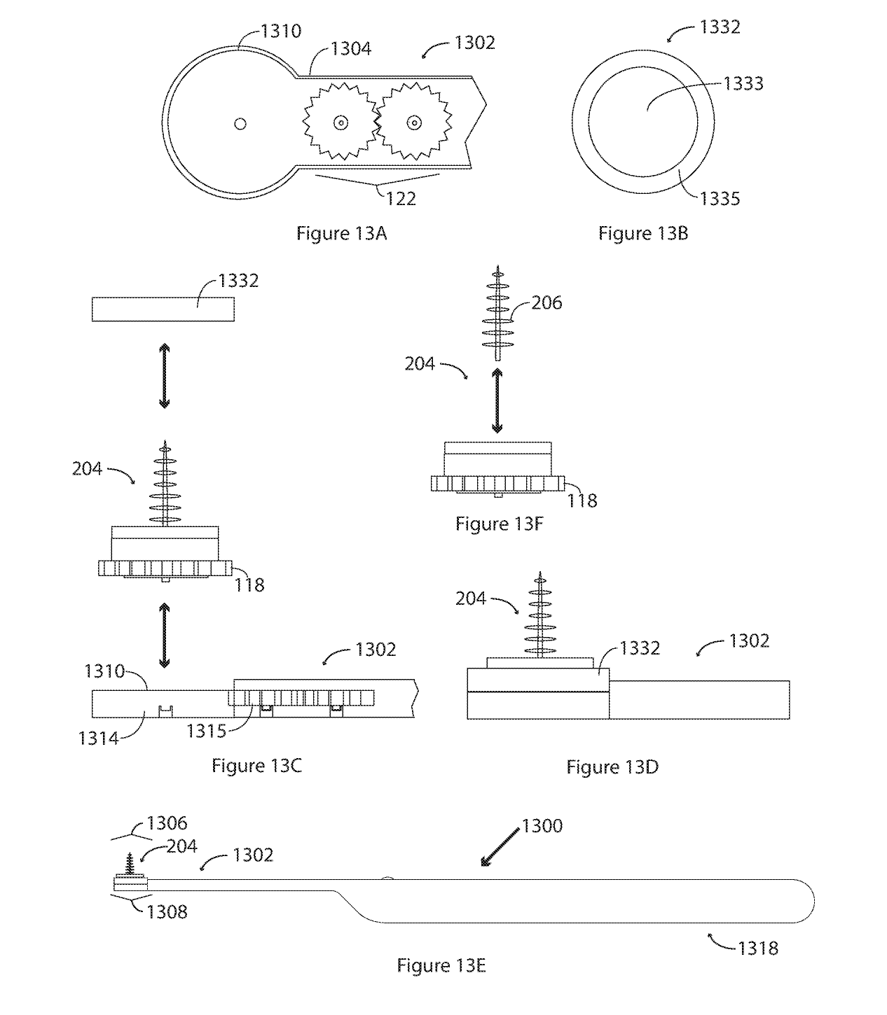

FIG. 13A-F schematically illustrate a handheld device from various views according to one embodiment of the invention. As shown, handheld device 1300 includes head portion 1302 that includes housing 1304, which includes top area 1306 and bottom area 1308. Top area 1306 includes top opening 1310. Handheld device 1300 also includes rotational component receiving area 1314 that communicates with top opening 1310. Rotational component receiving area 1314 is configured to reversibly receive a portion of interchangeable rotational component 204 through top opening 1310. Other examples of interchangeable rotational components that are optionally used with handheld device 1300 are described herein, such as in FIGS. 2B-2F, 4A-C, 5A-C, 6A-C, and 7A-C. In some embodiments, implements of rotational components are interchangeable. As shown in FIG. 13E, for example, implement 206 is optionally interchangeable (e.g., capable of being removed or detached from and/or replaced with the same or another type of implement) with the remaining portion of interchangeable rotational component 204 in this exemplary embodiment. In other exemplary embodiments, the implements of interchangeable rotational components are fabricated integral (e.g., not removable from) with other portions of the interchangeable rotational components. As also shown, interchangeable rotational component 204 includes gear component 118, which operably engages (e.g., meshes with) gear components 1315 of a drive mechanism component of handheld device 1300. In this exemplary embodiment, handheld device 1300 is configured to house one interchangeable rotational components at a given time. The handheld devices of the invention are optionally configured to include more than one interchangeable rotational component at a given time (e.g., 2, 3, 4, 5, 6, 7, 8, 9, 10, or more interchangeable rotational components).

Handheld device 1300 also includes a drive mechanism component that effects the rotation of interchangeable rotational component 204. Although not completely within view (e.g., portion of chain of meshed gear components 122 within view), the drive mechanism component of handheld device 1300 is configured similar to drive mechanism component 104 described herein. Other drive mechanism component configurations are optionally used. For example, drive mechanism component 105 described herein is optionally adapted for use with handheld device 1300.

In the exemplary embodiment shown, head portion 1302 (other than interchangeable rotational component 206 and retaining mechanism 1332) is fabricated integral with handle portion 1318. In other embodiments, head portions and handle portions are detachable from or reversibly connectable to one another.

As shown, handheld device 1300 also includes retaining mechanism 1332 (e.g., a cover component) that is configured to reversibly retain interchangeable rotational component 204 disposed in rotational component receiving areas 1314. Although not within view, retaining mechanism 1332 includes attachment components (e.g., molded projections and corresponding receiving areas and a latch mechanism) that are configured to reversibly attach retaining mechanism 1332 to head portion 1302 such a portion of interchangeable rotational component 204 that includes implement 206 is disposed through, and able to rotate within, orifice 1333 of retaining mechanism 1332. Ring component 1335 of retaining mechanism 1332 is an exemplary alignment component that is configured to reversibly align interchangeable rotational component 204 and housing 1304 relative to one another. Essentially any attachment component is adapted for use in attaching retaining mechanisms and head and/or handle portions to one another, such as hinges and latch components, corresponding threaded regions, tongue and groove-type sliding mechanisms, clamping mechanisms, and clipping mechanism, among many others.

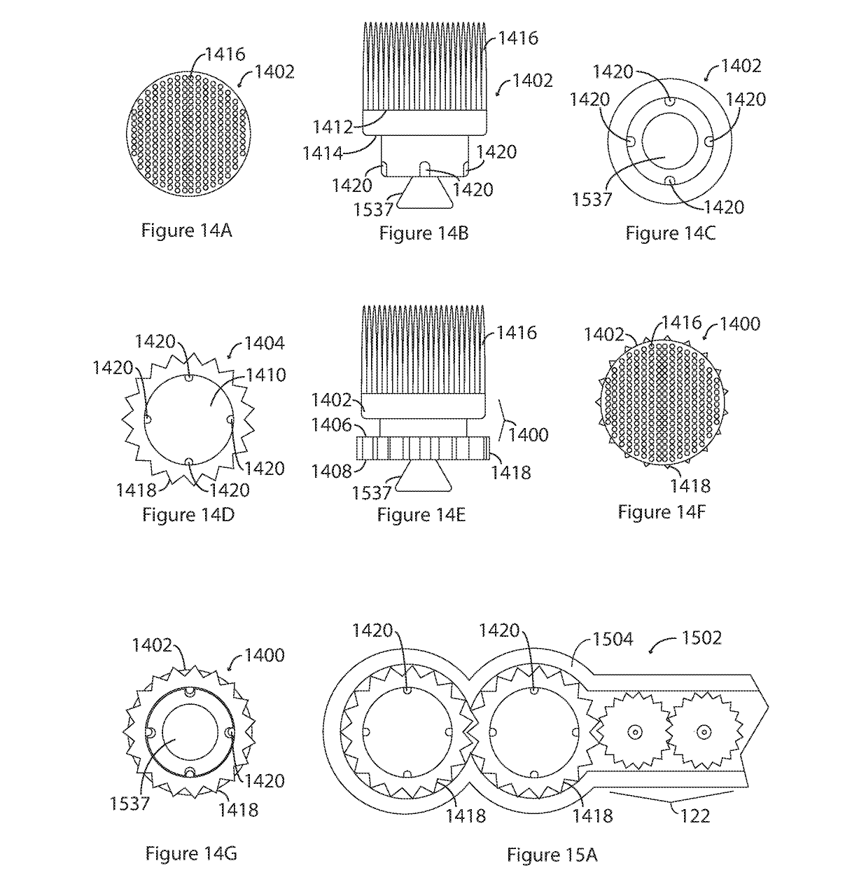

FIGS. 14A-G and 15A-U schematically illustrate interchangeable rotational components, handheld devices, or portions thereof from various views according to exemplary embodiments of the invention. As shown, handheld device 1500 includes head portion 1502 that includes housing 1504, which includes top area 1506 and bottom area 1508. Top area 1506 includes top openings 1510 and bottom area includes bottom openings 1512. Handheld device 1500 also includes rotational component receiving areas 1514 that communicates with top openings 1510 and bottom openings 1512. Rotational component receiving areas 1514 include first rotational component body structure portions 1404 of interchangeable rotational components 1400 disposed at least partially within the rotational component receiving areas 1514. First rotational component body structure portions 1404 include top surface 1406, bottom surface 1408, and orifice 1410 disposed at least partially through the first rotational component body structure portion 1404. Orifice 1410 is configured to reversibly receive at least one section or segment of second rotational component body structure portions 1402 through top openings 1510 such that segments of second rotational component body structure portions 1402 are reversibly received in and/or through top openings 1510. Second rotational component body structure portions 1402 include alignment component portions 1511 that reversibly align second rotational component body structure portions 1402 and first rotational component body structure portions 1404 relative to one another when orifice 1410 reversibly receives at least one section or segment of second rotational component body structure portions 1402. Second rotational component body structure portions 1402 also include top surface 1412 and bottom surface 1414. As shown, top surface 1412 includes implements 1416 (shown as bristle components). In certain embodiments, implements are fabricated integral with second rotational component body structure portions. In other exemplary embodiments, implements are selectively attachable to and/or detachable from second rotational component body structure portions.

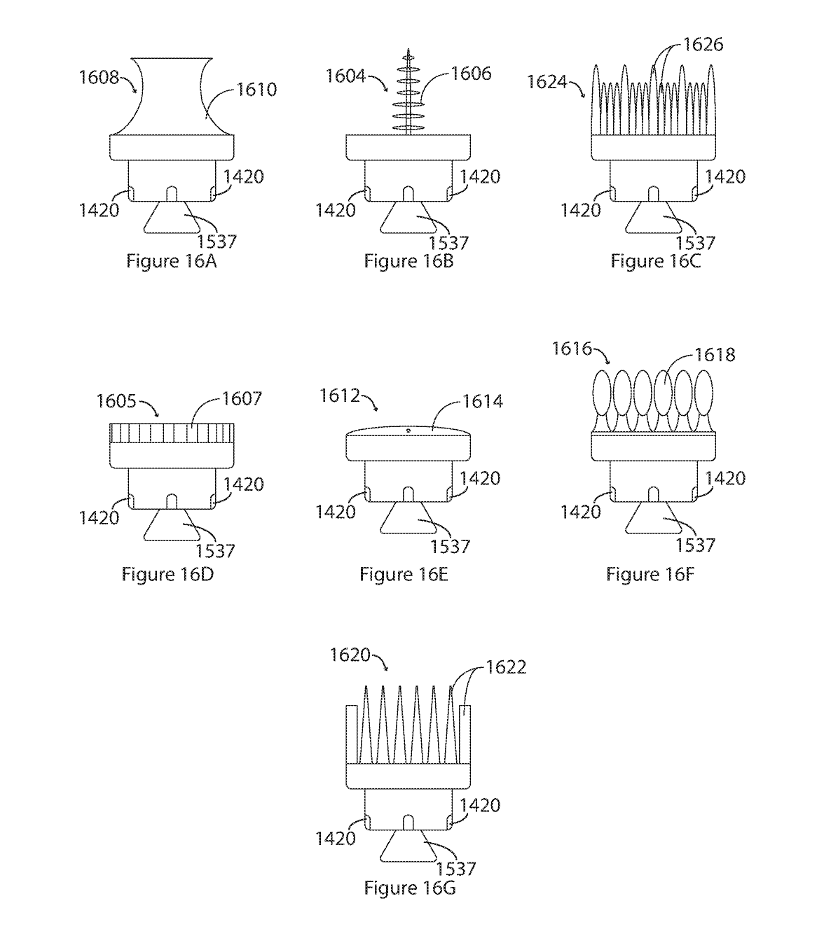

To further illustrate, FIG. 16A-G schematically illustrate side views of various second rotational component body structure portions that are optionally used in handheld device 1500 (e.g., interchanged in essentially any combination for one or more of second rotational component body structure portion 1402) or in other embodiments. As shown, FIG. 16A schematically depicts second rotational component body structure portion 1608, which includes polishing component 1610 (e.g., a prophy cup, etc.). FIG. 16B schematically depicts second rotational component body structure portion 1604, which includes flossing component 1606. FIG. 16C schematically depicts second rotational component body structure portion 1624, which includes bristle components 1626 (e.g., nylon bristles, silicone bristles, etc.). FIG. 16D schematically depicts second rotational component body structure portion 1605, which includes bristle components 1607. FIG. 16E schematically depicts second rotational component body structure portion 1612, which includes cap component 1614 (e.g., a blank cap or the like). Cap component 1614 lacks cleaning features, such as bristles or the like in this exemplary embodiment. In certain embodiments, cap components, such as cap component 1614 are used in a given device (e.g., handheld device 1500 or the like) when a user selects not to use every available rotational component position for a given application. For example, a user may interchange the two second rotational component body structure portions 1402 of handheld device 1500 with one second rotational component body structure portion 1604 comprising flossing component 1606 or one second rotational component body structure portion 1608 comprising polishing component 1610 and one second rotational component body structure portion 1612 comprising cap component 1614 as desired. FIG. 16F schematically depicts second rotational component body structure portion 1616, which includes bristle components 1618. FIG. 16G schematically depicts second rotational component body structure portion 1620, which includes bristle components 1622.

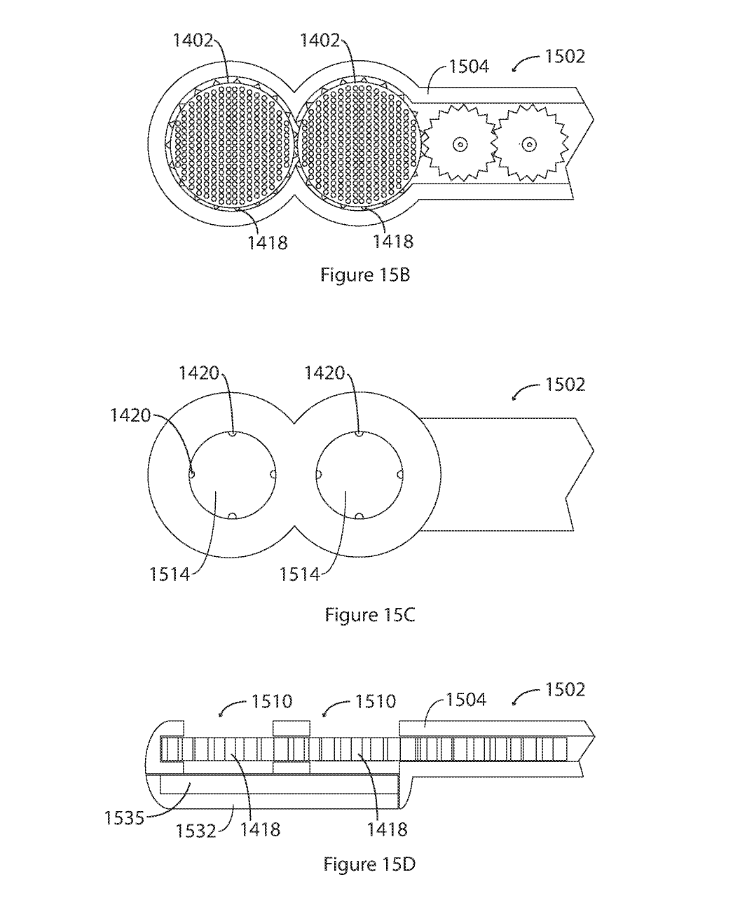

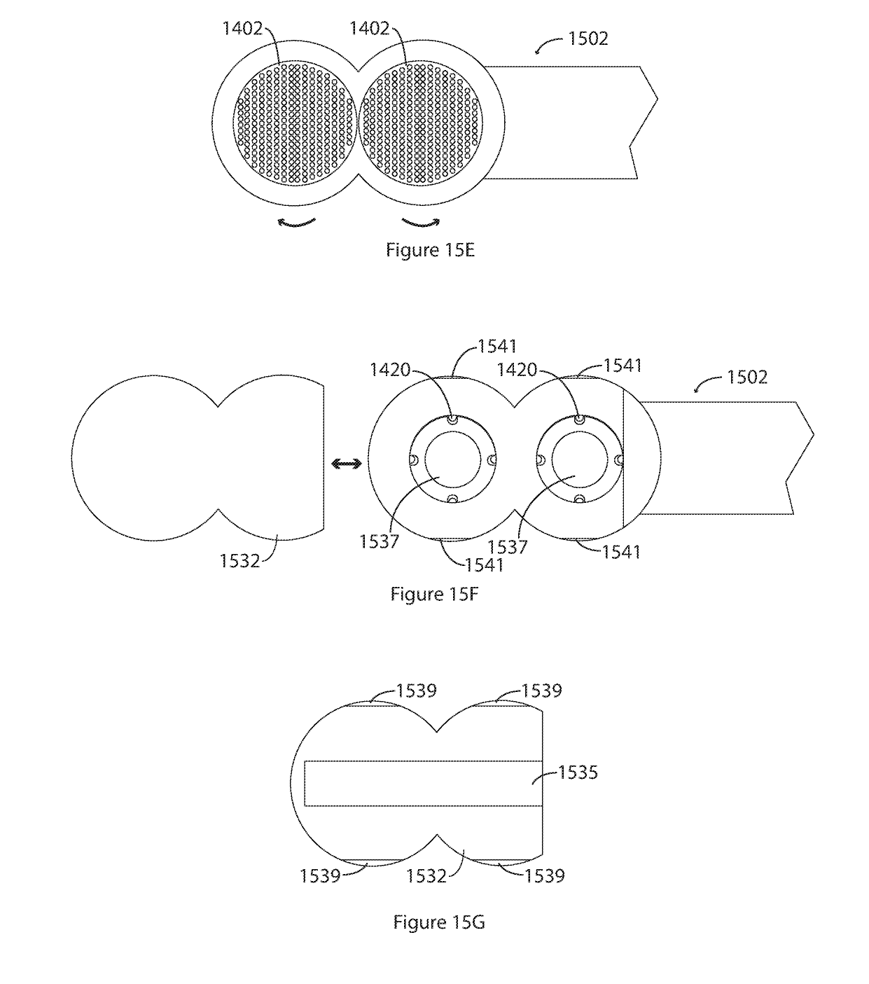

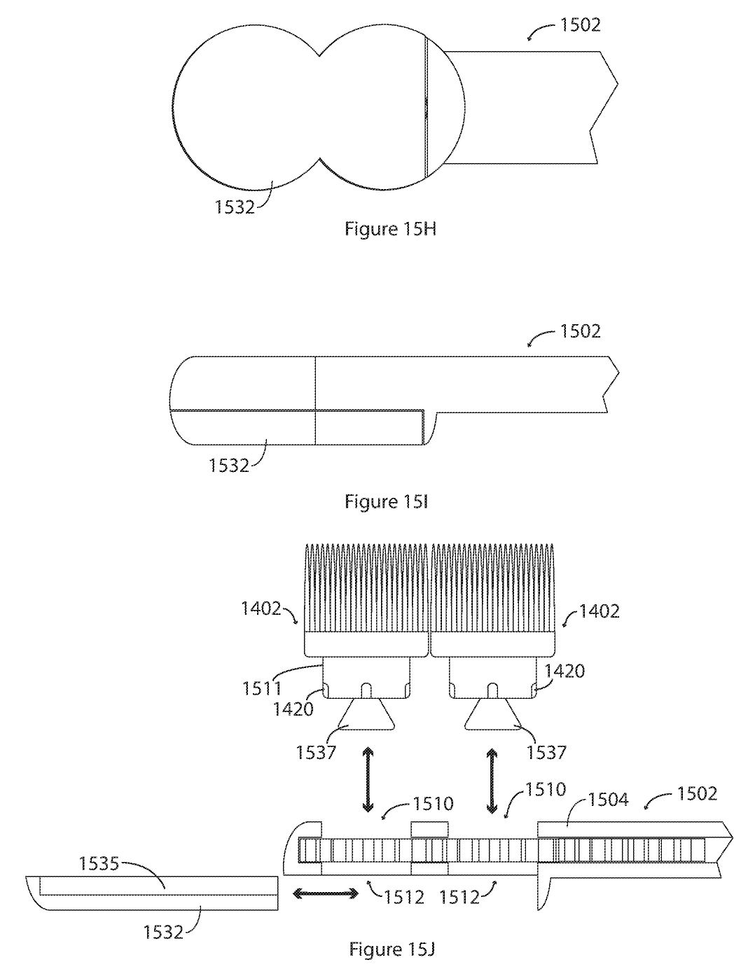

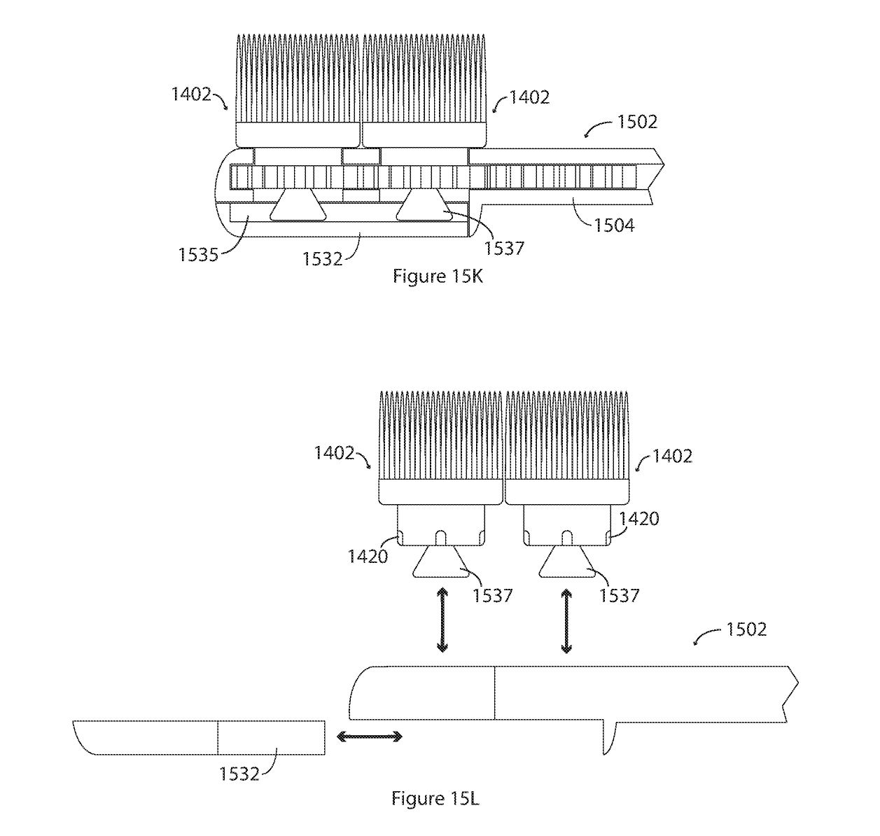

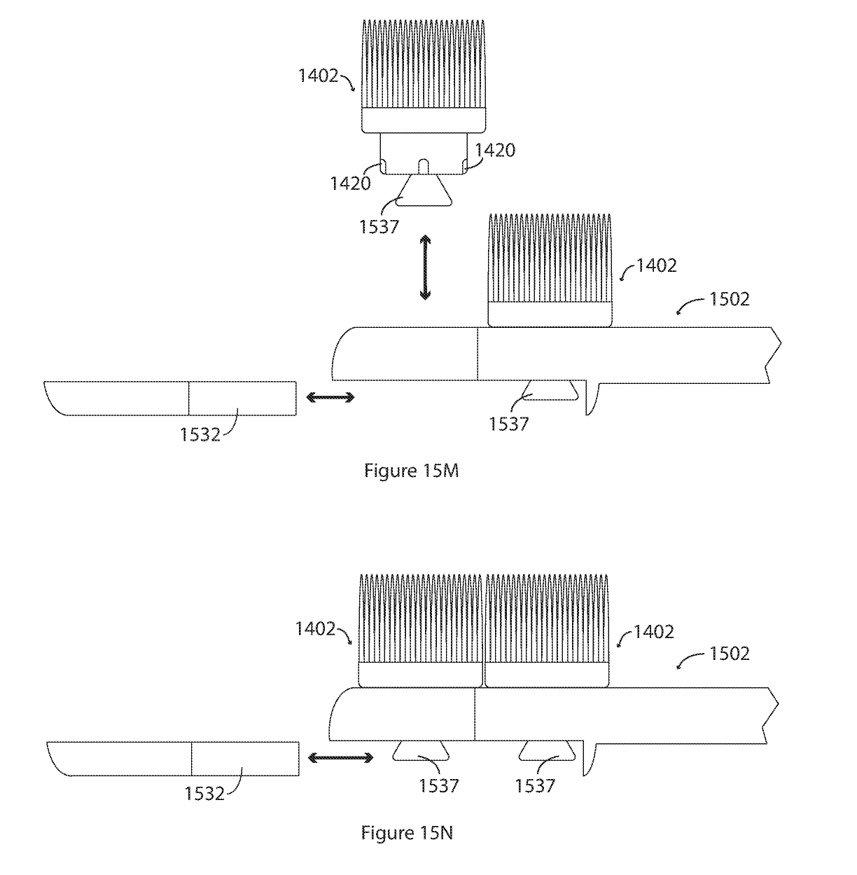

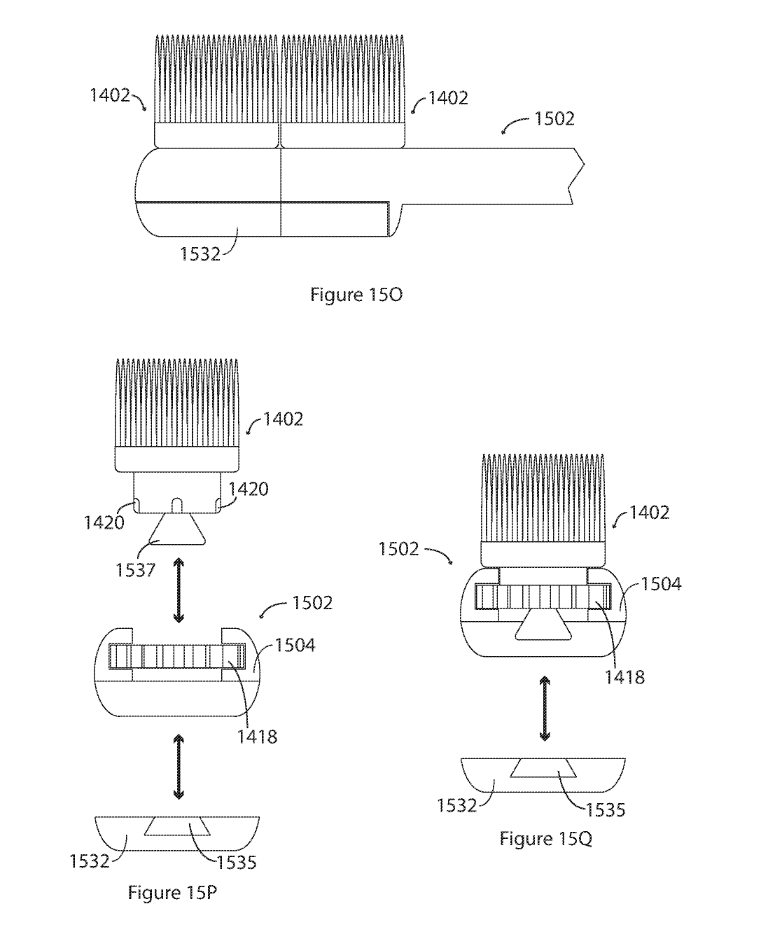

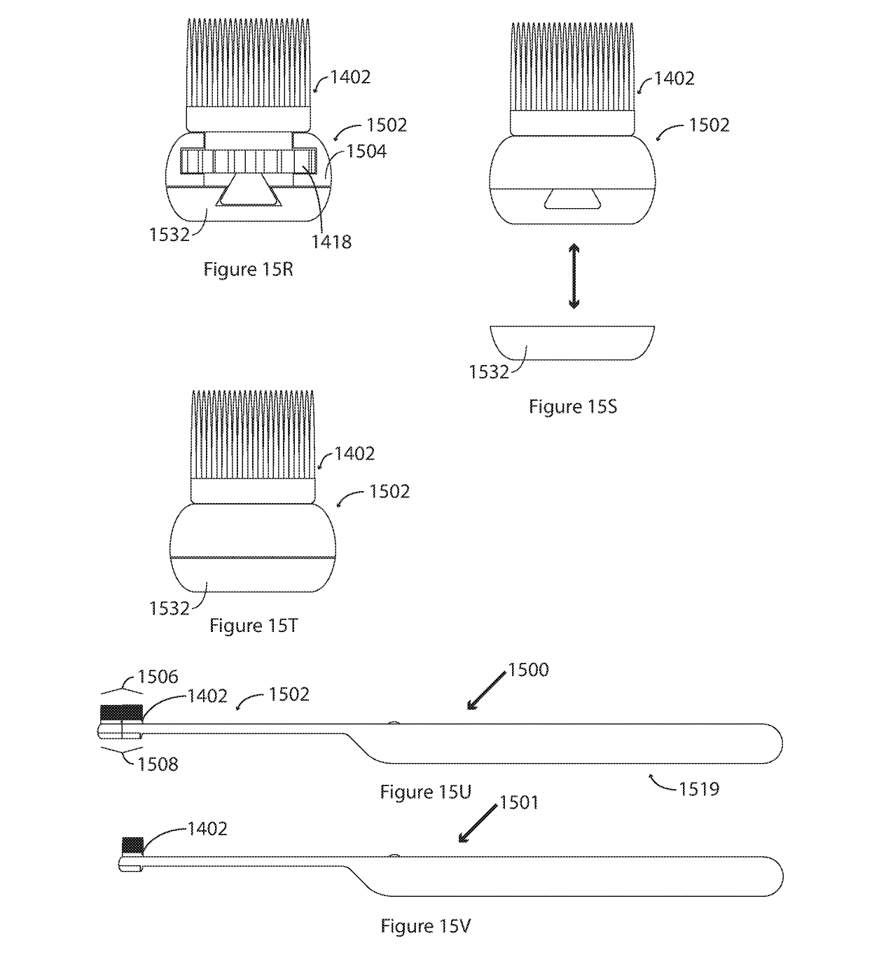

As shown, first rotational component body structure portions 1404 also include gear components 1418 disposed on at least one segment of first rotational component body structure portions 1404 between top surface 1406 and bottom surface 1408 of first rotational component body structure portions 1404. Gear components 1418 operably engage (e.g., mesh) one another such that the neighboring pair of interchangeable rotational components depicted counter-rotate (see, e.g., the directional arrow shown in FIG. 15E) relative to one another during operation of handheld device 1500. In this exemplary embodiment, handheld device 1500 is configured to house two interchangeable rotational components at a given time. The handheld devices of the invention are optionally configured to include only one interchangeable rotational component at a given time (see, for example, handheld device 1501 schematically shown in FIG. 15V) or more than two interchangeable rotational components at a given time (e.g., 3, 4, 5, 6, 7, 8, 9, 10, or more interchangeable rotational components).

In certain embodiments, interchangeable rotational components or portions thereof include various types of attachment components, alignment components, and/or portions thereof, which are configured to reversibly attach and/or align first and second rotational component body structure portions relative to one another. To illustrate, first rotational component body structure portions 1404 include projection components 1420 that fit at least partially within, for example, corresponding recess components 1422 of second rotational component body structure portions 1402, 1608, 1604, 1605, 1612, 1616, 1624, and/or 1620 to align and/or attach (e.g., in when recess components include compression fit features that compress at least portions of corresponding projection components, etc.).

Handheld device 1500 also includes a drive mechanism component that effects the rotation of, for example, second rotational component body structure portions 1402. Although not completely within view (e.g., portion of chain of meshed gear components 122 within view), the drive mechanism component of handheld device 1500 is configured similar to drive mechanism component 104 described herein. Other drive mechanism component configurations are optionally used. For example, drive mechanism component 105 described herein is optionally adapted for use with handheld device 1500.

In the exemplary embodiment shown, head portion 1502 (other than second rotational component body structure portions 1402 and retaining mechanism 1532) is fabricated integral with handle portion 1519. In other embodiments, head portions and handle portions are detachable from or reversibly connectable to one another.

As shown, handheld device 1500 also includes retaining mechanism 1532 (e.g., a cover component) that is configured to reversibly retain second rotational component body structure portions 1402 disposed in rotational component receiving areas 1514. As shown, retaining mechanism 1532 includes recess component 1535 that is configured to interlock with projection component 1537 (e.g., a tapered projection component) to reversibly retain second rotational component body structure portions 1402 and retaining mechanism 1532 positioned relative to one another when second rotational component body structure portions 1402 are received in rotational component receiving areas 1514 and rotate at least partially around rotational axes. Retaining mechanism 1532 also includes attachment component 1539 and 1541 (e.g., corresponding tongue and groove-type sliding mechanisms) that are configured to reversibly attach retaining mechanism 1532 to head portion 1502. Essentially any attachment component is adapted for use in attaching retaining mechanisms and head and/or handle portions to one another, such as hinges and latch components, clamping mechanisms, and clipping mechanisms, among many others.

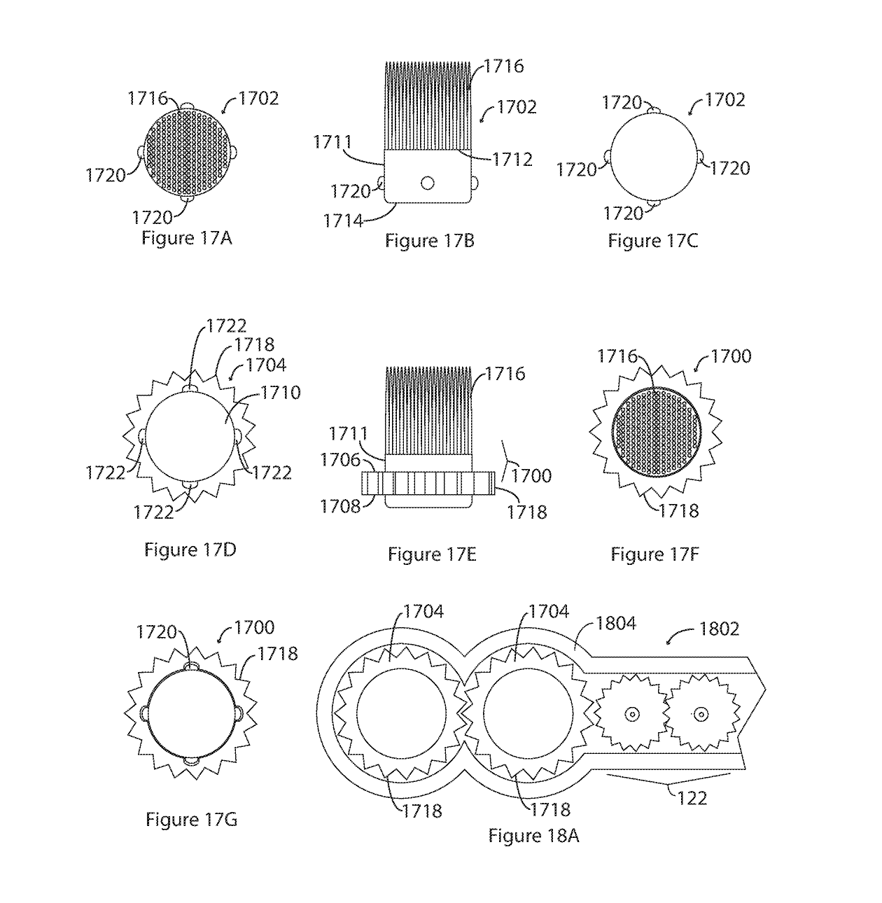

FIGS. 17A-G and 18A-CC schematically illustrate interchangeable rotational components, handheld devices, or portions thereof from various views according to exemplary embodiments of the invention. As shown, handheld device 1800 includes head portion 1802 that includes housing 1804, which includes top area 1806 and bottom area 1808. Top area 1806 includes top openings 1810 and bottom area includes bottom openings 1812. Handheld device 1800 also includes rotational component receiving areas 1814 that communicate with top openings 1810 and bottom openings 1812. Rotational component receiving areas 1814 include first rotational component body structure portions 1704 of interchangeable rotational components 1700 disposed at least partially within the rotational component receiving areas 1814. First rotational component body structure portions 1704 include top surface 1706, bottom surface 1708, and orifice 1710 disposed at least partially through first rotational component body structure portion 1704. Orifice 1710 is configured to reversibly receive at least one section or segment of second rotational component body structure portion 1702 through bottom openings 1812 such that segments of second rotational component body structure portions 1702 are reversibly received in and/or through top openings 1810. Second rotational component body structure portions 1702 include alignment component portions 1711 that reversibly align second rotational component body structure portions 1702 and first rotational component body structure portions 1704 relative to one another when orifice 1710 reversibly receives at least one section or segment of second rotational component body structure portions 1702. Second rotational component body structure portions 1702 also include top surface 1712 and bottom surface 1714. As shown, top surface 1712 includes implements 1716 (shown as bristle components). In certain embodiments, implements are fabricated integral with second rotational component body structure portions. In other exemplary embodiments, implements are selectively attachable to and/or detachable from second rotational component body structure portions.

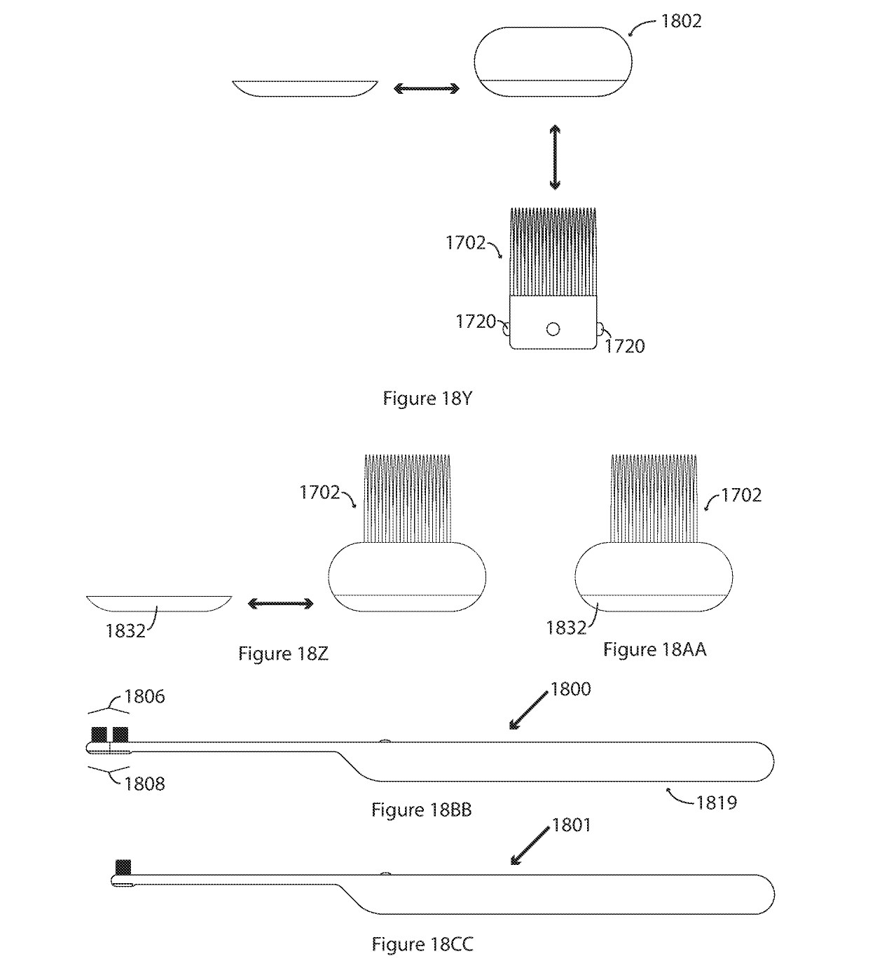

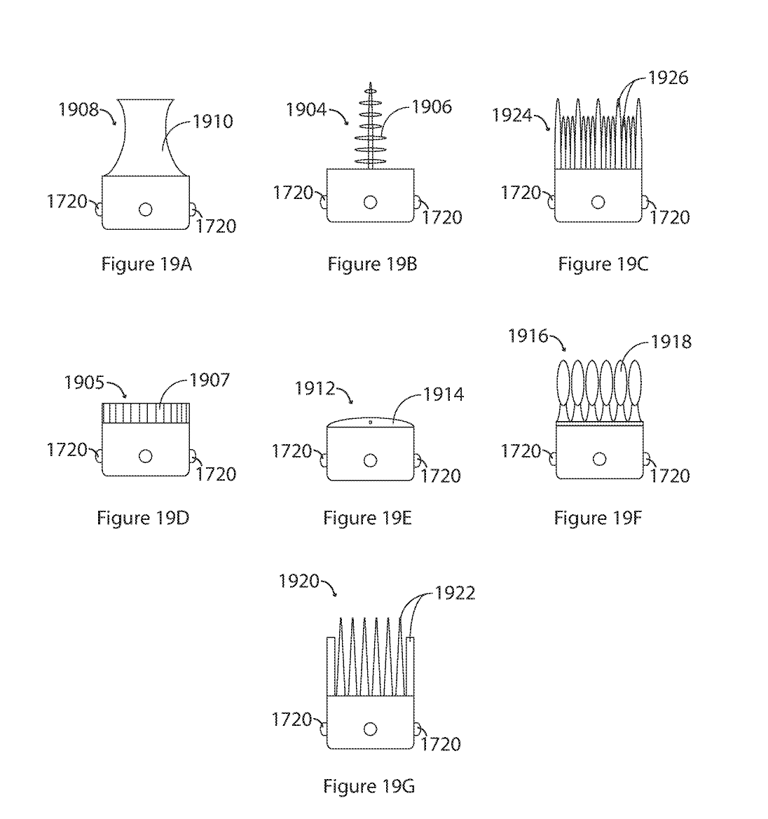

To further illustrate, FIG. 19A-G schematically illustrate side views of various second rotational component body structure portions that are optionally used in handheld device 1800 (e.g., interchanged in essentially any combination for one or more of second rotational component body structure portion 1702) or in other embodiments. As shown, FIG. 19A schematically depicts second rotational component body structure portion 1908, which includes polishing component 1910 (e.g., a prophy cup, etc.). FIG. 19B schematically depicts second rotational component body structure portion 1904, which includes flossing component 1906. FIG. 19C schematically depicts second rotational component body structure portion 1924, which includes bristle components 1926 (e.g., nylon bristles, silicone bristles, etc.). FIG. 19D schematically depicts second rotational component body structure portion 1905, which includes bristle components 1907. FIG. 19E schematically depicts second rotational component body structure portion 1912, which includes cap component 1914 (e.g., a blank cap o/r the like). Cap component 1914 lacks cleaning features, such as bristles or the like in this exemplary embodiment. In certain embodiments, cap components, such as cap component 1914 are used in a given device (e.g., handheld device 1800 or the like) when a user selects not to use every available rotational component position for a given application. For example, a user may interchange the two second rotational component body structure portions 1702 of handheld device 1800 with one second rotational component body structure portion 1904 comprising flossing component 1906 or one second rotational component body structure portion 1908 comprising polishing component 1910 and one second rotational component body structure portion 1912 comprising cap component 1914 as desired. FIG. 19F schematically depicts second rotational component body structure portion 1916, which includes bristle components 1918. FIG. 19G schematically depicts second rotational component body structure portion 1920, which includes bristle components 1922.

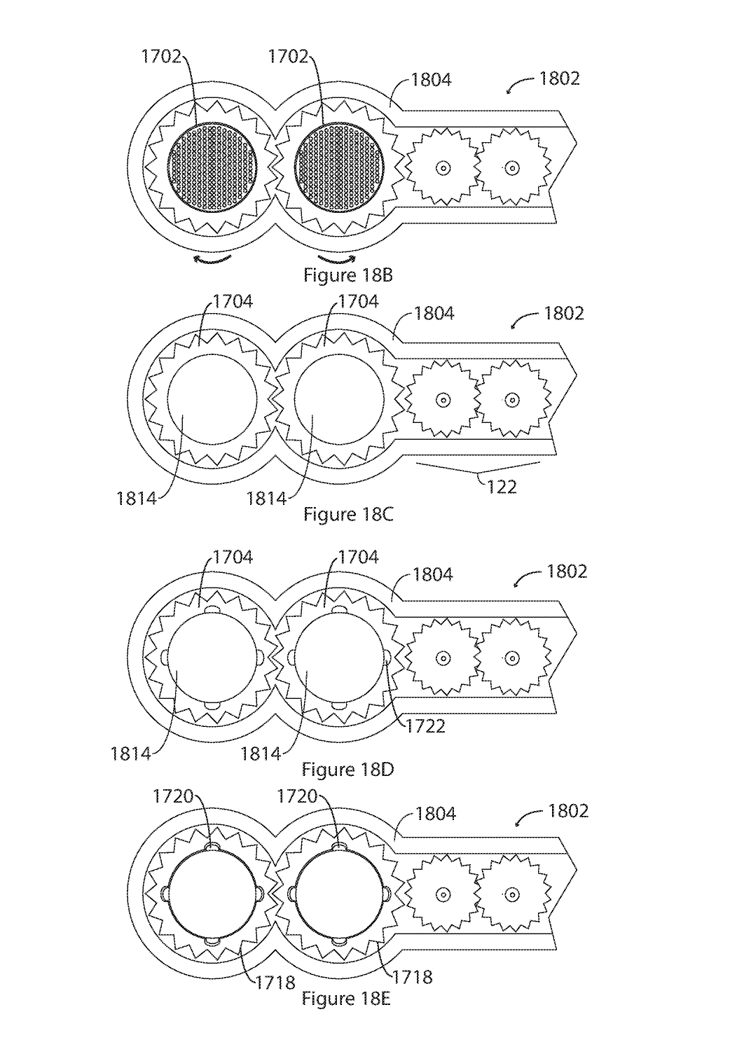

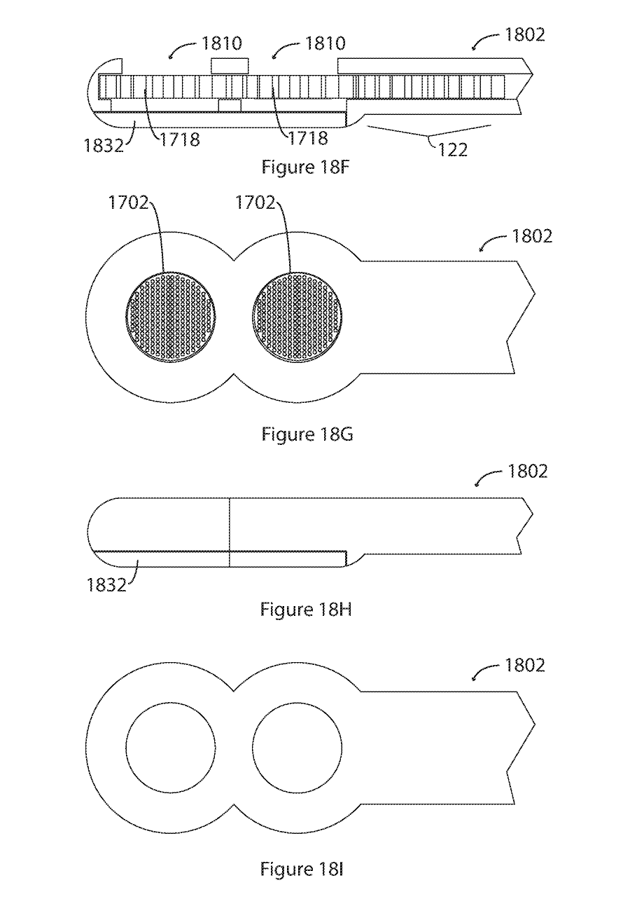

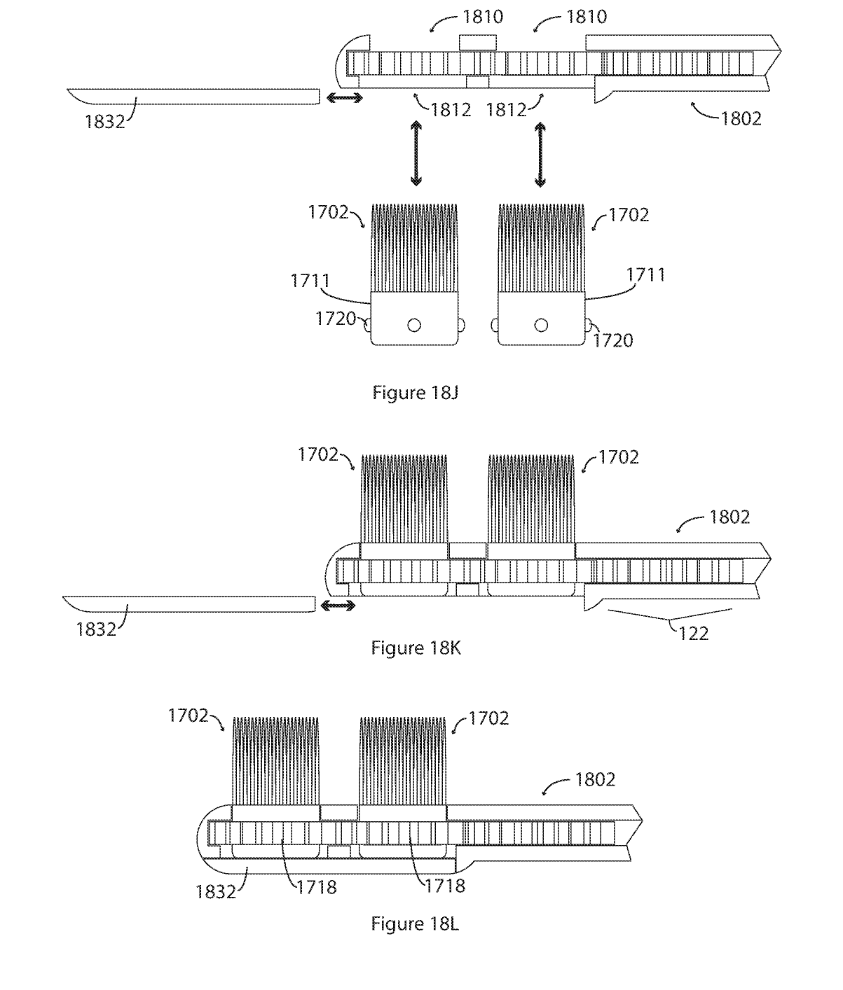

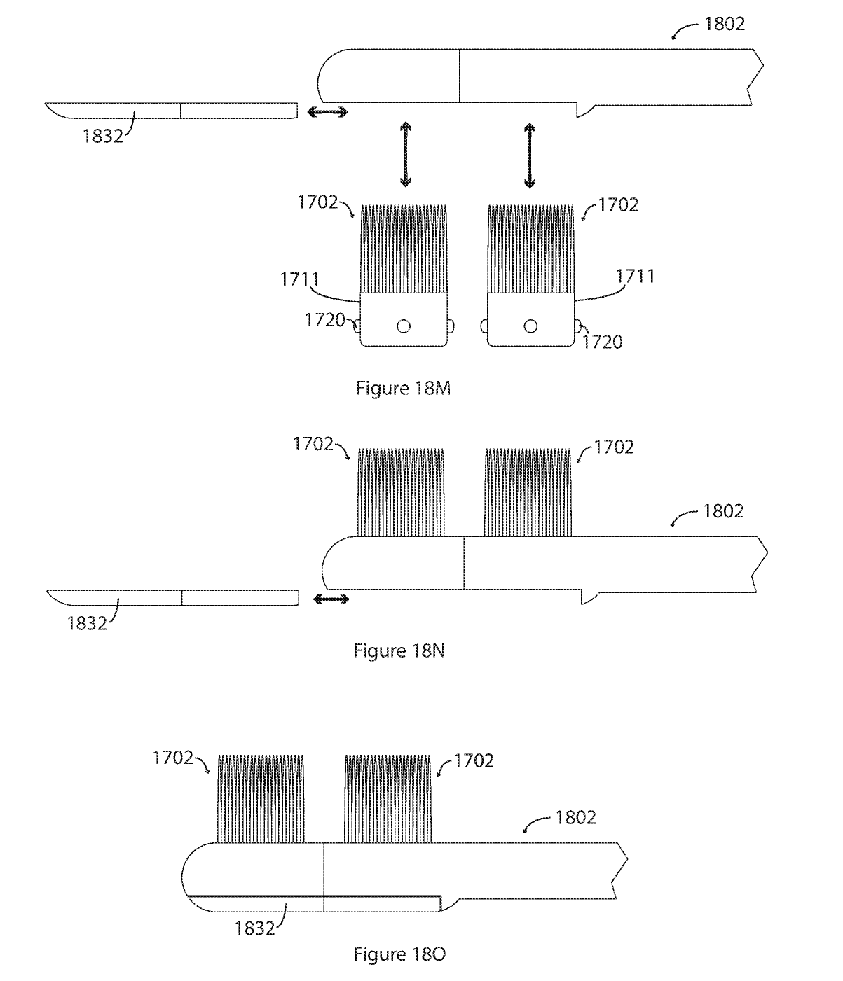

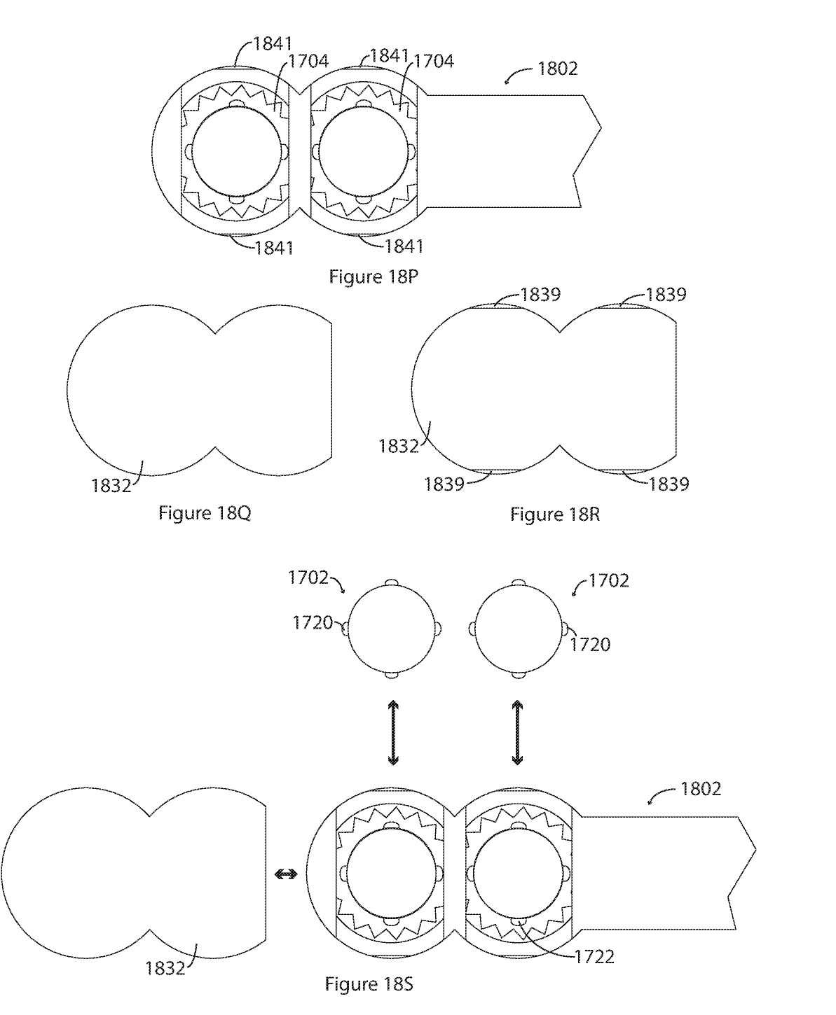

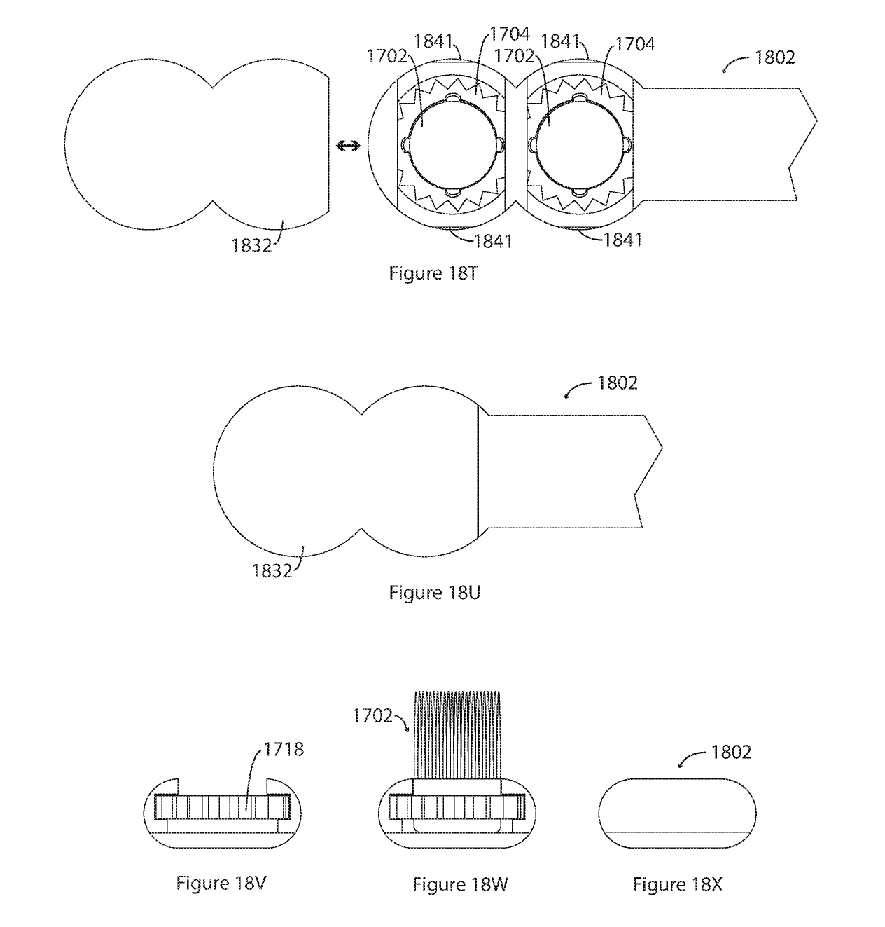

As shown, first rotational component body structure portions 1704 also include gear components 1718 disposed on at least one segment of first rotational component body structure portions 1704 between top surface 1706 and bottom surface 1708 of first rotational component body structure portions 1704. Gear components 1718 operably engage (e.g., mesh) one another such that the neighboring pair of interchangeable rotational components depicted counter-rotate (see, e.g., the directional arrow shown in FIG. 18B) relative to one another during operation of handheld device 1800. In this exemplary embodiment, handheld device 1800 is configured to house two interchangeable rotational components at a given time. The handheld devices of the invention are optionally configured to include only one interchangeable rotational component at a given time (see, for example, handheld device 1801 schematically shown in FIG. 18CC) or more than two interchangeable rotational components at a given time (e.g., 3, 4, 5, 6, 7, 8, 9, 10, or more interchangeable rotational components).

In certain embodiments, interchangeable rotational components or portions thereof include various types of attachment components, alignment components, and/or portions thereof, which are configured to reversibly attach and/or align first and second rotational component body structure portions relative to one another. To illustrate, second rotational component body structure portions 1702, 1908, 1904, 1905, 1912, 1916, 1924, and 1920 include projection components 1720 that fit at least partially within, for example, corresponding recess components 1722 of first rotational component body structure portions 1704 to align and/or attach (e.g., in when recess components include compression fit features that compress at least portions of corresponding projection components, etc.).

Handheld device 1800 also includes a drive mechanism component that effects the rotation of, for example, second rotational component body structure portions 1702. Although not completely within view (e.g., portion of chain of meshed gear components 122 within view), the drive mechanism component of handheld device 1800 is configured similar to drive mechanism component 104 described herein. Other drive mechanism component configurations are optionally used. For example, drive mechanism component 105 described herein is optionally adapted for use with handheld device 1800.

In the exemplary embodiment shown, head portion 1802 (other than second rotational component body structure portions 1702 and retaining mechanism 1832) is fabricated integral with handle portion 1819. In other embodiments, head portions and handle portions are detachable from or reversibly connectable to one another.

As shown, handheld device 1800 also includes retaining mechanism 1832 (e.g., a cover component) that is configured to reversibly retain second rotational component body structure portions 1702 disposed in rotational component receiving areas 1814, for example, when second rotational component body structure portions 1702 rotate at least partially around rotational axes. Retaining mechanism 1832 also includes attachment component 1839 and 1841 (e.g., corresponding tongue and groove-type sliding mechanisms) that are configured to reversibly attach retaining mechanism 1832 to head portion 1802. Essentially any attachment component is adapted for use in attaching retaining mechanisms and head and/or handle portions to one another, such as hinges and latch components, clamping mechanisms, and clipping mechanisms, among many others.

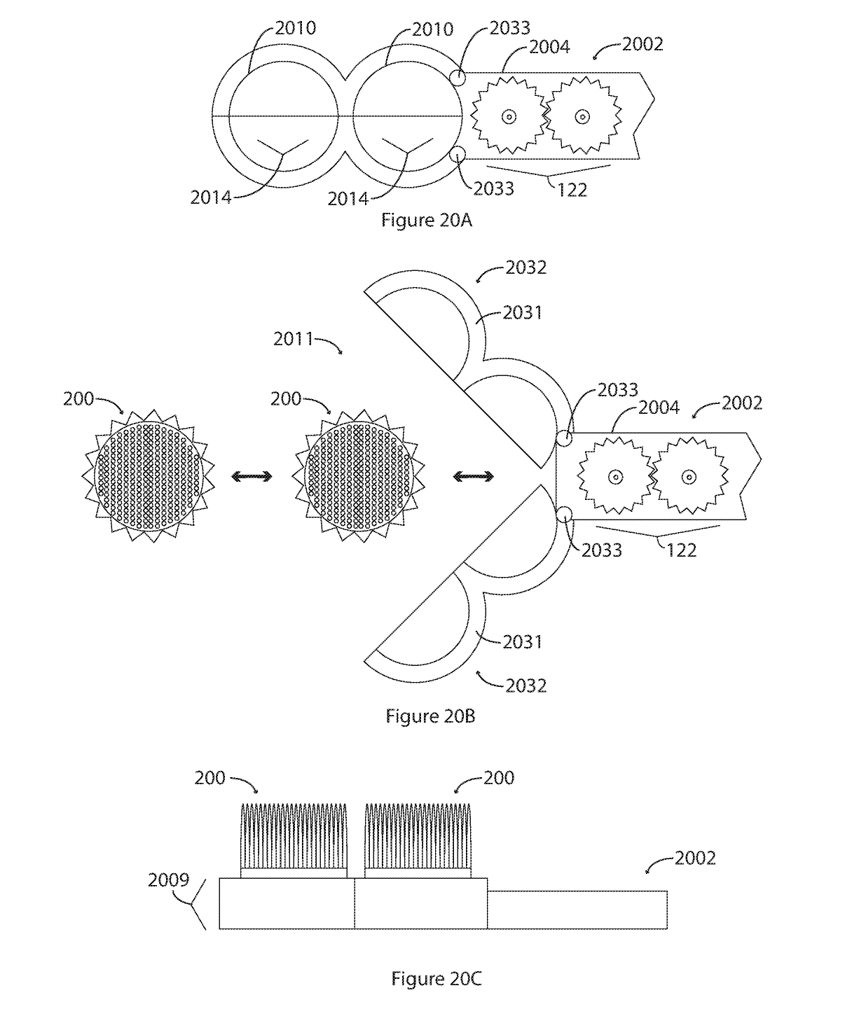

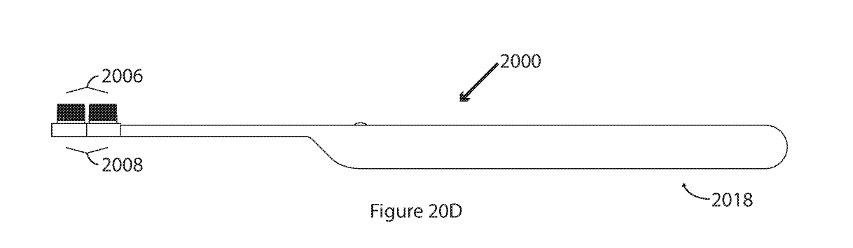

FIG. 20A-D schematically illustrate a handheld device or portions thereof from various views according to one embodiment of the invention. As shown, handheld device 2000 includes head portion 2002 that includes housing 2004, which includes top area 2006, bottom area 2008, and side area 2009. Top area 2006 includes top opening 2010. Handheld device 2000 also includes rotational component receiving areas 2014 that communicates with top openings 2010 and side opening 2011. Rotational component receiving areas 2014 are configured to reversibly receive a portion of, for example, interchangeable rotational components 200 at least through side opening 2011. Other examples of interchangeable rotational components that are optionally used with handheld device 2000 are described herein, such as in FIGS. 2B-2F, 4A-C, 5A-C, 6A-C, and 7A-C. In this exemplary embodiment, handheld device 2000 is configured to house two interchangeable rotational components at a given time. The handheld devices of the invention are optionally configured to include one or more than two interchangeable rotational components at a given time (e.g., 3, 4, 5, 6, 7, 8, 9, 10, or more interchangeable rotational components).

Handheld device 2000 also includes a drive mechanism component that effects the rotation of interchangeable rotational components 2000. Although not completely within view (e.g., portion of chain of meshed gear components 122 within view), the drive mechanism component of handheld device 2000 is configured similar to drive mechanism component 104 described herein. Other drive mechanism component configurations are optionally used. For example, drive mechanism component 105 described herein is optionally adapted for use with handheld device 2000.

In the exemplary embodiment shown, head portion 2002 (other than interchangeable rotational component 200 and retaining mechanism 2032) is fabricated integral with handle portion 2018. In other embodiments, head portions and handle portions are detachable from or reversibly connectable to one another.

As shown, handheld device 2000 also includes retaining mechanism 2032 that is configured to reversibly retain interchangeable rotational components 200 disposed in rotational component receiving areas 2014. Retaining mechanism 2032 includes movable segments 2031 that are configured to move such that the interchangeable rotational components 200 are reversibly receivable at least through side opening 2011. As shown, coupling components 2033 (e.g., hinge components) movably couple movable segment 2031 at least to housing 2004.

In some embodiments, the handheld devices (e.g., toothbrushing devices, household cleaning devices, etc.) or component thereof (e.g., toothbrush head components, household cleaning device head components, etc.) of the invention include rotational components (e.g., first rotational component body structure portions, second rotational component body structure portions, etc.). For example, FIGS. 21 A and B schematically show rotational components and a shaft gear component positioned relative to one another that are optionally adapted for use in the handheld devices or components thereof (e.g., toothbrush head components, etc.) of the invention. As shown, rotary mechanism 2100 includes first rotational component 2102 that is configured to rotate around first rotational axis 2104. First rotational component 2102 includes first body structure component 2106 that is configured to be at least partially disposed in a rotational component receiving area (not shown in FIGS. 21 A and B). Examples of rotational component receiving areas that are optionally adapted for use with rotary mechanism 2100 are described herein. First body structure component 2106 includes first gear component 2108 (e.g., a spur gear or the like) and second gear component 2110 (e.g., a bevel gear or the like). First body structure component 2106 also includes orifice 2112 disposed at least partially through the first body structure component 2106. Orifice 2112 is configured to reversibly receive at least one section of an interchangeable rotational component (e.g., interchangeable rotational component 2200 schematically illustrated in FIG. 22) through a top opening of a housing (not shown) of a device or device component (e.g., a detachable or replacement toothbrush head component, toothbrushing device, etc.) such that a segment of the interchangeable rotational component is reversibly received in and/or through the top opening. Housings that include head and neck portions that are optionally adapted for use with rotary mechanism 2100 are described herein.

As also shown, rotary mechanism 2100 also includes second rotational component 2114 that is configured to rotate around second rotational axis 2116. In this exemplary embodiment, first rotational axis 2104 and second rotational axis 2116 are substantially parallel to one another. In other embodiments, first rotational axis 2104 and second rotational axis 2116 are not substantially parallel to one another. Second rotational component 2114 includes second body structure component 2118 that is configured to be at least partially disposed in a rotational component receiving area (not shown in FIGS. 21 A and B). Examples of rotational component receiving areas that are optionally adapted for use with rotary mechanism 2100 are described herein. Second body structure component 2118 includes first gear component 2120 (e.g., a spur gear or the like), which operably engages (e.g., meshes with) first gear component 2108 of first body structure component 2106. In the embodiment shown, second body structure component 2118 includes second gear component 2122 (e.g., a bevel gear or the like). In other embodiments, second body structure component 2118 does not include a second gear component. Second body structure component 2118 also includes orifice 2124 disposed at least partially through second body structure component 2118. Orifice 2124 is configured to reversibly receive at least one section of an interchangeable rotational component (e.g., interchangeable rotational component 2200 schematically illustrated in FIG. 22) through a top opening of a housing (not shown) of a device or device component (e.g., a detachable or replacement toothbrush head component, toothbrushing device, etc.) such that a segment of the interchangeable rotational component is reversibly received in and/or through the top opening. Housings that include head and neck portions that are optionally adapted for use with rotary mechanism 2100 are described herein.

The handheld devices (e.g., toothbrushing devices, household cleaning devices, etc.) or component thereof (e.g., toothbrush head components, household cleaning device head components, etc.) of the invention also typically include drive mechanism components or portions thereof at least partially disposed in neck and/or handle portions of device or component housings. For example, rotary mechanism 2100 includes shaft component 2126 (only a portion is shown) that is configured to rotate around third rotational axis 2128. In the embodiment shown, third rotational axis 2128 is substantially perpendicular to, and intersects with, first rotational axis 2104 and/or second rotational axis 2116. In other embodiments, third rotational axis 2128 is not substantially perpendicular to, and/or does not intersect with, first rotational axis 2104 and/or second rotational axis 2116. As shown, shaft component 2126 includes shaft gear component 2130 (e.g., a bevel gear or the like) that operably engages (e.g., meshes with) second gear component 2110 of first body structure component 2102. When the shaft component 2126 continuously rotates in one direction around third rotational axis 2128, first rotational component 2102 continuously rotates in a first direction around first rotational axis 2104 and second rotational component 2114 continuously rotates in a second direction around second rotational axis 2116 in which the first and second directions are substantially opposite one another. Shaft component 2126 is typically operably connected to a motor component that effects rotation of shaft component 2126. Shaft components, motors, and other drive mechanism components or portions thereof that are optionally adapted for use with rotary mechanism 2100 are described herein.

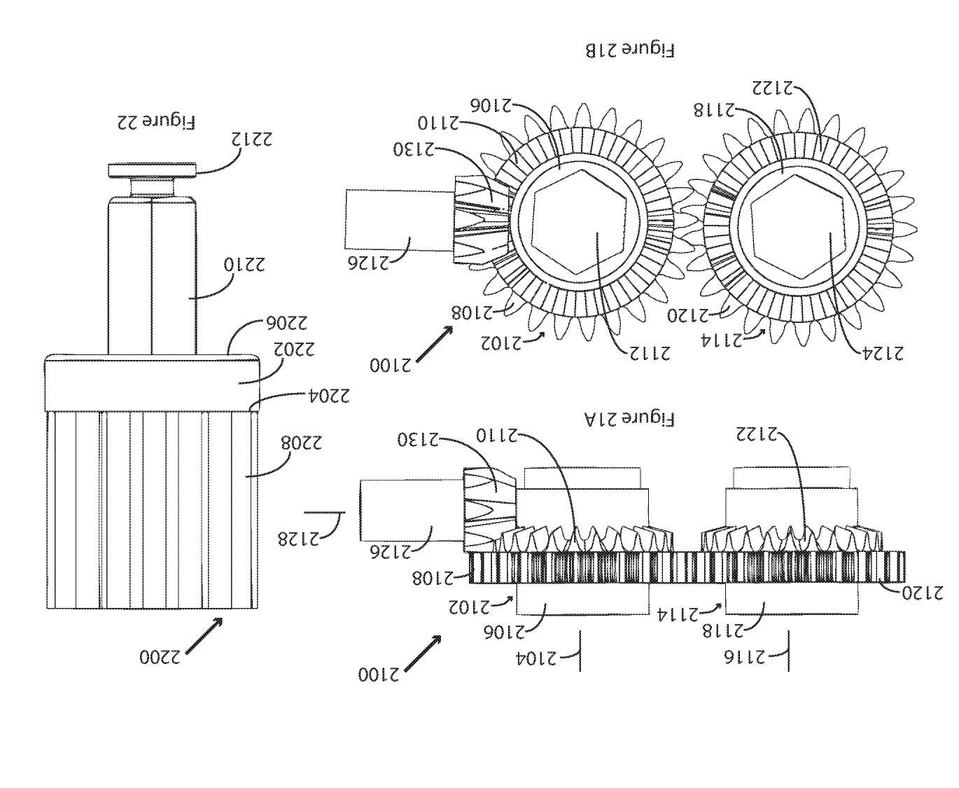

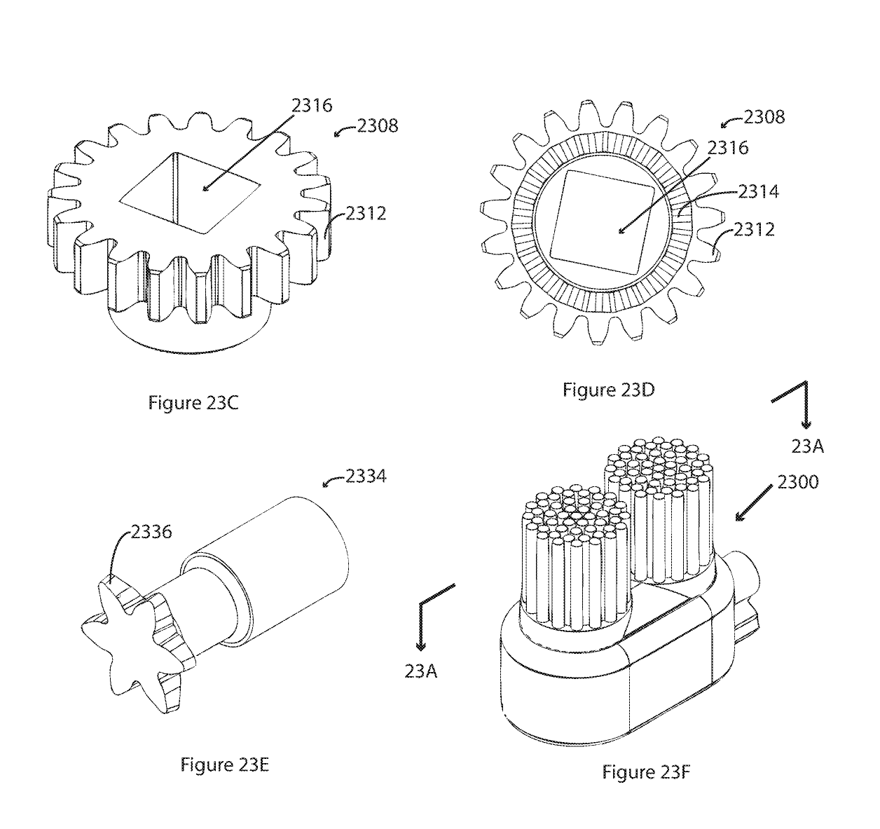

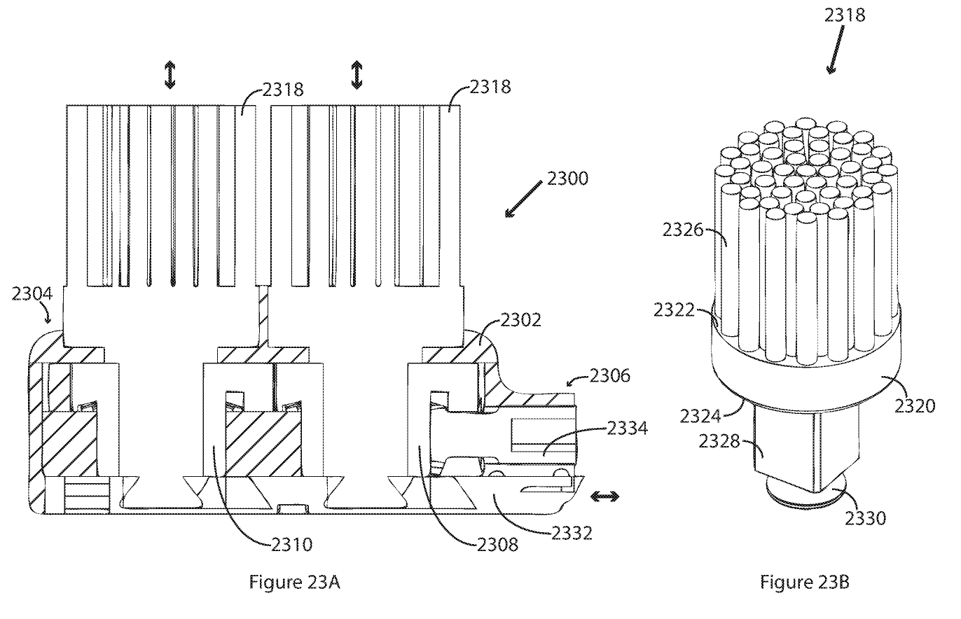

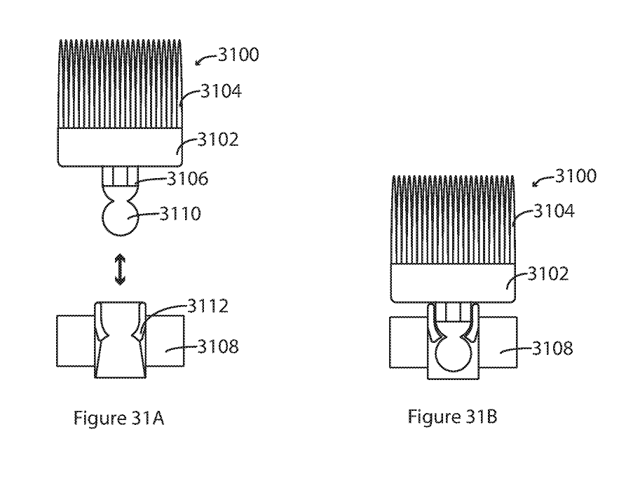

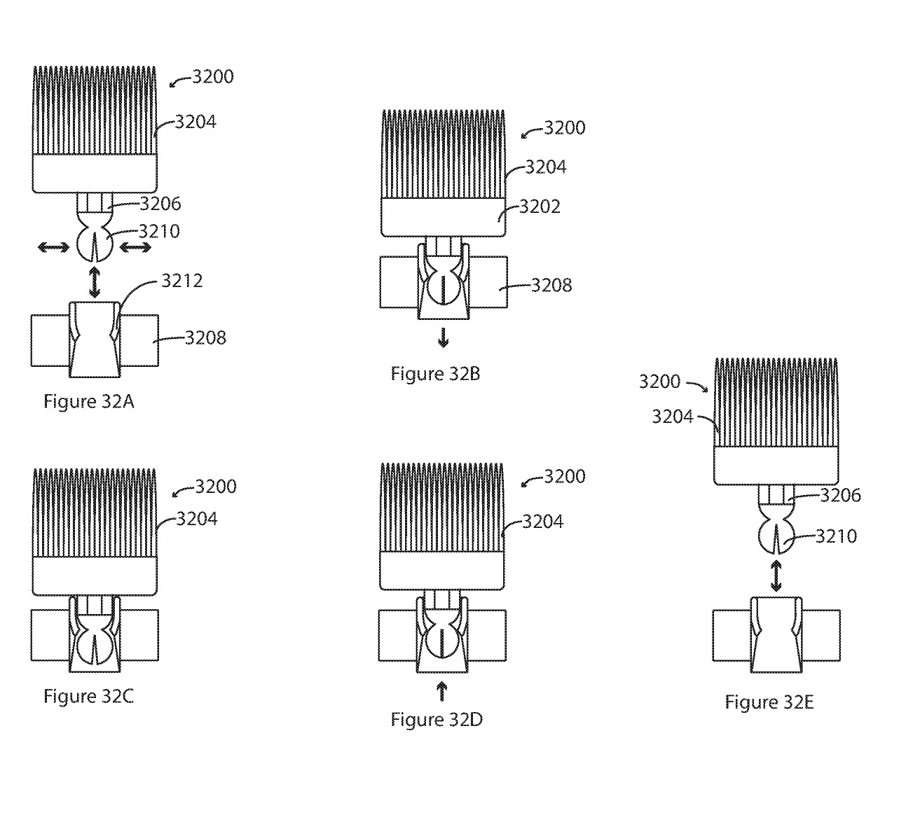

The invention also provides various types of interchangeable rotational components (e.g., second rotational component body structure portions, etc.). To illustrate, FIG. 22 schematically shows interchangeable rotational component 2200 which is configured to be at least partially inserted in orifice 2112 disposed at least partially through the first body structure component 2106 or in orifice 2124 disposed at least partially through second body structure component 2118. As shown, interchangeable rotational component 2200 includes base component 2202 that includes top surface 2204 and bottom surface 2206. Interchangeable rotational component 2200 includes implement 2208 (shown as a bristle component or the like) extending from top surface 2204. Various exemplary implements that are optionally adapted for use with interchangeable rotational component 2200 (e.g., flossing components, bristle components, polishing components, cap components, etc.) are described herein. As also shown, interchangeable rotational component 2200 also includes shaft component 2210 that extends from bottom surface 2203 of base component 2202. Shaft component 2210 is configured to be received, and reversibly retained, at least partially in an orifice (orifice 2112 or orifice 2124) of a body structure component of, e.g., a toothbrush rotational component or the like. In the exemplary embodiment shown, shaft component 2210 includes a substantially hexagonal cross-sectional shape. In other embodiments, at least a portion of shaft component 2210 includes at least one cross-sectional shape selected from, e.g., a circle, an oval, a square, a rectangle, a trapezoid, an irregular n-sided polygon, a regular n-sided polygon, and the like. Interchangeable rotational component 2200 also includes portion 2212 of a retaining mechanism that reversibly retains interchangeable rotational component 2200 positioned relative to, e.g., body structure components of toothbrush rotational components or the like when shaft component 2210 is at least partially disposed in the orifice of a body structure component of the toothbrush rotational component. In some embodiments, a portion of a retaining mechanism of an interchangeable rotational component is configured to engage another portion of the retaining mechanism (e.g., including one or more resilient coupling components in certain embodiments) that is disposed on a one or more surfaces that define the orifice of a body structure component of a rotational component. Some of these embodiments are schematically depicted, e.g., in FIGS. 31 A and B and FIGS. 32A-E. In some embodiments, a portion of a retaining mechanism of an interchangeable rotational component is not configured to engage another portion of the retaining mechanism that is disposed on a one or more surfaces that define the orifice of a body structure component of a rotational component (e.g., the other portion of the retaining mechanism that is disposed on a component that is separate from the orifice of a body structure component of a rotational component, such as a keeper plate or the like). Additional examples of retaining mechanisms or portions thereof that are optionally adapted for use with, e.g., interchangeable rotational component 2200 are described herein. Some of these exemplary embodiments are schematically depicted, e.g., in FIGS. 23A-F, 24, 25A-D, 26A-D, 27A-D, 28 A and B, and 29.

To further illustrate, FIGS. 23A-F schematically illustrates a segment of a head portion of a toothbrush or portions thereof from various views according to an exemplary embodiment of the invention. In some embodiments, the device head portions of the invention (e.g., head portions of toothbrushes, head portions of household cleaning devices, etc.) are optionally fabricated as selectively detachable from handle portions of devices by users (e.g., as replacement toothbrush heads, etc.) or are fabricated integral with (e.g., as one with or non-detachable from) handle portions of devices. As shown, toothbrush head component 2300 includes housing 2302, which includes head portion 2304 and neck portion 2306 (only a segment shown) that are operably connected to one another. Head portion 2304 includes a top area that includes first and second top openings and first and second rotational component receiving areas that communicate with the top openings. In addition, rotational components 2308 and 2310 (e.g., first rotational body structure portions, etc.) are at least partially disposed, and configured to rotate, in the first and second rotational component receiving areas, respectively. In the exemplary embodiment shown, rotational components 2308 and 2310 are the same as one another. Rotational components 2308 and 2310 include first gear components 2312 (e.g., spur gear components, etc.) and second gear components 2314 (e.g., crown gear components, etc.). First gear components 2312 of rotational components 2308 and 2310 mesh with one another. As also shown, body structure components of rotational components 2308 and 2310 also include orifices 2316 disposed at least partially through the body structure components. Orifices 2316 are configured to reversibly receive at least one section of interchangeable rotational components (e.g., interchangeable rotational component 2318) through the top openings such that a segment of the interchangeable rotational components is reversibly received through the top openings.

As shown, interchangeable rotational component 2318 includes base component 2320, which includes top surface 2322 and bottom surface 2324. Implements 2326 (shown as bristle components) extend from top surface 2322. Shaft component 2328 extends from bottom surface 2322 of base component 2320. Shaft component 2328 is configured to be received, and reversibly retained, at least partially in orifices 2316 of the body structure components of rotational components 2308 and 2310. Additional examples of interchangeable rotational components and implements that are optionally adapted for use with toothbrush head component 2300 are described herein. As also shown, interchangeable rotational component 2318 also includes portion 2330 (shown as a tapered projection component) of a retaining mechanism that reversibly retains interchangeable rotational component 2318 positioned relative to the body structure components of rotational components 2308 and 2310 when shaft component 2328 is at least partially disposed in orifices 2316 of rotational components 2308 and 2310. Portion 2330 of interchangeable rotational component 2318 is configured to interlock with recess components of retaining mechanism portion 2332 (shown as a sliding component in an open position) to reversibly retain interchangeable rotational component 2318 (e.g., a second rotational component body structure portion) when interchangeable rotational component 2318 is received in orifices 2316 of rotational components 2308 and 2310 and rotate around rotational axes in toothbrush head component 2300.

Toothbrush head component 2300 also includes shaft component 2334, which includes shaft gear component 2336 (e.g., a star gear component, etc.). Shaft gear component 2336 meshes with second gear component 2314 of rotational component 2308. When the shaft component 2334 continuously rotates in one direction around its rotational axis, rotational component 2308 continuously rotates in a first direction around its rotational axis and rotational component 2310 continuously rotates in a second direction around its rotational axis in which the first and second directions are substantially opposite one another. Shaft component 2334 is typically operably connected to a motor component that effects rotation of shaft component 2334. Shaft components, motors, and other drive mechanism components or portions thereof that are optionally adapted for use with toothbrush head component 2300 are described herein.

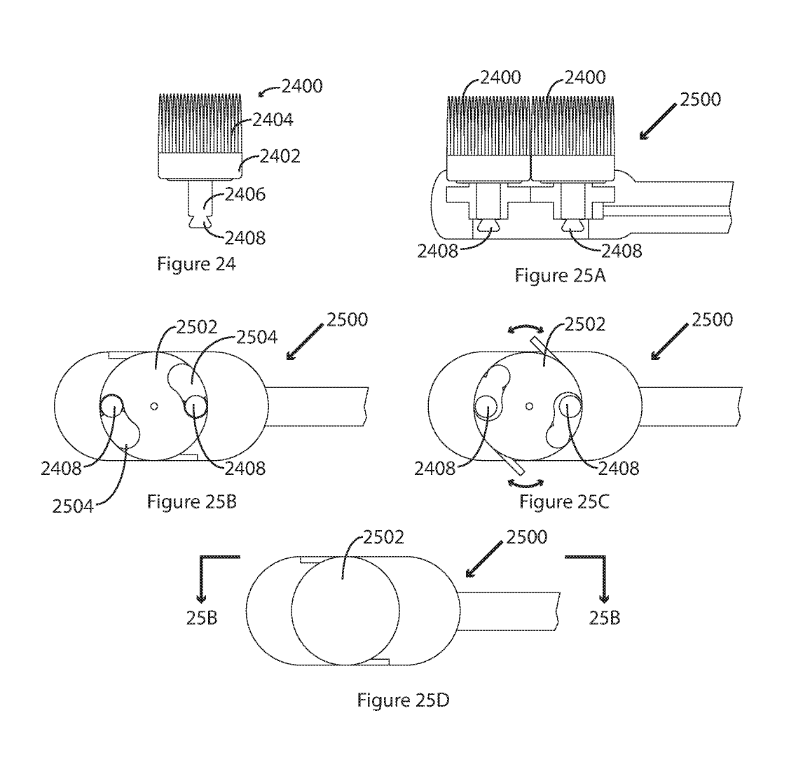

To further illustrate, FIG. 24 schematically shows interchangeable rotational component 2400 from a side view according to one exemplary embodiment of the invention. As shown, interchangeable rotational component 2400 includes base component 2402 that includes a top surface and a bottom surface. Interchangeable rotational component 2400 includes implement 2404 (shown as a bristle component or the like) extending from the top surface. Various exemplary implements that are optionally adapted for use with interchangeable rotational component 2400 (e.g., flossing components, bristle components, polishing components, cap components, etc.) are described herein. As also shown, interchangeable rotational component 2400 also includes shaft component 2406 that extends from the bottom surface of base component 2402. Shaft component 2406 is configured to be received, and reversibly retained, at least partially in an orifice of a body structure component of, e.g., a toothbrush rotational component or the like. In the exemplary embodiment shown, shaft component 2406 includes a substantially rounded square cross-sectional shape. In other embodiments, at least a portion of shaft component 2406 includes at least one cross-sectional shape selected from, e.g., a circle, an oval, a square, a rectangle, a trapezoid, an irregular n-sided polygon, a regular n-sided polygon, and the like. Interchangeable rotational component 2400 also includes portion 2408 of a retaining mechanism that reversibly retains interchangeable rotational component 2400 positioned relative to, e.g., body structure components of toothbrush rotational components or the like when shaft component 2406 is at least partially disposed in the orifice of a body structure component of the toothbrush rotational component.

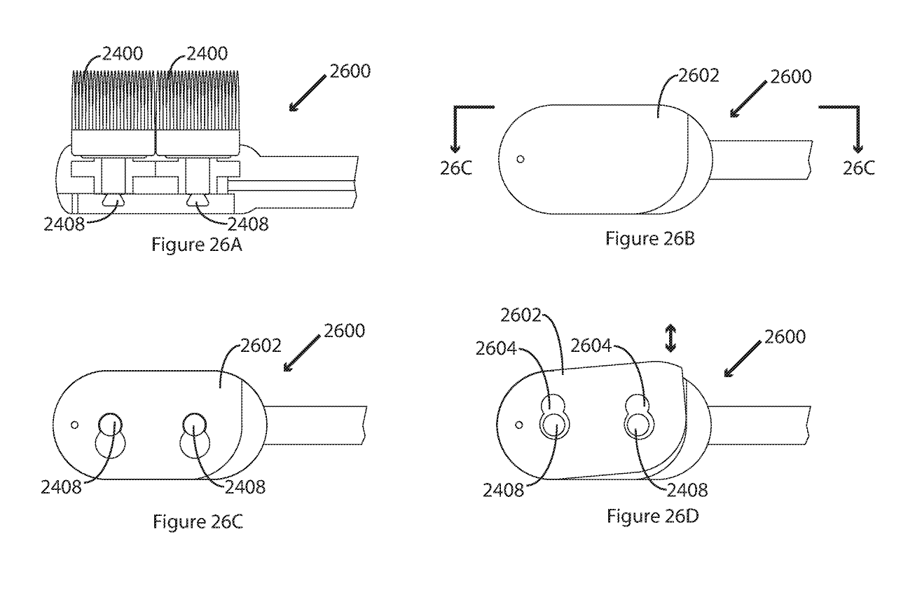

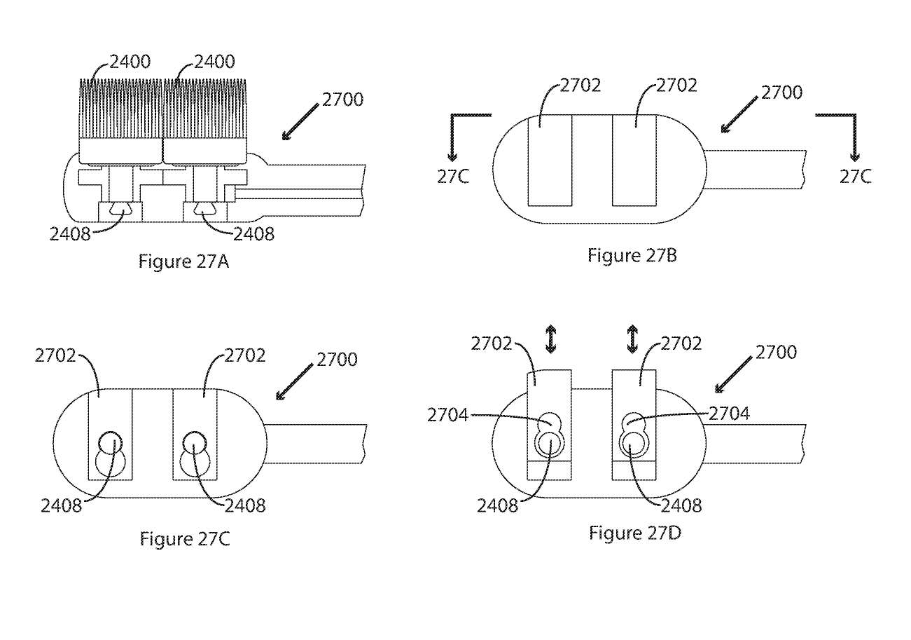

The devices of the invention include various retaining mechanism embodiments. Retaining mechanisms are typically included to retain and permit the rotation of interchangeable rotational components relative to other device components (e.g., toothbrush head components, cleaning head components, etc.) during usage. To illustrate, FIGS. 25A-D schematically depict a segment of a toothbrush head component from various views according to an exemplary embodiment of the invention. As shown, segment 2500 of the toothbrush head component includes retaining mechanism portion 2502 (shown as a rotatable component). Portion 2408 of interchangeable rotational component 2400 is configured to interlock with recess components 2504 of retaining mechanism portion 2502 to reversibly retain interchangeable rotational component 2400 (e.g., a second rotational component body structure portion) when interchangeable rotational component 2400 is received in the orifices of rotational components of segment 2500 of the toothbrush head component and rotate around rotational axes in segment 2500 of the toothbrush head component. FIGS. 26A-D schematically depict a segment of a toothbrush head component from various views according to an exemplary embodiment of the invention. As shown, segment 2600 of the toothbrush head component includes retaining mechanism portion 2602 (shown as a rotatable component). Portion 2408 of interchangeable rotational component 2400 is configured to interlock with recess components 2604 of retaining mechanism portion 2602 to reversibly retain interchangeable rotational component 2400 (e.g., a second rotational component body structure portion) when interchangeable rotational component 2400 is received in the orifices of rotational components of segment 2600 of the toothbrush head component and rotate around rotational axes in segment 2600 of the toothbrush head component. FIGS. 27A-D schematically depict a segment of a toothbrush head component from various views according to an exemplary embodiment of the invention. As shown, segment 2700 of the toothbrush head component includes retaining mechanism portions 2702 (shown as slidable components). Portion 2408 of interchangeable rotational component 2400 is configured to interlock with recess components 2704 of retaining mechanism portions 2702 to reversibly retain interchangeable rotational component 2400 (e.g., a second rotational component body structure portion) when interchangeable rotational component 2400 is received in the orifices of rotational components of segment 2700 of the toothbrush head component and rotate around rotational axes in segment 2700 of the toothbrush head component.

To further illustrate, FIGS. 28 A and B schematically depict a segment of toothbrush head component 2800. As shown, toothbrush head component 2800 includes rotational components 2803 and 2805 (e.g., first rotational component body structure portions) with orifices that receive shaft components of interchangeable rotational components 2802 (e.g., second rotational component body structure portions). Rotational components 2803 and 2805 of toothbrush head component 2800 include gear components (e.g., bevel gear components, etc.) that mesh with one another. Toothbrush head component 2800 also includes retaining mechanism portion 2804 (shown as a slidable component) that includes a recess component (not within view) that interlocks with retaining mechanism portions of interchangeable rotational components 2802. Toothbrush head component 2800 also includes shaft component 2806, which include shaft gear component 2808 (e.g., bevel gear components, etc.). Shaft gear component 2808 meshes with the gear component of rotational component 2805. When the shaft component 2806 continuously rotates in one direction around its rotational axis, rotational component 2805 continuously rotates in a first direction around its rotational axis and rotational component 2803 continuously rotates in a second direction around its rotational axis in which the first and second directions are substantially opposite one another. Shaft component 2806 is typically operably connected to a motor component that effects rotation of shaft component 2806. Shaft components, motors, and other drive mechanism components or portions thereof that are optionally adapted for use with toothbrush head component 2800 are described herein.

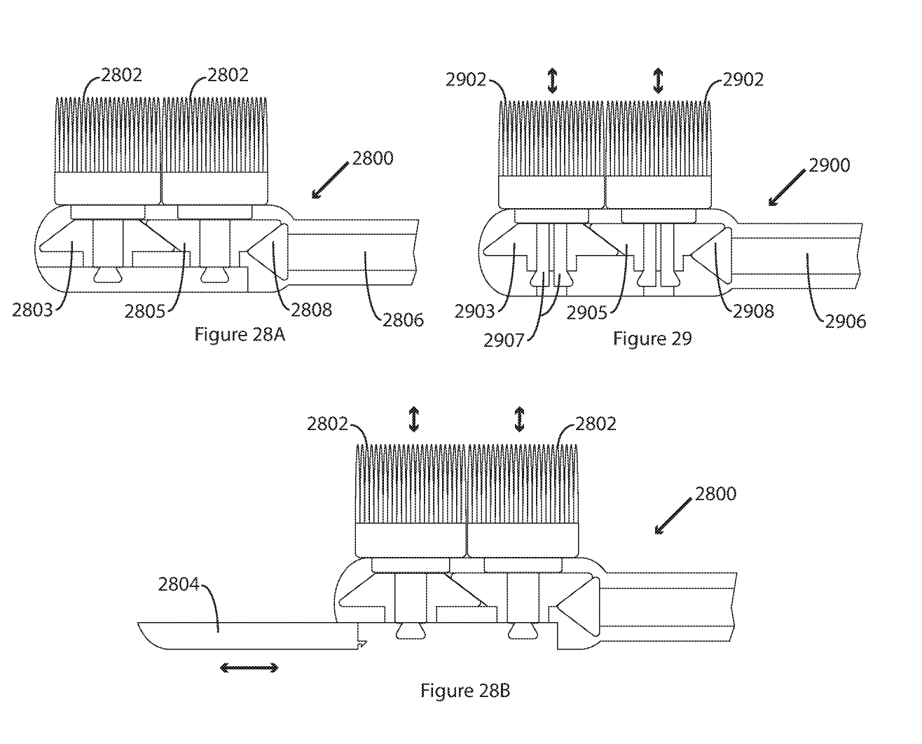

To further illustrate, FIG. 29 schematically depicts a segment of toothbrush head component 2900. As shown, toothbrush head component 2900 includes rotational components 2903 and 2905 (e.g., first rotational component body structure portions) with orifices that receive resilient shaft components 2907 of interchangeable rotational components 2902 (e.g., second rotational component body structure portions). Resilient shaft components 2907 are configured to compress together when resilient shaft components 2907 are inserted into or removed from the orifices of rotational components 2903 and 2905. Resilient shaft components 2907 retain and permit rotation of interchangeable rotational components 2902 in the absence of other retaining mechanism portions (e.g., retaining mechanism portion 2804, etc.). Rotational components 2903 and 2905 of toothbrush head component 2900 include gear components (e.g., bevel gear components, etc.) that mesh with one another. Toothbrush head component 2900 also includes shaft component 2906, which include shaft gear component 2908 (e.g., bevel gear components, etc.). Shaft gear component 2908 meshes with the gear component of rotational component 2905. When the shaft component 2906 continuously rotates in one direction around its rotational axis, rotational component 2905 continuously rotates in a first direction around its rotational axis and rotational component 2903 continuously rotates in a second direction around its rotational axis in which the first and second directions are substantially opposite one another. Shaft component 2906 is typically operably connected to a motor component that effects rotation of shaft component 2906. Shaft components, motors, and other drive mechanism components or portions thereof that are optionally adapted for use with toothbrush head component 2900 are described herein.

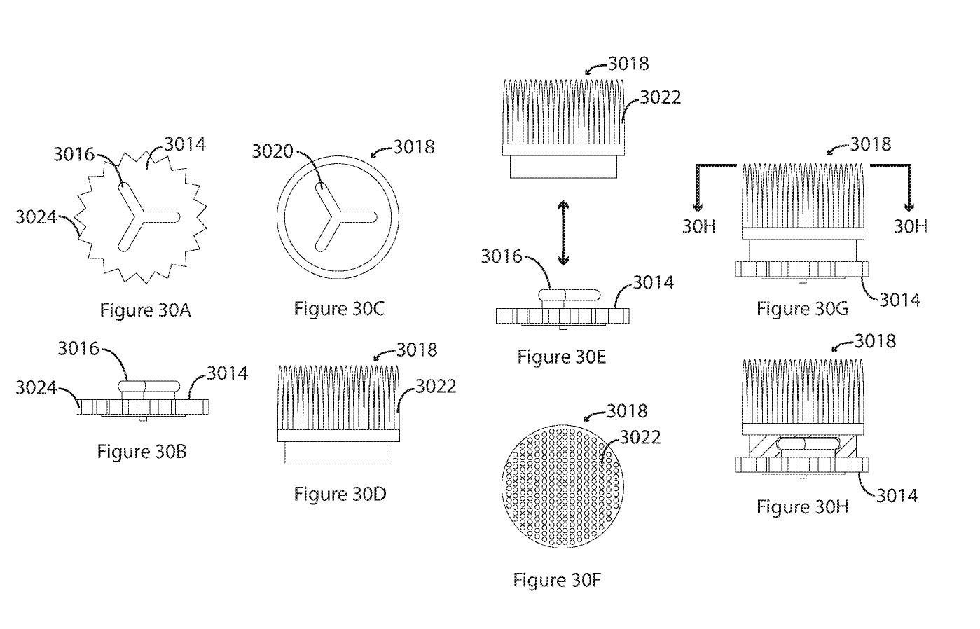

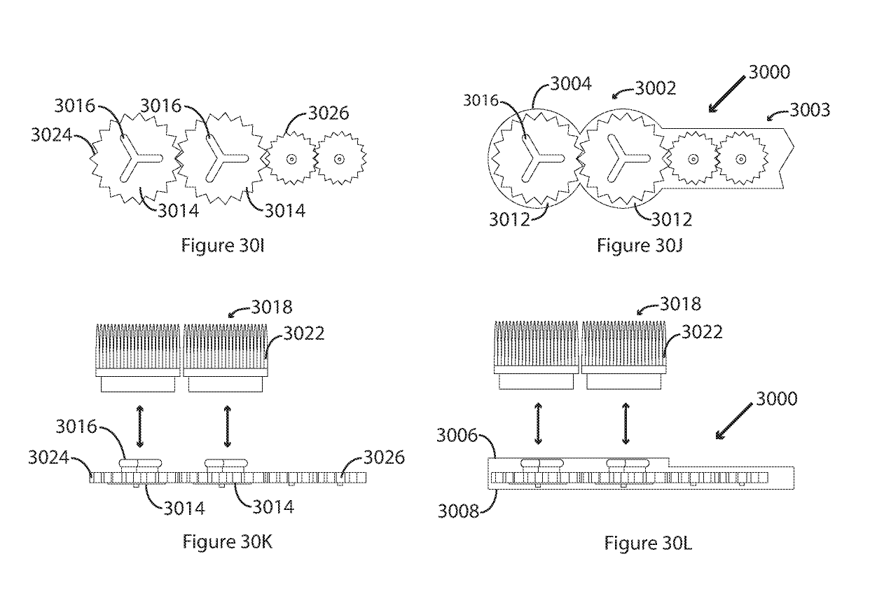

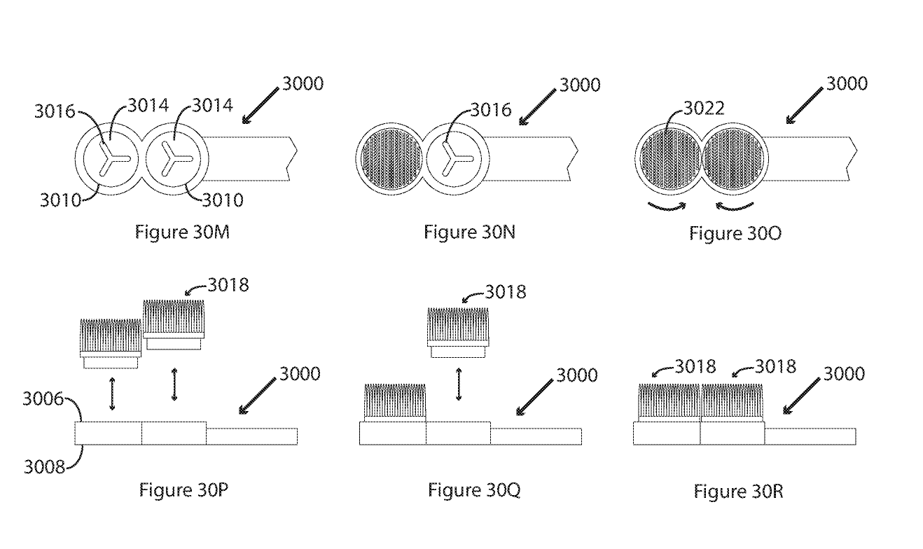

To further illustrate, FIGS. 30A-R schematically depict a segment of toothbrush head component 3000 or components thereof according to an exemplary embodiment of the invention. As shown, toothbrush head component 3000 includes head portion 3002 and neck portion 3003 that includes housing 3004, which includes top area 3006 and bottom area 3008. Top area 3006 includes top openings 3010. Toothbrush head component 3000 also includes rotational component receiving areas 3012 that communicate with top openings 3010. Rotational component receiving areas 3012 include first rotational component body structure portions 3014 of interchangeable rotational components disposed at least partially within rotational component receiving areas 3012. First rotational component body structure portions 3014 include protrusions 3016 (e.g., Y-shaped protrusions, etc.) disposed on top surfaces of first rotational component body structure portions 3014. Top openings 3010 are configured to reversibly receive at least one section or segment of second rotational component body structure portions 3018 through top openings 3010 such that segments of second rotational component body structure portions 3018 are reversibly received in and/or through top openings 3010. Second rotational component body structure portions 3018 include protrusion receiving areas 3020 that are configured to reversibly receive and retain protrusions 3016. Second rotational component body structure portions 3018 also include implements 3022 (shown as bristle components) extending from top surfaces of second rotational component body structure portions 3018. In certain embodiments, implements are fabricated integral with second rotational component body structure portions. In other exemplary embodiments, implements are selectively attachable to and/or detachable from second rotational component body structure portions. As also shown, first rotational component body structure portions 3014 also include gear components 3024 that mesh with one another and/or other gear components 3026. In other embodiments, a shaft component with a shaft gear component is optionally adapted for use with gear components 3024 of second rotational component body structure portions 3018.

To further illustrate, FIGS. 31 A and B schematically show an interchangeable rotational component and a rotational component from various views according to an exemplary embodiment of the invention. As shown, interchangeable rotational component 3100 includes base component 3102 that includes a top surface and a bottom surface. Interchangeable rotational component 3100 includes implement 3104 (shown as a bristle component or the like) extending from the top surface. Various exemplary implements that are optionally adapted for use with interchangeable rotational component 3100 (e.g., flossing components, bristle components, polishing components, cap components, etc.) are described herein. As also shown, interchangeable rotational component 3100 also includes shaft component 3106 that extends from the bottom surface of base component 3102. Shaft component 3106 is configured to be received, and reversibly retained, at least partially in an orifice of body structure component 3108, e.g., a toothbrush rotational component or the like. In the exemplary embodiment shown, shaft component 3106 includes a substantially hexagonal cross-sectional shaped section. In other embodiments, at least a portion of shaft component 3106 includes at least one cross-sectional shape selected from, e.g., a circle, an oval, a square, a rectangle, a trapezoid, an irregular n-sided polygon, a regular n-sided polygon, and the like. Interchangeable rotational component 3100 also includes portion 3110 (e.g., a fixed portion, etc.) of a retaining mechanism that reversibly retains interchangeable rotational component 3100 positioned relative to, e.g., body structure component 3108 of toothbrush rotational components or the like when shaft component 3106 is at least partially disposed in the orifice of body structure component 3108 of the toothbrush rotational component or the like. As also shown, the orifice of body structure component 3108 includes resilient coupling component 3112 that reversibly receives and retains portion 3110 of a retaining mechanism of interchangeable rotational component 3100.

To further illustrate, FIGS. 32A-E schematically show an interchangeable rotational component and a rotational component from various views according to an exemplary embodiment of the invention. As shown, interchangeable rotational component 3200 includes base component 3202 that includes a top surface and a bottom surface. Interchangeable rotational component 3200 includes implement 3204 (shown as a bristle component or the like) extending from the top surface. Various exemplary implements that are optionally adapted for use with interchangeable rotational component 3200 (e.g., flossing components, bristle components, polishing components, cap components, etc.) are described herein. As also shown, interchangeable rotational component 3200 also includes shaft component 3206 that extends from the bottom surface of base component 3202. Shaft component 3206 is configured to be received, and reversibly retained, at least partially in an orifice of body structure component 3208, e.g., a toothbrush rotational component or the like. In the exemplary embodiment shown, shaft component 3206 includes a substantially hexagonal cross-sectional shaped section. In other embodiments, at least a portion of shaft component 3206 includes at least one cross-sectional shape selected from, e.g., a circle, an oval, a square, a rectangle, a trapezoid, an irregular n-sided polygon, a regular n-sided polygon, and the like. Interchangeable rotational component 3200 also includes portion 3210 (e.g., a resilient portion, etc.) of a retaining mechanism that reversibly retains interchangeable rotational component 3200 positioned relative to, e.g., body structure component 3208 of toothbrush rotational components or the like when shaft component 3206 is at least partially disposed in the orifice of body structure component 3208 of the toothbrush rotational component or the like. As also shown, the orifice of body structure component 3208 includes fixed coupling component 3212 that reversibly receives and retains portion 3210 of a retaining mechanism of interchangeable rotational component 3200.

Device components (e.g., head portions, handle portions, interchangeable rotational components, rotational component body structure portions, drive mechanism components, gear components, shafts, device housings, etc.) are optionally formed by various fabrication techniques or combinations of such techniques including, e.g., cast molding, stamping, machining, embossing, extrusion, engraving, injection molding, etching (e.g., electrochemical etching, etc.), or other techniques. These and other suitable fabrication techniques are generally known in the art and described in, e.g., Molinari et al. (Eds.), Metal Cutting and High Speed Machining, Kluwer Academic Publishers (2002), Altintas, Manufacturing Automation: Metal Cutting Mechanics, Machine Tool Vibrations, and CNC Design, Cambridge University Press (2000), Stephenson et al., Metal Cutting Theory and Practice, Marcel Dekker (1997), Fundamentals of Injection Molding, W. J. T. Associates (2000), Whelan, Injection Molding of Thermoplastics Materials, Vol. 2, Chapman & Hall (1991), Rosato, Injection Molding Handbook, 3.^{rd} Ed., Kluwer Academic Publishers (2000), Fisher, Extrusion of Plastics, Halsted Press (1976), and Chung, Extrusion of Polymers: Theory and Practice, Hanser-Gardner Publications (2000), which are each incorporated by reference. Exemplary materials optionally used to fabricate device components include, e.g., metal, glass, wood, polymethylmethacrylate, polyethylene, polydimethylsiloxane, polyetheretherketone, polytetrafluoroethylene, polystyrene, polyvinylchloride, polypropylene, polysulfone, polymethylpentene, and polycarbonate, among many others. In certain embodiments, following fabrication, device components are optionally further processed, e.g., by painting, coating surfaces with a hydrophilic coating, a hydrophobic coating, or the like.

Exemplary rotary units, rotational mechanisms, related applications, and other aspects, which are optionally adapted, e.g., for use with the rotary units and rotational mechanisms described herein are also described in, e.g., U.S. patent application Ser. No. 13/451,468, entitled “HANDHELD DEVICES AND RELATED METHODS”, filed Apr. 19, 2012 (now U.S. Pat. No. 8,684,883, issued Apr. 1, 2014), U.S. patent application Ser. No. 14/187,302, entitled “HANDHELD DEVICES AND RELATED METHODS”, filed Feb. 23, 2014 (now U.S. Pat. No. 8,956,258, issued Feb. 17, 2015), U.S. patent application Ser. No. 14/327,519, entitled “ROTARY UNITS, MECHANISMS, AND RELATED DEVICES”, filed on Jul. 9, 2014, U.S. Patent Application No. 62/186,229, entitled “ROTARY UNITS, MECHANISMS, AND RELATED DEVICES”, filed on Jun. 29, 2015, and U.S. patent application Ser. No. 14/339,382, entitled “HANDHELD DEVICES AND RELATED METHODS”, filed Jul. 23, 2014, which are each incorporated herein by reference in their entirety for all purposes.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A toothbrush head component, comprising:
a housing comprising a head portion and a neck portion that are operably connected to one another, wherein the head portion comprises a top area that comprises at least first and second top openings, and wherein the head portion comprises at least first and second rotational component receiving areas that communicate with one or more of the top openings;
a first rotational component that is configured to rotate around a first rotational axis, which first rotational component comprises a first body structure component that is at least partially disposed in the first rotational component receiving area, which first body structure component comprises at least first and second gear components, and at least one orifice disposed at least partially through the first body structure component, which orifice is configured to reversibly receive at least one section of at least a first interchangeable rotational component through the first top opening such that a segment of the first interchangeable rotational component is reversibly received in and/or through the first top opening;
a second rotational component that is configured to rotate around a second rotational axis, wherein the first and second rotational axes are substantially parallel to one another, which second rotational component comprises a second body structure component that is at least partially disposed in the second rotational component receiving area, which second body structure component comprises at least a first gear component and at least one orifice disposed at least partially through the second body structure component, which orifice is configured to reversibly receive at least one section of at least a second interchangeable rotational component through the second top opening such that a segment of the second interchangeable rotational component is reversibly received in and/or through the second top opening, wherein the first and/or second interchangeable rotational component comprises, or is configured to comprise, at least one implement, and wherein the first gear component of the second body structure component operably engages the first gear component of the first body structure component; and,
a drive mechanism component or portion thereof at least partially disposed in the neck portion of the housing, which drive mechanism component or portion thereof comprises at least one shaft component that is configured to rotate around a third rotational axis, which shaft component comprises at least one shaft gear component that operably engages the second gear component of the first body structure component such that when the shaft component continuously rotates in one direction around the third rotational axis, the first rotational component continuously rotates in a first direction around the first rotational axis and the second rotational component continuously rotates in a second direction around the second rotational axis, wherein the first and second directions are substantially opposite one another.

2. The toothbrush head component of claim 1, wherein the third rotational axis is substantially perpendicular to, and intersects with, the first and second rotational axes.

3. The toothbrush head component of claim 1, comprising at least one retaining mechanism or portion thereof that is configured to reversibly retain at least one of the interchangeable rotational components when the orifice reversibly receives the section of the interchangeable rotational component.

4. The toothbrush head component of claim 1, comprising a handle portion operably connected or connectable to the head portion.

5. The toothbrush head component of claim 1, comprising the first and/or second interchangeable rotational component.

6. The toothbrush head component of claim 1, wherein at least a portion of the implement comprises at least one cross-sectional shape selected from the group consisting of: a circle, an oval, a square, a rectangle, a trapezoid, an irregular n-sided polygon, and a regular n-sided polygon.

7. The toothbrush head component of claim 1, wherein the implement is selected from the group consisting of: a flossing component, a bristle component, a polishing component, and a cap component.

8. An interchangeable rotational component configured to be reversibly received by one or more of the orifices of the toothbrush head component of claim 1.

9. A tooth brushing device comprising the toothbrush head component of claim 1.

10. The toothbrush head component of claim 1, wherein the head portion comprises a bottom area that comprises at least first and second bottom openings and wherein one or more of the first and second rotational component receiving areas communicate with one or more of the bottom openings.

11. A toothbrush rotational component, comprising:
a body structure component that comprises at least first and second gear components, and at least one orifice disposed at least partially through the body structure component, wherein the first gear component of the body structure component is configured to operably engage at least one gear component of another toothbrush rotational component and wherein the second gear component of the body structure component is configured to operably engage at least one shaft gear component of a toothbrush head component; and,
an interchangeable rotational component that comprises, or is configured to comprise, at least one implement, wherein at least one section of the interchangeable rotational component is reversibly received in the orifice of the body structure component.

12. The toothbrush rotational component of claim 11, comprising at least one retaining mechanism or portion thereof that is configured to reversibly retain the section of the interchangeable rotational component in the orifice of the body structure component.

13. The toothbrush rotational component of claim 11, wherein at least a portion of the implement comprises at least one cross-sectional shape selected from the group consisting of: a circle, an oval, a square, a rectangle, a trapezoid, an irregular n-sided polygon, and a regular n-sided polygon.

14. The toothbrush rotational component of claim 11, wherein the implement is selected from the group consisting of: a flossing component, a bristle component, a polishing component, and a cap component.

15. An interchangeable rotational component, comprising:
a base component comprising top and bottom surfaces, wherein at least one implement extends from the top surface; and,
at least one shaft component that extends from the bottom surface of the base component, which shaft component is configured to be received, and reversibly retained, at least partially in an orifice of a body structure component of a toothbrush rotational component.

16. The interchangeable rotational component of claim 15, wherein at least a portion of the implement comprises at least one cross-sectional shape selected from the group consisting of: a circle, an oval, a square, a rectangle, a trapezoid, an irregular n-sided polygon, and a regular n-sided polygon.

17. The interchangeable rotational component of claim 15, wherein the implement is selected from the group consisting of: a flossing component, a bristle component, a polishing component, and a cap component.

18. The interchangeable rotational component of claim 15, comprising at least a portion of a retaining mechanism that reversibly retains the interchangeable rotational component positioned relative to the body structure component of the toothbrush rotational component when the shaft component is at least partially disposed in the orifice of the body structure component of the toothbrush rotational component.

19. The interchangeable rotational component of claim 18, wherein the shaft component comprises the portion of the retaining mechanism, which portion of the retaining mechanism is configured to engage another portion of the retaining mechanism that is disposed on a one or more surfaces that define the orifice of the body structure component.

20. The interchangeable rotational component of claim 19, wherein the retaining mechanism comprises one or more resilient coupling components.
